(19) United States
(12) Patent Application Publication
(10) Pub. No.: US 2006/0212323 A1
(43) Pub. Date: Sep. 21, 2006

(54) Production management system

(76) Inventor: Yoshio Ninomiya, Tokyo (JP)

Correspondence Address: FISH & RICHARDSON P.C., P.O. BOX 1022, MINNEAPOLIS, MN, 55440-1022, US

(21) Appl. No.: 11/342,362

(22) Filed: Jan. 26, 2006

(30) Foreign Application Priority Data
Mar. 15, 2005 (JP) JP2005-073686
Mar. 31, 2005 (JP) JP2005-103519
Mar. 31, 2005 (JP) JP2005-103520
Apr. 22, 2005 (JP) JP2005-125330

(51) Int. Cl. G06F 17/50

(52) U.S. Cl. 705/7

(57) ABSTRACT

A system is provided that can reset a production schedule in accordance with a change caused in a production This system optionally displays, when a demand from a customers is changed and product order receiving conditions are changed, component procurement conditions required to receive the change of the demand to thousands of component vendors for example so that the component vendors can update the component procurement conditions in accordance with a range acceptable for the vendors (screen AB) . Then, the system automatically counts them to update the product order receiving conditions so that the order for the product can be partially received.

This application is based on and claims the benefit of priority from Japanese Patent Application No. 2005-073686, filed on Mar. 15, 2005, Japanese Patent Application No. 2005-103519, filed on Mar. 31, 2005, Japanese Patent Application No. 2005-103520, filed on Mar. 31, 2005, and Japanese Patent Application No. 2005-125330, filed on Apr. 22, 2005, the contents of which are incorporated herein by reference.

### BACKGROUND OF THE INVENTION

1. Field of the Invention

The present invention relates to a production management system that resets a production schedule in accordance with various changes caused in production activities (e.g., (1) demand from customers, (2) production capability, (3) material procurement conditions), and a program for causing the production management system to execute the resetting.

The present invention also relates to a system and a program to provide information showing whether a work at a production site such as a plant can be undertaken or not based on a resource required for the work. More specifically, the system and the program provide information showing whether a manufacturing work can be undertaken or not based on resource information such as conditions for raw material, facility and machine, and workers required for undertaking the work.

The present invention also relates to a computer, a program, and a method by which a field can be easily added to a plurality of tables of a database.

The present invention also relates to a production management apparatus, a production management program, and a production management method. In particular, the present invention relates to a production management apparatus, a production management program, a computer-readable recording medium for recording the production management program, and a production management method by which custom-made product (product made one by one, i.e. a product made by one item production) can be controlled in a preferred manner.

The present invention also relates to a production management apparatus, a production management program, and a production management method. In particular, the present invention relates to a production management apparatus, a production management program, a computer-readable recording medium for recording the production management program, and a production management method by which production management in Material Requirements Planning (hereinafter simply referred to as “MRP”) can be performed in a preferred manner.

The present invention also relates to a production management apparatus, a production management program, and a production management method. In particular, the present invention relates to a production management apparatus, a production management program, a computer-readable recording medium for recording the production management program, and a production management method by which production management in an intermediate process can be flexibly performed in accordance with conditions.

2. Related Art

Conventionally, various production management systems have been developed and used with an object of improving the production efficiency of a plant. By using such production management systems, a user can input an anticipated customer demand, a production capability, material procurement conditions or the like to calculate requirements for components constituting a to-be-produced product, facility and machine, workers for example (MRP; Material Requirements Planning), thereby setting and operating a production schedule.

Production management systems have effectively functioned to set and to securely execute a production schedule corresponding to an estimated demand. More specifically, by using a computer to understand a real production situation based on the previously determined production schedule, it has been possible to appropriately provide instructions for the procurement of required components and the start or end of manufacturing processes for example. Thus, the material could be used effectively and the productivity could be maximized.

Patent Publication A1: Japanese Patent Application Unexamined Publication No. 2000-79023

It is desirable for a production site such as a plant to have a minimized fluctuation of the demand for work processes in view of an efficient operation of plant facilities and workers and the absorption ability to a sudden change of a production schedule for example. On the other hand, manufacturing works are planned based on the production schedule. However, the plan calculated based on the production schedule is not always free from fluctuation.

Thus, there may be cases in which a responsible person of a manufacturing department performs, within his discretion, the equalizing of works by the adjustment of a timing at which a work is undertaken by accelerating the work or by the change of an order of works.

However, if the responsible person freely changes a timing at which a work is undertaken or an order of works for example, there may be cases where a work plan cannot be maintained and the production activity is not economical despite the intention.

Furthermore, there also may be cases in which such situations must be handled where the condition of secured components or materials is changed due to a sudden fluctuation of inventory, fluctuation of a demand, or a change in the production schedule, an accident for example; the production capability is changed due to workers or facility and machine; effects are caused due to a trouble in a leading process; or the resource condition is suddenly changed due to a post-process or a sudden request from a customer.

Under these situations, in order to equalize works or to handle the fluctuation for example by changing an order of undertaking works, the responsible person of the manufacturing process needs to accurately know which work can be undertaken at the time.

Patent Publication B1: Japanese Patent Application Unexamined Publication No. 2002-123657

The inventions described in the above publications are effective to maintain the production schedule by controlling an anteroposterior relationship between works, required days, or a progress situation to check whether an estimated date at which the work is completed exceeds the deadline so that awareness of workers can be promoted. However, the inventions can tell which work should be done now but do not provide a device for presenting information that shows which work can be undertaken and that is useful for equalizing works and for handling a sudden change of situation.

When a great number of pieces of data must be controlled, it is effective to use such a database that is designed to be useful by collecting all pieces of data in a computer to subsequently collect certain pieces of information related to one another.

In a production site for example, there are a great number of objects to be controlled, including products, components, the number of processes, and work sites. In order to control these large objects to be controlled in an efficient and accurate manner, a production management system using a database has been used in the manufacturing business.

However, a situation where the design of a specification of a table in a database must be changed after the operation of the database is started is not always unusual. In this case, a small-scale design change can be performed by SQL or the like to add or change a field of the table.

In the manufacturing business, there is a case where the specification of a product is changed in accordance with the needs from a market or a customer for example. Thus, the database-based production management system desirably can control large objects and can cope with the change of the contents of the objects at any time. On the other hand, the database used in the production management system has many various types of tables and an enormous amount of data. Thus, when the contents are changed, a check process for maintaining the data consistency is complicated.

Due to this reason, there are many techniques regarding the change and control of tables and data of the database.

For example, Patent Publication C1 discloses a technique. This technique is comprising: a device for writing data to a manufacturing BOM (BOM: bill of materials) on the basis of a production unit to update data stored in the manufacturing BOM; and a device for correcting, based on inputted changed data, a specification BOM and the manufacturing BOM.

Patent Publication C1: Japanese Patent Application Unexamined Publication No. 2001-282343

Large custom-made products still occupy an important part of Japanese industry. Conventionally, these large custom-made products generally have been sold with relatively high prices and thus have not drawn cost-consciousness and have required a long period from a stage of an order receipt to a stage of the completion. However, with the recent increasing competition among manufacturers, manufacturers have been required to complete these products with a shorter period. Manufacturers also have been required to reduce the cost in accordance with the decline of the selling price.

In order to complete the product with a shorter period, it may be considered to order those components or materials or the like requiring a long delivery at an earlier stage and with a timing at which the basic design is completed. However, there may be cases where the customer changes the intention after the components or materials or the like were ordered at an earlier stage or cases where the design is changed from the one in an original specification. Furthermore, there also may be cases in which a component ordered at an earlier stage cannot be manufactured as specified in the design. If the previously-ordered design is changed so that the component can be manufactured in this case, it may cause the need to change the designs of related components. Furthermore, there also may be cases where the original design of the component ordered at an earlier stage is inappropriate and thus must be corrected after the component was ordered at an earlier stage.

In this case, when 100 components have been ordered at an earlier stage for a product consisting of 1000 components for example and the designs of a few components among them must be changed, this design change can be handled by increasing the number of workers. However, if components requiring a design change are increased, it is very difficult to handle the design change only with increased workers, resulting in a significant effect on the delivery, quality, and cost of the product. Such a situation is particularly important to the cost. When the customer changes the intention, it is required to immediately and appropriately know which components are changed and which components are not required, and which components are additionally required. If there are components no more required, it is desirable to notify a supplier that the components are not required to cancel the order if possible. If the order cannot be cancelled, the cost increases by the cost of the components, which causes a significant deficit depending on a situation to put a user in a serious financial crisis. There also may be cases where the order that would have been able to be cancelled at an earlier stage cannot be cancelled because the order has not notified a supplier of the fact that the component is not required when the supplier finishes the manufacture of the component for example. In this case, if the components not required are disposed, this is not environmentally desirable.

Furthermore, if components that require a long lead time delivery and that should be ordered by an additional order are not determined or ordered immediately, a risk is caused in which all required components are not available at an assembly, causing a delayed delivery. The delayed delivery requires an unreasonable handling. This causes a further increase in the cost and reduced morale of employees. The reduced morale of employees suppresses orders from increasing. This reduces the efficiency, thus further increasing the cost. The above vicious cycle causes the management crisis of the company.

With regard to this point, a method has been already disclosed that provides a review and approval section for the production management of a power generator (see Patent Publication D1). However, this method does not disclose a systematic method to cope with, for example, a situation where the customer changes the intention or the like.

Patent Publication D1: Japanese Patent Application Unexamined Publication No. 2004-192352

Conventionally, an MRP-based method has been used in which, in order to achieve a production schedule of the company, an amount of to-be-ordered material and an ordering timing are calculated based on a BOM and inventory information. This method does not supply materials used in the past but is aware of an anticipated demand in advance, thereby realizing both reduced inventory and eliminated shortage. This method provides a direct link from material procurement to the receipt of orders from customers and to the anticipation of demands, thereby significantly improving an operation for preparing the production schedule.

However, the conventional MRP production management system allows only an input of real execution data for inputting a completion. Thus, a problem has been caused where an actual production not satisfying a schedule leads to a situation where, in spite of the fact that an additional production is not needed, an instruction for the additional production is issued or a situation where a procurement slip is additionally issued.

With regard to this point, a production data management method has been suggested that uses an information processing apparatus to control a production schedule and production data for the execution status (see Patent Publication E1). In particular, this method uses, when a processing for reconciling the production schedule is performed, a concept of virtual execution data (virtual completion value) that is different from real execution data (absolute completion value).

Patent Publication E1: Japanese Patent Publication No.

Conventionally, a production management apparatus has displayed a chart based on a Gantt chart for example for an intermediate process for the purpose of production management in an individual work place. Based on this chart, required works have been achieved by preparing a specific time schedule for the respective orders.

However, the conventional method merely associates to-be-executed items with the time schedule. Thus, a problem has been caused in which, when a work specified in the time schedule is to be performed, required components are not available and thus the work cannot be performed. In this case, in order to efficiently use employees and production facilities, individual working places frequently start, instead of the production of the non-available components, the production of other components that must be completed within few days. However, this has often confused employees because they did not know whether required components were available or not at the time.

With regard to this point, various methods have been suggested; including a method to display, in order to provide an efficient work control method to a Gantt chart-based production schedule, a map including equipment by which the work is to be performed and a method to display a pop-up window (see Patent Publications F1 and F2). However, these methods do not disclose a systematical method to provide information showing whether preparation of production is completed or not. More specifically, there has been a clear need, in individual working places where production management is performed, to appropriately understand which process can be undertaken at the time based on the respective pieces of process result data that change every second. In spite of this need, no system has been provided that displays, in an easy-to-understand manner, information showing which process can be undertaken in the working place based on information regarding components in an amount from thousands to tens of thousands.

Patent Publication F1: Japanese Patent Application Unexamined Publication No. 2004-54716

Patent Publication F2: Japanese Patent Application Unexamined Publication No. 2004-164408

### SUMMARY OF THE INVENTION

However, the conventional production management systems cannot cope with current situations. For example, the situation includes diversified preferences of customers and an increased speed of the change of the preferences. This situation thus has caused frequent changes of ordering conditions of a product. Thus, production sites frequently must change an original production schedule. The situation as described above has caused the problem as described below.

When a customer demand changes and a sudden inquiry is caused for example, accepting this inquiry requires to immediately understand the inventory in component vendors (which are sometimes in an amount of thousands) of required components in an amount of tens of thousands and material procurement conditions (e.g., a status where how many components are ordered) and the production capability so that whether the product can be produced by the desired deadline by changing an original production schedule or not can be judged. If this is possible, then the production schedule must be actually changed. Such a change of the production schedule is caused not only by the change of the customer demand as in this example but also by the change of a production capability due to a failure of equipment or illness or injury of a worker and the change of material procurement conditions such as a request from a component vendor for the change of a planned delivery or a delivery amount.

The diversified changes as described above have been handled by the conventional production management system in a non-flexible manner. For example, when a customer demand changes, the conventional production management system judges whether the production schedule can be changed or not while fixing inventory (e.g., component, intermediate product, product), surplus of the production capability (e.g., facility and machine, worker), and previously determined material procurement conditions for the delivery of components from a component vendor for example. Thus, even when a production site would have able to negotiate with the component vendor to cause the vendor to deliver the components earlier than the regular delivery or would have able to cope with the situation by changing the number of lots in the delivery, the conventional production management system cannot change the plan according to which the order has been already issued (or fixed plan). As a result, dissociation is caused between the plan and an actual production, preventing the situation of the actual production from being simulated by the system. In other words, the unavailability of a system for simulating the irregular response from the component vendor prevents a question of whether the change of the customer demand can be handled or not from being judged accurately. This deprives the manufacturer of an opportunity to accept the order. This is the first problem of the conventional production management system.

By the way, when a production capability changes or when material procurement conditions change, the conventional production management system cannot accept the above change. Thus, when such a change comes to reality, dissociation is caused between an actual production schedule and a production schedule in a production management system. This is the second problem of the conventional production management system.

The present invention has been made in view of the above disadvantages. It is an object of the present invention to provide a system that can flexibly cope with various change of the surrounding situation.

In order to achieve the object as described above, the present invention provides the following.

(1) A server that is connected to a terminal via a communication network and that calculates acceptable ordering conditions in accordance with a change of ordering conditions sent from the terminal to transmit the calculated conditions to the terminal, comprising: a storage unit at least including a product order receiving conditions storage area for storing product order receiving conditions and a component procurement conditions storage area for storing component procurement conditions; a product order receiving conditions reception device for receiving product order receiving conditions from the terminal; a component procurement conditions transmission device for transmitting, to the terminal, component procurement conditions calculated based on the product order receiving conditions; a component procurement conditions reception device for receiving, from the terminal, an update regarding the component procurement conditions; and a product order receiving conditions transmission device for transmitting, to the terminal, product order receiving conditions calculated based on the received component procurement conditions.

According to the aspect of the invention (1), acceptable product order receiving conditions can be calculated by allowing a component vendor to update component procurement conditions calculated in accordance with a change in product order receiving conditions caused in a production activity. In particular, with regard to the component procurement conditions, several tens of thousands of acceptable component procurement conditions updated by the respective component vendors (which are sometimes in an amount of thousands) can be automatically counted and can be reflected in the calculation of acceptable product order receiving conditions. This can cope with a change in product order receiving conditions that cannot be accepted without the update of component procurement conditions.

As described above, such a change in product order receiving conditions is frequently caused in the modern production activity. Thus, the possibility of “partial receipt of an order” by the present invention provides a significant change in an order receipt rate. Specifically, by providing a new stage for updating component procurement conditions that have been once calculated based on conditions such as a procurement lead time and the number of to-be-procured lots, an opportunity to accept an order for a product that has been given in consideration of an irregular response from a component vendor can be obtained as much as possible. Furthermore, the response as described above is followed by an update of the production schedule itself. As a result, even when another new change in product order receiving conditions is caused, another opportunity to accept an order can be successively obtained with the same calculation accuracy as that in the previous calculation.

(2) A server that is connected to a terminal via a communication network and that calculates an effects on product delivery conditions in accordance with a change of component procurement conditions sent from the terminal to transmit the calculated effect to the terminal, comprising: a storage unit at least including a component procurement conditions storage area for storing component procurement conditions, a production schedule storage area for storing a production schedule, and a product delivery conditions storage area for storing product delivery conditions; a component procurement conditions reception device for receiving component procurement conditions from the terminal; a production schedule transmission device for transmitting, to the terminal, a production schedule calculated based on the component procurement conditions; a production schedule reception device for receiving, from the terminal, an update of the production schedule; and a product delivery conditions transmission device for transmitting, to the terminal, product delivery conditions calculated based on the received production schedule.

According to the aspect of the invention (2), in contrast to the case of the case of the invention (1), a production schedule calculated in accordance with a change in component procurement conditions at a component vendor is updated by a product maker. As a result, effects on product delivery conditions can be calculated. With regard to component procurement conditions in particular, several tens of thousands of component procurement conditions changed by the respective component vendors (which are sometimes in an amount of thousands) can be automatically counted and can be reflected on the calculation of the production schedule.

As described above, the changes in component procurement conditions as described above may be simultaneously caused in the modern production activity. Thus, the quick calculation by the present invention of an effect on product delivery conditions will play an important role for maintaining existing product order receiving conditions. Specifically, by introducing a new stage for updating a production schedule that has been once calculated based on conditions such as a production lead time and a work load, existing product order receiving conditions can be maintained as much as possible in consideration of an irregular response from a product maker. Furthermore, the response as described above is followed by an update of the production schedule itself. This allows, even when another new change in component procurement conditions is caused, the change to be handled with the same calculation accuracy as that in the previous calculation.

(3) The server according to the invention (1), comprising: the storage unit further including: a product inventory information storage area for storing product inventory information; component inventory information storage area for storing component inventory information; a component procurement lead time storage area for storing a component procurement lead time; and a production schedule storage area for storing production schedule, a production schedule determination device for determining the production schedule including a buffer based on the product inventory information, the component inventory information, and the component procurement lead time.

(4) The server according to the invention (2), comprising: the storage unit further including: a product inventory information storage area for storing product inventory information; a component inventory information storage area for storing component inventory information; and a component procurement lead time storage area for storing a component procurement lead time, a production schedule determination device for determining the production schedule by including a buffer on the product inventory information, the component inventory information, and the component procurement lead time.

According to the aspect of the invention (3) or (4), the production schedule is determined by including a buffer on the product inventory information, the component inventory information, and the component procurement lead time. Thus, a change in product order receiving conditions or a change in component procurement conditions can be handled within the range of the buffer and without changing the production schedule.

(5) A production management program that causes a server connected to a terminal via a communication network to calculate acceptable ordering conditions in accordance with a change of ordering conditions sent from the terminal to transmit the calculated conditions to the terminal, wherein: the server includes a control unit and a storage unit; the storage unit at least includes a product order receiving conditions storage area for storing product order receiving conditions and a component procurement conditions storage area for storing component procurement conditions; the production management program further causes the control unit to execute: a product order receiving conditions reception processing for receiving product order receiving conditions from the terminal; a component procurement conditions transmission processing for transmitting, to the terminal, component procurement conditions calculated based on the product order receiving conditions; a component procurement conditions reception processing for receiving, from the terminal, an update of the component procurement conditions; and a product order receiving conditions transmission processing for transmitting, to the terminal, product order receiving conditions calculated based on the received component procurement conditions.

(6) A production management program that causes a server connected to a terminal via a communication network to calculate acceptable ordering conditions in accordance with a change of ordering conditions sent from the terminal to transmit the calculated conditions to the terminal, wherein: the server includes a control unit and a storage unit; the storage unit at least includes a product order receiving conditions storage area for storing product order receiving conditions and a component procurement conditions storage area for storing component procurement conditions; the production management program further causes the control unit to execute: a product order receiving conditions reception processing for receiving product order receiving conditions from the terminal; a component procurement conditions transmission processing for transmitting, to the terminal, component procurement conditions calculated based on the product order receiving conditions; a component procurement conditions reception processing for receiving, from the terminal, an update of the component procurement conditions; and a product order receiving conditions transmission processing for transmitting, to the terminal, product order receiving conditions calculated based on the received component procurement conditions.

(7) The production management program according to the invention (5), wherein: the storage unit further includes a product inventory information storage area for storing product inventory information, a component inventory information storage area for storing component inventory information, a component procurement lead time storage area for storing a component procurement lead time, and a production schedule storage area for storing a production schedule, the production management program further causes the control unit to execute: a production schedule determination processing for determining the production schedule including a buffer based on the product inventory information, the component inventory information, and the component procurement lead time.

(8) The production management program according to the invention (6), comprising: the storage unit further includes a product inventory information storage area for storing product inventory information, a component inventory information storage area for storing component inventory information, and a component procurement lead time storage area for storing a component procurement lead time, the production management program further causes the control unit to execute: a production schedule determination processing for determining the production schedule including a buffer based on the product inventory information, the component inventory information, and the component procurement lead time.

No conventional techniques have provided a device for allowing a person responsible for a manufacturing operation to clearly know which work can be undertaken when the person tries to change an order of undertaking works in order to provide equalizing and to handle a sudden change in a resource status without changing the delivery date of a production schedule.

It is very difficult to accurately judge whether a certain work can be undertaken or not when there is a great number of works or when a relationship among the works or resources required for the works is complicated or when various raw material items or components are required to undertake the work.

Due to this reason, judgment with regard to whether a work can be undertaken or not in a production site has depended, in reality, on the experience and seat-of-the-pants approach by a responsible person of a manufacturing department. Thus, a shop floor having no skilled responsible persons or the like cannot always provide an appropriate judgment regarding whether the work can be undertaken or not.

The present invention has been made in view of these problems. It is an object of the present invention to provide a system that appropriately presents, to a responsible person of a manufacturing department, work that can be undertaken at a production site to contribute to an efficient production activity through the equalizing of work for example.

In order to achieve this object, the present invention provides a system that appropriately presents a work that can be undertaken at a production site such as a plant. This system receives, via an input unit, the current status of resources required for undertaking a manufacturing work (e.g., conditions such as components or materials, facilities or machines, workers required for undertaking the work) and the conditions of the resources required for undertaking the respective works. Then, the system compares the former and the latter to judge whether the work can be undertaken or not. Then, the system displays the result through a display unit. This supports the equalizing of the work and the decision making with regard to whether the work is undertaken or not in order to cope with a change that are performed within the discretion of a responsible person at a production site. More specifically, the followings are provided.

(9) A computer for judging whether a work can be undertaken or not, wherein: the computer includes a storage unit that includes a storage area, the storage area at least stores therein work information, the work information being composed of: resource status information that represents the current status of a resource required for undertaking a work and that is composed of a resource name and unit(s) of resource(s); deliverables information that represents a work name specifying the work and deliverables obtained by the completion of the work; and resource request information that represents required conditions of the resource required for undertaking the work, the deliverables information is composed of a deliverable name and unit(s) of deliverable(s) and the resource request information is composed of a resource name and unit(s) of resource(s), the computer further including: a resource status information input reception device for receiving an input of resource status information; a work information input reception device for receiving work information; a device for judging whether a work can be undertaken or not, the device judges that the work can be undertaken when unit(s) of resource(s) of the resource status information of all resources required for undertaking the work is equal to or higher than unit(s) of resource(s) of resource request information and judges that the work cannot be undertaken in a case other than the above case; and a device for displaying a result of the judgment regarding whether a work can be undertaken or not, the device displays the judgment result of the device for judging whether a work can be undertaken or not.

According to the aspect of the invention (9), the information providing system can calculate the information showing whether the work can be undertaken or not based on the resource status information and the work information. This information showing whether the work can be undertaken or not allows, even when there are various types of work or resources or when works or resources have a complicated relationship, a responsible person at a production site or the like to accurately know a work that can be currently undertaken based on the information showing whether the work can be undertaken or not. Therefore, decision making required for the equalizing of works or for an unexpected situation (e.g., decision of a work to be undertaken, examination of an order of works) can be performed in an easy manner.

The information providing system also displays information showing whether the work can be undertaken or not. Thus, the information showing whether the work can be undertaken or not can be visually recognized by a symbol mark for example. Thus, the situation can be appropriately understood by a shop floor and an instruction for a manufacturing work can be quickly given.

(10) The computer according to the invention (9), wherein: the device for judging whether a work can be undertaken or not judges that-the work can be entirely undertaken when unit(s) of resource(s) of the resource status information of all resources required for undertaking the work is (are) equal to or higher than unit(s) of resource(s) of resource request information, judges that the work can be partially undertaken in a case other than the above case in which unit(s) of resource(s) of the resource status information is, with regard to deliverables of the work, equal to or higher than unit(s) of resource(s) required for providing at least one unit of deliverable, and judges that the work cannot be undertaken in a case other than these cases, and the device for displaying a result of the judgment regarding whether a work can be undertaken or not displays unit(s) of deliverable(s) of deliverables information of work information of the work judged by the device for judging whether a work can be undertaken or not.

According to the aspect of the invention (10), even when the status of a resource in a process prevents an originally-determined total amount of deliverables by a work from being provided, whether this amount can be partially provided or not by partially undertaking the work can be judged when the determined amount can be partially provided by partially undertaking the work. As a result, a responsible person of a manufacturing department can issue an instruction for a manufacturing activity in a more flexible manner.

(11) The computer according to the invention (9) or (10), wherein: the storage unit includes a storage area that at least stores undertaking instruction information, the undertaking instruction information notifies that the work has been undertaken and is composed of a work name, a deliverable name, and unit(s) of deliverable(s) planned to be obtained when the work is undertaken, and the computer includes: an undertaking instruction information input reception device for receiving an input of the undertaking instruction information; and an undertaken resource status information update device for deducting, when the undertaking instruction information regarding the work is inputted, from unit(s) of resource(s) of the resource status information, unit(s) of resource(s) of resource request information of the work corresponding to unit(s) of deliverable(s) of undertaking instruction information of the work with regard to all resources corresponding to deliverable names of the work for update.

According to the aspect of the invention (11), when the undertaking instruction is issued for the work, an amount required for undertaking the work can be deducted from the units of resources of the resource status information. As a result, every change in the resource due to the undertaken work can be reflected in the judgment whether other works can be undertaken or not. Thus, a responsible person of a manufacturing department can issue an undertaking instruction in a step-by-step manner and based on accurate information.

It is noted that the undertaking may include not only an entire undertaking of the work but also a partial undertaking of the work.

(12) The computer according to any of the inventions (9) to (11), wherein: the storage unit includes a storage area that at least stores work completion information, the work completion information notifies that the work is completed and composed of a work name, a deliverable name, and unit(s) of deliverable(s) obtained by the completion of the work, and the computer includes: a work completion information input reception device for receiving an input of the work completion information; and a completed resource status information update device for adding, when the work completion information regarding the work is inputted and when deliverables of the work are a resource required for undertaking another work, unit(s) of deliverable(s) of work completion information of the work to unit(s) of resource(s) of the resource of resource status information for update.

According to the aspect of the invention (12), when the work is completed, the units of resources of the resource status information can be increased by an amount of unit(s) of deliverable(s) obtained by the completion of the work. As a result, every change in the resource due to the completion of the work can be reflected on the judgment whether other works can be undertaken or not. Thus, a responsible person of a manufacturing department can issue an undertaking instruction in a step-by-step manner and based on accurate information.

It is noted that the undertaking may include not only an entire undertaking of the work but also a partial undertaking of the work.

(13) The computer according to any of the inventions (9) to (12), wherein: the work information further includes planned undertaking timing information representing a planned timing at which a work is undertaken, the computer further includes a device for receiving an input of a final timing at which a work is displayed for receiving an input of work final display timing information showing a final timing at which a work is displayed, and the device for displaying a result of the judgment regarding whether a work can be undertaken or not displays, when a work has work information having planned undertaking timing information that is simultaneous with or earlier than the final display timing information and when the work has unit(s) of deliverable(s) larger than unit(s) of deliverable(s) of work completion information, the judgment result by the device for judging whether a work can be undertaken or not.

According to the aspect of the invention (13), a work already completed and a future work for which the display timing is not yet reached are not displayed. Thus, such a work that really needs information showing whether the work can be undertaken or not is displayed. Thus, a user can understand the situation in an appropriate and prompt manner.

(14) The computer according to any of the inventions (11) to (13), wherein: the storage unit includes a storage area that at least stores work equalizing information for displaying, in order to equalize works of a manufacturing department, an amount of works to be done by the manufacturing department on a date and actually undertaken volume information showing the total of unit(s) of deliverable(s) of deliverables planned to be obtained when the work for which an undertaking instruction has been issued on the date is undertaken, and the computer further includes: a work equalizing information input reception device for receiving an input of the work equalizing information; and a work equalizing information display device for simultaneously displaying the work equalizing information and the actually undertaken volume information.

According to the aspect of the invention (14), undertaking instructions based on a plan can be accumulated in a step-by-step manner and thus a plan for issuing undertaking instructions can be arranged while comparing the instructions with the plan.

(15) A program for allowing a computer to realize a function for judging whether a work can be undertaken or not, wherein: the computer includes a storage unit that includes a storage area, the storage area at least stores therein work information, the work information is composed of: resource status information that represents the current status of a resource required for undertaking a work and that is composed of a resource name and unit(s) of resource(s); deliverables information that represents a work name specifying the work and deliverables obtained by the completion of the work; and resource request information that represents required conditions of the resource required for undertaking the work, the deliverables information is composed of a deliverable name and unit(s) of deliverable(s) and the resource request information is composed of a resource name and unit(s) of resource(s), and the program further allows the computer to realize: a resource status information input reception function for receiving an input of resource status information; a work information input reception function for receiving work information; a function for judging whether a work can be undertaken or not, the function judges that the work can be undertaken when unit(s) of resource(s) of the resource status information of all resources required for undertaking the work is (are) equal to or higher than unit(s) of resource(s) of resource request information and judges that the work cannot be undertaken in a case other than the above case; and a function for displaying a result of the judgment regarding whether a work can be undertaken or not for displaying the judgment result of the function for judging whether a work can be undertaken or not.

The invention (15) can provide the same effects as that by the invention (9).

(16) The program according to the invention (15), wherein: the function for judging whether a work can be undertaken or not causes the computer to judge that the work can be entirely undertaken when unit(s) of resource(s) of the resource status information of all resources required for undertaking the work is (are) equal to or higher than unit(s) of resource(s) of resource request information, to judge that the work can be partially undertaken in a case where unit(s) of resource(s) of the resource status information is (are), with regard to deliverables of the work, equal to or higher than unit(s) of resource(s) required for providing at least one unit of deliverable, and to judge that the work cannot be undertaken in a case other than these cases, and the function for displaying a result of the judgment regarding whether a work can be undertaken or not causes the computer to display unit(s) of deliverable(s) of deliverables information of work information of the work judged by the function for judging whether a work can be undertaken or not.

The invention (16) can provide the same effects as that by the invention (10).

(17) The program according to the invention (15) or (16), wherein: the storage unit of the computer further includes a storage area that at least stores undertaking instruction information, the undertaking instruction information notifies that the work has been undertaken and is composed of a work name, a deliverable name, and unit(s) of deliverable(s) planned to be obtained when the work is undertaken, the program allows the computer to realize: an undertaking instruction information input reception function for receiving an input of the undertaking instruction information; and an undertaken resource status information update function for deducting, when the undertaking instruction information regarding the work is inputted, from unit(s) of resource(s) of the resource status information, unit(s) of resource(s) of resource request information of the work corresponding to unit(s) of deliverable(s) of undertaking instruction information of the work with regard to all resources corresponding to deliverable names of the work for update.

The invention (17) can provide the same effects as that by the invention (11).

(18) The program according to any of the inventions (15) to (17), wherein: the storage unit of the computer further includes a storage area that at least stores work completion information, the work completion information notifies that the work is completed and is composed of a work name, a deliverable name, and unit(s) of deliverable(s) obtained by the completion of the work, the program allows the computer to realize: a work completion information input reception function for receiving an input of the work completion information; and a completed resource status information update function for adding, when the work completion information regarding the work is inputted and when deliverables of the work are a resource required for undertaking another work, unit(s) of deliverable(s) of work completion information of the work to unit(s) of resource(s) of the resource of resource status information for update.

The invention (18) can provide the same effects as that by the invention (12).

(19) The program according to any of the inventions (15) to (18), wherein: the work information further includes planned undertaking timing information representing a planned timing at which a work is undertaken, the function for displaying a result regarding whether a work can be undertaken or not further allows the computer to realize: a function for receiving an input of a final timing at which a work is displayed for receiving an input of work final display timing information showing a final timing at which a work is displayed,; and a function for determining the display of a judgment result for displaying, when a work has work information having planned undertaking timing information that is simultaneous with or earlier than the final display timing information and when the work has unit(s) of deliverable(s) larger than unit(s) of deliverable(s) of work completion information, the judgment result by the function for judging whether a work can be undertaken or not.

The invention (19) can provide the same effects as that by the invention (13).

(20) The program according to any of the inventions (17) to (19), wherein: the storage unit of the computer includes a storage area that at least stores work equalizing information for displaying, in order to equalize works of a manufacturing department, an amount of works to be done by the manufacturing department on a date and actually undertaken volume information showing the total of unit(s) of deliverable(s) of deliverables planned to be obtained when the work for which an undertaking instruction has been issued on the date is undertaken, the program further allows the computer to realize: a work equalizing information input reception function for receiving an input of the work equalizing information; and a work equalizing information display function for simultaneously displaying the work equalizing information and the actually undertaken volume information.

The invention (20) can provide the same effects as that by the invention (14).

However, when data of a field included in a table is changed due to an increase or decrease of components required for the manufacture for example, the production management support system of Patent Publication C1 as described above can automatically reflect the change on other related tables. However, the production management support system of Patent Publication C1 cannot add a field itself to the table and cannot reflect the addition of the field on other tables. However, in reality, there may be the need as described above to change, after the use of a database is started, a field of a table of the database. This will be described by an example of a shop floor subjected to production management for example. When an item master as one table of tables of a production management system has a new need to control an item color, an existing production management system requires a system manager to manually add an “item color” section to the item master. Furthermore, in order to specify “item color” in an ordering slip, it is also required to manually add an “item color” section to an ordering slip table and to manually change a database design so that data inputted to the “item color” section of the item master as described above can be reflected on the data of the “item color” section of the ordering slip table. Furthermore, it is also required to manually rewrite an application of the database. Thus, it is difficult that these works are performed only by a production shop floor. Thus, these works will be outsourced to a programmer for example.

Thus, it is an object of the present invention to provide a computer, a program, and a method that can easily add a field to a plurality of tables of a database. The present invention is also preferable for adding a field in a production management system for example as described above.

(21) A computer including a database having a plurality of tables, wherein: the computer includes a storage unit including a storage area, the storage area at least stores: the plurality of tables; table selection information showing the status of a table selected by a user from among the plurality of tables; additional field information showing a new field added to the table selected by the user; and the additional data inputted by the user regarding the new field, the computer includes: a table selection information input reception device for receiving an input of the table selection information by the user; an additional field information input reception device for receiving an input of the additional field information by the user regarding the selected table; an additional data input reception device for receiving an input of the additional data by the user; a field addition device for adding, based on the additional field information, the new field to the selected table; and a data substitution device for substituting the additional data to the new field.

According to the aspect of the invention (21), with regard to a database in the computer, an input of the table selection information, an input of the additional field information, and an input of additional data are received. As a result, a new field can be automatically added to an arbitrary table. Furthermore, based on the inputted information for the additional field, substitution of the data to the field can be performed automatically. This can omit a process by a system manager to manually add a field to a master table or to substitute the data to the field in every table. It is noted that the data substitution herein device an input of data to a field of a table.

(22) A computer including a database having a plurality of tables, wherein: the computer includes a storage unit including a storage area, the storage area at least stores: the plurality of tables; field-related information representing a dependency among a plurality of fields included in the plurality of tables; and data inputted by a user regarding the plurality of fields included in the plurality of tables, the computer includes: a field-related information input reception device for receiving an input of the field-related information by the user; a data input reception device for receiving an input of the data by the user; and a data substitution device for substituting, based on the field-related information, the data to the plurality of fields.

According to the aspect of the invention (22), by receiving, with regard to a database in the computer, an input of the field-related information and an input of data, the data can be automatically substituted to the fields in a plurality of tables based on the dependency among the inputted fields. This can omit a process by a system manager to manually investigate the dependency among fields for every tables to substitute the data to the fields. A field regarding the field-related information may be a newly added field or may be an existing field.

(23) A computer including a database having a plurality of tables, wherein: the computer includes a storage unit including a storage area, the storage area at least stores: the plurality of tables; table selection information representing the selection status of a table selected by a user from among the plurality of tables; additional field information representing a new field added to the table selected by a user; field-related information representing a dependency among a plurality of fields included in the plurality of tables; and additional data regarding the new field inputted by a user, the computer including: a table selection information input reception device for receiving an input of the table selection information by the user; an additional field information input reception device for receiving an input of the additional field information regarding the selected table by the user; a field-related information input reception device for receiving an input of the field-related information by the user; an additional data input reception device for receiving an input of the additional data by the user; a field addition device for adding, based on the additional field information, the new field to the selected table; and a data substitution device for substituting, based on the field-related information, the additional data to the plurality of fields at least including the new field.

According to the aspect of the invention (23), with regard to the database in the computer, an input of the table selection information, an input of the additional field information, an input of the field-related information, and an input of the additional data are received. As a result, new fields can be automatically added to a plurality of tables. Furthermore, data can be automatically substituted to the fields based on the dependency among the input fields. This can omit a process by a system manager to manually add a field to a master table or to substitute the data to the field in every related table. It is noted that a field regarding the field-related information may be a newly added field or may be an existing field.

(24) The computer according to any of the inventions (21) to (23), wherein: the field-related information is represented by a mathematical expression.

According to the aspect of the invention (24), even when fields to be newly added have a dependency having no simple copying relationship, the data can be substituted to the fields based on the mathematical expression representing the dependency.

(25) The computer according to the invention (24), comprising: the computer includes a mathematical expression input reception device for receiving an input of the mathematical expression by the user.

According to the aspect of the invention (25), a mathematical expression representing the dependency of fields can be arbitrarily defined by a user.

(26) The computer according to any of the inventions (21) to (23), wherein: the storage unit further includes an area for storing table relation information representing a dependency among the tables and the field-related information input reception device further includes a table relation information input reception device for receiving an input of the table relation information by the user.

According to the aspect of the invention (26), a user can arbitrarily input the table relation information. As a result, the dependency among fields will be determined based on the dependency among tables to which the fields belong. More specifically, the table relation information may be inputted by allowing a user to connect arbitrary tables by a line (e.g., arrow) by operating a mouse or the like for example. As a result, the user can input field-related information more freely and field-related information can be efficiently inputted via the table relation information without direct input of every pieces of field-related information.

(27) A program for allowing a computer to control a database having a plurality of tables, wherein: the computer includes a storage unit including a storage area, the storage area at least stores: the plurality of tables; table selection information representing the selection status of a table selected by a user from among the plurality of tables; additional field information representing a new field added to the table selected by a user; field-related information representing a dependency among a plurality of fields included in the plurality of tables; and additional data regarding the new field inputted by a user, the program allows the computer to realize: a table selection information input reception function for receiving an input of the table selection information by the user; an additional field information input reception function for receiving an input of the additional field information regarding the selected table by the user; a field-related information input reception function for receiving an input of the field-related information by the user; an additional data input reception function for receiving an input of the additional data by the user; a field addition function for adding, based on the additional field information, the new field to the selected table; and a data substitution function for substituting, based on the field-related information, the additional data the plurality of fields at least including the new field.

The invention (27) can provide the same effects as that by the invention (21).

(28) A method for adding a table field using a computer for controlling a database having a plurality of tables, wherein: the computer includes a storage unit including a storage area, the storage area at least storing: the plurality of tables; table selection information representing the selection status of a table selected by a user from among the plurality of tables; additional field information representing a new field added to the table selected by a user; field-related information representing a dependency among a plurality of fields included in the plurality of tables; and additional data regarding the new field inputted by a user, the method including: a table selection information input reception step for receiving an input of the table selection information by the user; an additional field information input reception step for receiving an input of the additional field information regarding the selected table by the user; a field-related information input reception step for receiving an input of the field-related information by the user; an additional data input reception step for receiving an input of the additional data by the user; a field addition step for adding, based on the additional field information, the new field to the selected table; and a data substitution step for substituting, based on the field-related information, the additional data the plurality of fields at least including the new field.

The invention (28) can provide the same effects as that by the invention (21).

(29) The computer according to any of the inventions (21) to (26), wherein: the computer is used for table control.

According to the aspect of the invention (29), a work by a system manager to substitute data to a field of a table can be performed easily. As a result, the table can be controlled efficiency.

(30) The computer according to any of the inventions (21) to (26), wherein: the computer is used for production control.

According to the aspect of the invention (30), a shop floor subjected to production management in the manufacturing business can receive the same effects as those by the inventions (21) to (26). Thus, the production management can be performed efficiency.

It is an object of the present invention to provide a production management apparatus, a production management program, a computer-readable recording medium for recording the production management program, and a production management method that can appropriately cope with, even in the case of a so-called custom-made product, the challenge as described above such as a change due to a request from a customer.

In order to solve the disadvantages as described above, the present invention provides the followings.

(31) A production management apparatus, comprising: a storage device for storing at least a component ordered while being associated with a production number; a changed BOM preparation device for preparing a changed BOM based on changed CAD data; a changed component calculation device for comparing a component included in the prepared changed BOM with the component stored in the storage device to calculate a to-be-canceled component of the production number and a to-be-additionally-ordered component; and a display device for displaying the calculated to-be-canceled component and to-be-additionally-ordered component.

(32) The production management apparatus according to the invention (31), further comprising: an input reception device for receiving an input of CAD data; a production BOM preparation device for preparing a production BOM based on the received input of CAD data; and a to-be-ordered component calculation device for calculating a to-be-ordered component based on the prepared production BOM so that the to-be-ordered component is associated with an order number.

(33) The production management apparatus according to the invention (31) or (32), further comprising: an acquisition device for acquiring information regarding whether the displayed to-be-canceled component can be cancelled or not; and a slip issue device for issuing a slip for canceling the cancelable component and a slip for a to-be-additionally-ordered component. It is preferred that the production management apparatus removes a production number from non-cancelable component and treat it as an inventory.

(34) A production management program, wherein the program causes a computer as a production management apparatus to function as: a storage device for storing at least a component ordered while being associated with a production number; a changed BOM preparation device for preparing a changed BOM based on changed CAD data; a changed component calculation device for comparing a component included in the prepared hanged BOM with the component stored in the storage device to calculate a to-be-canceled component of the production number and a to-be-additionally-ordered component; and a display device for displaying the calculated to-be-canceled component and to-be-additionally-ordered component.

(35) The production management program according to the invention (34), wherein the program allows the computer to additionally function as: an input reception device for receiving an input of CAD data; a production BOM preparation device for preparing a production BOM based on the received input of CAD data; and a to-be-ordered component calculation device for calculating a to-be-ordered component based on the prepared production BOM so that the to-be-ordered component is associated with a production number.

(36) The production management program according to the invention (34) or (35), comprising the program allows the computer to additionally function as: an acquisition device for acquiring information regarding whether the displayed to-be-canceled component can be cancelled or not; and a slip issue device for issuing a slip for canceling the cancelable component and a slip for a to-be-additionally-ordered component.

(37) The computer-readable recording medium for recording a production management program according to any of the inventions (34) to (36).

(38) A computer-based production management method, comprising: a step for storing at least a component ordered while being associated with a production number; a step for preparing a changed BOM based on changed CAD data; a step for comparing a component included in the prepared hanged BOM with the component stored in the storage step to calculate a to-be-canceled component of the production number and a to-be-additionally-ordered component; and a step for displaying the calculated to-be-canceled component and to-be-additionally-ordered component.

(39) The computer-based production management method according to the invention (38), comprising: the method performs, prior to the storing step, a step for receiving an input of CAD data by an input reception device; a step for preparing a production BOM based on the received input of CAD data; and a step for calculating a to-be-ordered component based on the prepared production BOM so that the to-be-ordered component is associated with a production number.

(40) The computer-based production management method according to the invention (38) or (39), comprising: the method further including: a step for acquiring information regarding whether the displayed to-be-canceled component can be cancelled or not; and a step for issuing a slip for canceling the cancelable component and a slip for a to-be-additionally-ordered component.

The use of the production management apparatus according to the invention (31) can provide the following effects. First, even when a component is previously ordered in order to complete the product with a short deadline, the component ordered while being associated with a production number is at least stored in the storage device. Even when the design is changed due to a subsequent change of an intention of a customer for example, a changed BOM is prepared by the changed BOM preparation device based on the changed CAD data. Next, the changed component calculation device is used to compare a component included in the prepared hanged BOM with the component stored in the storage device to calculate a to-be-canceled component of the production number and a to-be-additionally-ordered component. Next, the calculated to-be-canceled component and to-be-additionally-ordered component are displayed by the display device. The display of the calculated to-be-canceled component and to-be-additionally-ordered component allows a user of the production management apparatus to understand, even when the design is changed due to an intention of a customer or the like, the to-be-canceled component and to-be-additionally-ordered component that must be specifically handled. As a result, the user can investigate, through the displayed contents, whether the to-be-canceled component is cancelable or not. As a result, even a challenge such as a change due to a request from a customer can be appropriately handled.

The use of the production management apparatus according to the invention (32) not only provides the device described in the invention (31) but also allows the input reception device to receive an input of CAD data. Thereafter, a production BOM is prepared based on the CAD data received by the production BOM preparation device. The to-be-ordered component calculation device calculates, based on the prepared production BOM, a to-be-ordered component associated with the production number. This can provide, in addition to the effects described for the invention (31), an appropriate ordering by a user of a component to be previously ordered.

The use of the production management apparatus according to the invention (33) allows the acquisition device to provide information showing whether the displayed to-be-canceled component can be cancelled or not. More specifically, a user can ask a component vendor or the like whether the component can be cancelled or not to input the result to the production management apparatus according to the present invention. Then, the slip issue device issues a canceling slip for the cancelable component and a slip for a to-be-additionally-ordered component. This provides the effects described for the invention (31) or (32) and allows, even when a challenge such as a change or the like by a request from a customer is caused, the user to promptly cancel the cancelable component and to order the to-be-additionally-ordered component. Thus, a problem can be solved such as the one in which an order that would have been able to be cancelled at an earlier stage cannot be cancelled because notification that the ordered component is no more required is made too late. Furthermore, through the information immediately and automatically displayed after the change is inputted, a user can recognize a component to be additionally ordered. Then, the user can order the component. This provides an increased possibility of avoiding a problem where a component having a long delivery date causes a risk where all components cannot be collected for the assembly to delay the delivery date. When the desirable structure of the present invention is used, a production number is cancelled with regard to a component that cannot be cancelled and that can be used for another work and the inventory is processed. Thus, an amount of disposed components can be reduced.

By allowing a computer to read the production management program according to the aspects of the inventions (34) to (36), the same device as those of the inventions (34) to (33) are caused to function. Thus, the same effects can be provided.

Furthermore, by allowing a computer to read the computer-readable recording medium for recording the production management program according to the invention (37), the same device as those of the inventions (31) to (33) are caused to function. Thus, the same effects can be provided.

Alternatively, the computer-based production management method according to the aspects of the inventions (38) to (40) also can provide the same effects.

Here, the term “production number” device a manufacture number that is allocated for controlling the manufacture. Some companies simply call the production number as “SAKUBAN”. The term “cancellation of a production number” device a processing for separating, from a component, a production number stored in the storage device while being associated with the component. For example, the term “cancellation of a production number” device to change a production number stored while being associated with a component to another mark.

There have been another inconvenience where, when an MRP production management system is used to calculate a requirement with an arbitrary timing and when a completion value is smaller than a value in a plan, the requirement is calculated based on the value and the completion value to cause a slip for the shortage to the plan to be issued, even when a responsible person of a shop floor judges that the shortage can be compensated by the next process based on the past completion or the like.

It is an object of the present invention to provide a production management apparatus, a production management program, a computer-readable recording medium for recording the production management program, and a production management method that can solve the inconvenience as described above to perform production management in a preferred manner.

In order to solve the above challenge, the present invention provides the followings.

(41) A production management apparatus based on Material Requirements Planning for calculating, based on a production BOM and inventory information, an amount of material to be ordered and an ordering timing, comprising: a completion value input device for inputting, with regard to an already-executed work item among work items to be executed in a production schedule, the real completion value thereof; a theoretical inventory value input device for inputting a theoretical inventory value for the material requirement calculation; an inventory data update device for using the completion value inputted to the completion value input device to update inventory data of the already-executed work item; and a requirement calculation device for using the theoretical inventory value inputted to the theoretical inventory value input device and the inventory data updated by the inventory data update device to calculate the next requirement.

(42) A production management program for allowing a computer to function as a production management apparatus based on Material Requirements Planning for calculating, based on a production BOM and inventory information, an amount of material to be ordered and an ordering timing, comprising the program allows the computer to function as: a completion value input device for inputting, with regard to an already-executed work item among work items to be executed in a production schedule, the real completion value thereof; a theoretical inventory value input device for inputting a theoretical inventory value for the material requirement calculation; an inventory data update device for using the completion value inputted to the completion value input device to update inventory data of the already-executed work item; and a requirement calculation device for using the theoretical inventory value inputted to the theoretical inventory value input device and the inventory data updated by the inventory data update device to calculate the next requirement.

(43) The computer-readable recording medium for recording a production management program according to the invention (42).

(44) A production management method based on Material Requirements Planning using a computer for calculating, based on a production BOM and inventory information, an amount of material to be ordered and an ordering timing, comprising: a field for inputting, with regard to an already-executed work item among work items to be executed in a production schedule, the real completion value thereof; and a field for inputting a theoretical inventory value for the material requirement calculation, and the method comprising: a step for using the inputted completion value to update inventory data of the already-executed work item; and a step for using the inputted theoretical inventory value and the inventory data updated in the step for updating the inventory data to calculate the next requirement.

The use of the production management apparatus according to the invention (41) can provide the effects as shown below. With regard to an already-executed work item among work items to be executed in a production schedule, the real completion value thereof is inputted to the completion value input device. Based on the inputted completion value, the inventory data of the already-executed work item is updated by the inventory data update device. On the other hand, even when a completion value is smaller than a planned value, the theoretical inventory value input device can input the difference as a theoretical inventory value when a responsible person of a shop floor judges that the difference can be compensated by the next process based on the past completion or the like. Based on the inputted theoretical inventory value and the inventory data updated by the inventory data update device, the next requirement is calculated by the requirement calculation device. As a result, when the next requirement is calculated, inventory in an amount that has been judged as compensatable by the responsible person of the shop floor is assumed as existing. This can eliminate the inconvenience as in a conventional technique where a slip for the shortage is issued even when the responsible person of the shop floor judges that the shortage can be compensated by the next process based on the past completion or the like.

By allowing a computer to read the production management program according to the invention (42), the same device as that of the invention (41) is caused to function. Thus, the same effects can be provided.

Furthermore, by allowing a computer to read the computer-readable recording medium for recording the production management program according to the invention (43), the same device as that of the invention (41) is caused to function. Thus, the same effects can be provided.

Furthermore, the computer-based production management method according to the invention (44) also can provide the same effects.

It is an object of the present invention to provide a production management apparatus, a production management program, a computer-readable recording medium for recording the production management program, and a production management method that automatically calculate, based on completion data of the respective processes, whether individual working places where production management is performed are prepared for production or not and that display the result so that a user can take a specific measure easily so that the production management can be performed efficiently.

In order to solve the challenges as described above, the present invention provides the followings.

(45) A production management apparatus, comprising: a respective pieces of process information input device for inputting, with regard to a production schedule, the respective pieces of process information including a schedule or a result of delivery or completion of material or a component; a storage device for storing the inputted respective pieces of process information and production management information of the production schedule; a production preparation situation calculation device for calculating, based on the respective pieces of process information and production management information stored in the storage device, a production preparation situation at a desired investigation time; and a production situation display device for displaying the calculated production preparation situation and the production management information.

The term “desired investigation time” device a time at which a user of the production management apparatus desires to investigate a production preparation situation or the like. With regard to some types of products to be produced, the “desired investigation time” may be represented on the basis of hour or day.

(46) The production management apparatus according to the invention (45), further comprising: a capacity requirement(i.e. number of required workers, materials, or machines in a particular process or workplace) calculation device for calculating, based on the production management information of the production schedule, a capacity requirement; and a capacity requirement display device for displaying the capacity requirement so as to be associated with the production preparation situation and the production management information.

(47) The production management apparatus according to the invention (46), wherein: the production management apparatus further includes a reception and input device for receiving the respective pieces of process information from at least one terminal via a communication line, and based on the received respective pieces of process information and the production management information stored in the storage device, the production preparation situation calculation device calculates a production preparation situation at a desired investigation time and the capacity requirement calculation device calculates a capacity requirement at a desired investigation time.

(48) The production management apparatus according to the invention (46) or (47), wherein: the production management apparatus further includes a change input device for inputting a change of the displayed production management information regarding predetermined material or component, based on the inputted change of the production management information, the production preparation situation calculation device calculates a production preparation situation at a desired investigation time and the capacity requirement calculation device calculates a capacity requirement at a desired investigation time.

(49) The production management apparatus according to any of the inventions (45) to (48), wherein: the production management apparatus further includes a production resource information input device, the storage device further stores the production resource information, and the production preparation situation calculation device calculates the production preparation situation at the desired investigation time in consideration of the production resource information stored in the storage device.

(50) The production management apparatus according to any of the inventions (45) to (49), wherein: the production preparation situation calculation device calculates a production preparation situation in a predetermined period before and after the desired investigation time, and the capacity requirement calculation device calculates a capacity requirement in a predetermined period before and after the desired investigation time.

(51) A production management program characterized in allowing a computer as a production management apparatus to function as: a respective pieces of process information input device for inputting, with regard to a production schedule, the respective pieces of process information including a schedule or a result of delivery or completion of material or a component; a storage device for storing the inputted respective pieces of process information and production management information of the production schedule; a production preparation situation calculation device for calculating a production preparation situation at a desired investigation time based on the respective pieces of process information and production management information stored in the storage device; and a production situation display device for displaying the calculated production preparation situation and the production management information.

(52) The production management program according to the invention (51), wherein: the production management program further allows the computer to function as: a capacity requirement calculation device for calculating, based on the production management information of the production schedule, a capacity requirement, and a capacity requirement display device for displaying the capacity requirement so as to be associated with the production preparation situation and the production management information.

(53) The production management program according to the invention (52), wherein: the production management program further allows the computer to function as: a reception and input device for receiving the respective pieces of process information from at least one terminal via a communication line, and based on the received respective pieces of process information and the production management information stored in the storage device, the production preparation situation calculation device is caused to calculate a production preparation situation at a desired investigation time and the capacity requirement calculation device is caused to a capacity requirement at a desired investigation time.

(54) The production management program according to the invention (52) or (53), wherein: the production management program further allows the computer to function as: a change input device for inputting a change of the displayed production management information regarding predetermined material or component, and based on the inputted change of the production management information, the production preparation situation calculation device is further caused to calculate a production preparation situation at a desired investigation time and the capacity requirement calculation device is further caused to calculate a capacity requirement.

(55) The production management program according to any of the inventions (51) to (54), wherein: the production management program further allows the computer to function as a production resource information input device, a storage device is caused to further store the inputted production resource information, and the production preparation situation calculation device is caused to calculate the production preparation situation at the desired investigation time in further consideration of the production resource information stored in the storage device.

(56) The production management program according to any of the inventions (51) to (55), wherein: the production preparation situation calculation device is caused to calculate a production preparation situation in a predetermined period before and after the desired investigation time, and the capacity requirement calculation device is caused to calculate a capacity requirement in a predetermined period before and after the desired investigation time.

(57) The computer-readable recording medium for recording a production management program according to any of the inventions (51) to (56).

(58) A computer-based production management method, comprising: a respective pieces of process information input step for inputting, with regard to a production schedule, the respective pieces of process information including a schedule or a result of delivery or completion of material or a component: a storage step for storing the inputted respective pieces of process information and production management information of the production schedule; a production preparation situation calculation step for calculating, based on the respective pieces of process information and production management information stored in the storage step, a production preparation situation at a desired investigation time; and a production situation display step for displaying the calculated production preparation situation and the production management information.

(59) The computer-based production management method according to the invention (58), further comprising: a capacity requirement calculation step for calculating, based on the production management information of the production schedule, a capacity requirement; and a capacity requirement display step for displaying the capacity requirement so as to be associated with the production preparation situation and the production management information.

(60) The computer-based production management method according to the invention (59), wherein: the method further includes a reception and input step for receiving the respective pieces of process information from at least one terminal via a communication line, based on the received respective pieces of process information and the production management information stored in the storage step, the production preparation situation calculation step calculates a production preparation situation at a desired investigation time and the capacity requirement calculation step calculates a capacity requirement at a desired investigation time.

(61) The computer-based production management method according to the invention (59) or (60), wherein: the method further includes a change input step for inputting a change of the displayed production management information regarding predetermined material or component, based on the inputted change of the production management information, the production preparation situation calculation step calculates a production preparation situation at a desired investigation time and the capacity requirement calculation step calculates a capacity requirement at a desired investigation time.

(62) The computer-based production management method according to any of the inventions (58) to (61), wherein: the method further includes a production resource information input step, the storage step further stores the production resource information, and the production preparation situation calculation step calculates the production preparation situation at the desired investigation time in consideration of the production resource information stored in the storage step.

(63) The computer-based production management method according to any of the inventions (58) to (62), wherein: the production preparation situation calculation step calculates a production preparation situation in a predetermined period before and after the desired investigation time, and the capacity requirement calculation step calculates a capacity requirement in a predetermined period before and after the desired investigation time.

The use of the production management apparatus according to the invention (45) can provide effects as shown below. The respective pieces of process information input device inputs, with regard to a production schedule, the respective pieces of process information including a schedule or a result of delivery or completion of material or a component. The inputted respective pieces of process information and the production management information of the production schedule are stored in the storage device. Based on the respective pieces of process information and the production management information stored in the storage device, the production preparation situation calculation device calculates a production preparation situation at a desired investigation time. The production preparation situation and the production management information calculated by the production situation display device are displayed. Whether individual working places where production management is performed are ready for production or not is automatically calculated based on the completion data of the respective processes and the result related to a working place controlled by a user is selected and displayed. As a result, managers of individual working places can appropriately judge whether the next process can be performed or not in accordance with completions in the respective processes at the time. Thus, production management can be performed efficiently. In this case, the production preparation situation and the display by the production situation display device desirably represent a case where all components are delivered and preparation is provided by “◯” or the like for example so that the case can be judged intuitively. Similarly, a case where components are partially delivered and the work can be partially undertaken is desirably displayed by “Δ” or the like and a case where components are not delivered at all and the work cannot be undertaken is desirably displayed by “X” or the like so that the managers of individual working places can make a judgment intuitively.

The use of the production management apparatus according to the invention (46) can provide the following effects. In addition to the effects by the production management apparatus according to the invention (45), the capacity requirement calculation device calculates the capacity requirement based on the production management information of the production schedule. The calculated capacity requirement is displayed by the capacity requirement display device while being associated with the production preparation situation and the production management information. This allows a manager of a shop floor to comprehensively judge the production preparation situation together with the capacity requirement. This also allows the manager to easily take, when a problem is caused, a measure against the problem based on the how many loads are piled up in the working place for which the manager is responsible.

The use of the production management apparatus according to the invention (47) can provide the following effects. The reception and input device receives the respective pieces of process information from at least one terminal via the communication line. Specifically, the respective pieces of process information are directly received form a terminal of a component supplier via a communication line for example. This can save a significant amount of personnel cost compared to a case where a person responsible for the material who controls the supply of the component inputs an inquiry for a delivery date of each component to the supplier. This also can prevent confusion due to a wrong input. Furthermore, based on the received respective pieces of process information, the production preparation situation calculation device calculates a production preparation situation at a desired investigation time and the capacity requirement calculation device calculates a capacity requirement at a desired investigation time. This allows, even when a schedule of an external supplier is changed, a person responsible for material to immediately confirm, through the display device, the production preparation situation and the capacity requirement on which the effects are reflected and to examine an appropriate measure.

More specifically, a terminal of a supplier for a component or an outsourced processing is connected to the production management apparatus via a communication line. Generally, an ordering slip for the component or the outsourced processing and a requested delivery date are displayed to the supplier. When the supplier cannot meet this request, then the supplier inputs a possible delivery date via the terminal. Alternatively, depending on a case, the supplier does not change the requested delivery date but changes the requested amount to the number of components or materials that can be delivered to input the changed amount. When the request for postponing the delivery date or for changing the number of components or materials to be delivered as described above is received, it is very important to find whether the request causes a problem in the production schedule or not. Specifically, even when these changes are caused, the subsequent processes can be carried out as planned if the effect by the changes are within an anticipated defect rate in the production schedule or within a margin of the process. Alternatively, the subsequent processes also can be carried out as scheduled if there is inventory that can be reserved. However, in a case other than the above cases, the subsequent processes must be changed. Each working place where production management is performed needs to immediately find whether the problem as described above exists or not. The use of the production management apparatus according to the present invention allows the production preparation situation calculation device and the capacity requirement calculation device to recalculate and to display the effect As described later, the production management apparatus according to the present invention allows a manager of each working place to find a problematic point in the schedule at a glance because, when a postponed delivery date of a process is later than a date at which another process following this process is to be undertaken for example, the schedule bar of the process is displayed by a frame by a thick line and a line connecting these processes is displayed in a backward direction. The effects as described above is remarkable when a large amount of data exists. In this manner, a problem in production can be grasped in an efficient manner.

The use of the production management apparatus according to the invention (48) can provide the following effects. The production management apparatus according to the invention (46) or (47) allows a user, in a case where the user sees the production preparation situation and the capacity requirement to subsequently judge that the problem can be solved by changing a production place or the like, to input the change via the change input device. Alternatively, the user also can specify a production process from among displayed production management information to change a date at which the process is undertaken. When the change is inputted, the production preparation situation calculation device calculates, based on the production management information for which the change has been inputted, a production preparation situation at a desired investigation time and the capacity requirement calculation device calculates the capacity requirement. As a result, the user can actually issue an instruction for the change after checking an effect on the production situation and the capacity requirement when the change is actually executed.

The use of the production management apparatus according to the invention (49) can provide the following effects. In addition to the effects by the production management apparatus according to any of the inventions (45) to (48), the production resource information input device is further provided. Furthermore, the production preparation situation calculation device calculates the production preparation situation at the desired investigation time in consideration of the production resource information stored in the storage device. Here, the production resource includes, for example, resource required for the production such as manpower, equipment, and tools. For some types of products, the production resource is a key for the production process. The invention provides an advantage where a manager or the like of a shop floor makes a comprehensive judgment in consideration of information for the component or the like in addition to the above information.

The use of the production management apparatus according to the invention (50) can provide the following effects. In the production management apparatus according to any of the inventions (45) to (49), the production preparation situation calculation device calculates the production preparation situation within a predetermined period before and after a desired investigation time and the capacity requirement calculation device calculates a capacity requirement in a predetermined period before and after the desired investigation time. The predetermined period is different depending on the type of a product subjected to production control. A period starting from a date one week earlier than the desired investigation time and ending at a date one week later than the desired investigation time for example also can be specified as a predetermined period. By specifying a period that is most convenient for the user and that is most suitable for the type of the product in advance, the most appropriate measure considering time can be examined in a comprehensive manner.

The same effects can be provided by causing the same device as those of the inventions (45) to (50) to function by allowing a computer to read the production management program according to the aspects of the inventions (51) to (56).

Furthermore, the same effects can be provided by causing the same device as those of the inventions (54) to (50) to function by allowing a computer to read the computer-readable recording medium for recording the production management program according to the invention (57).

Alternatively, the same effects can be provided by the computer-based production management method according to the aspects of the inventions (58) to (63).

### BRIEF DESCRIPTION OF THE DRAWINGS

FIG. 1A is a block diagram illustrating an entire structure of a system according to the present invention.

FIG. 2A is a block diagram illustrating the structure of a personal computer A3.

FIG. 3A is a block diagram illustrating the structure of server A4.

FIG. 4A is a block diagram illustrating an example of the structure of information to be displayed on a screen displayed by a display unit A34 by a control unit A31 of a personal computer A3.

FIG. 5A is a block diagram illustrating another example of the structure of information to be displayed on a screen displayed by the display unit A34 by the control unit A31 of the personal computer A3.

FIG. 6A is a block diagram illustrating another example of the structure of information to be displayed on a screen displayed by the display unit A34 by the control unit A31 of the personal computer A3.

FIG. 7A illustrates an example of component information according to the present invention.

FIG. 8A illustrates an example of manufacturing process information according to the present invention.

FIG. 9A illustrates an example of component inventory or ordering information according to the present invention.

FIG. 10A illustrates an example of manufacturing process load information according to the present invention.

FIG. 11A illustrates an example of lead time information according to the present invention.

FIG. 12A illustrates an example of information for the number of ordering lot(s) according to the present invention.

FIG. 13A is a flow diagram illustrating a procedure for judging whether a new order can be accepted or not.

FIG. 14A is a flow diagram illustrating a procedure for judging whether a new order can be accepted or not.

FIG. 15A is a flow diagram illustrating a procedure for judging whether a new order can be accepted or not.

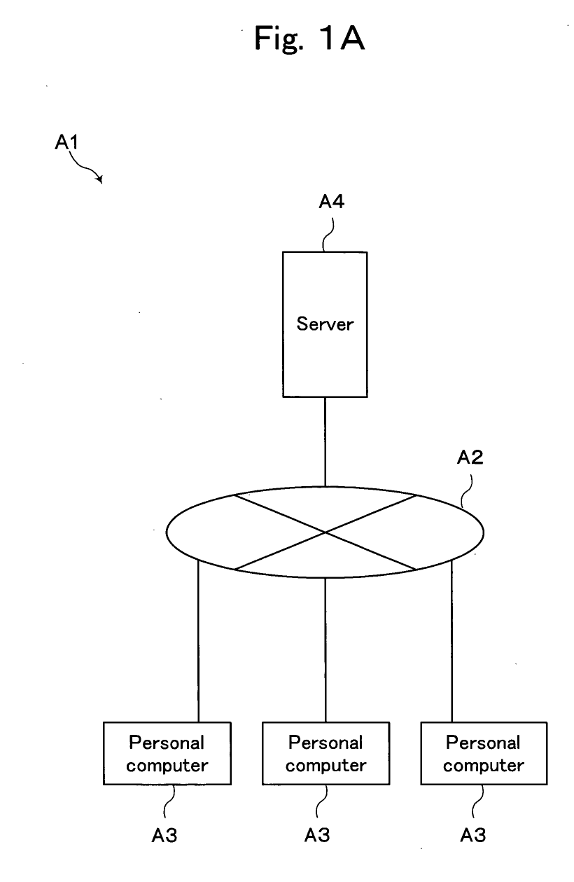

FIG. 1B is a block diagram illustrating an entire structure of a computer according to the present invention.

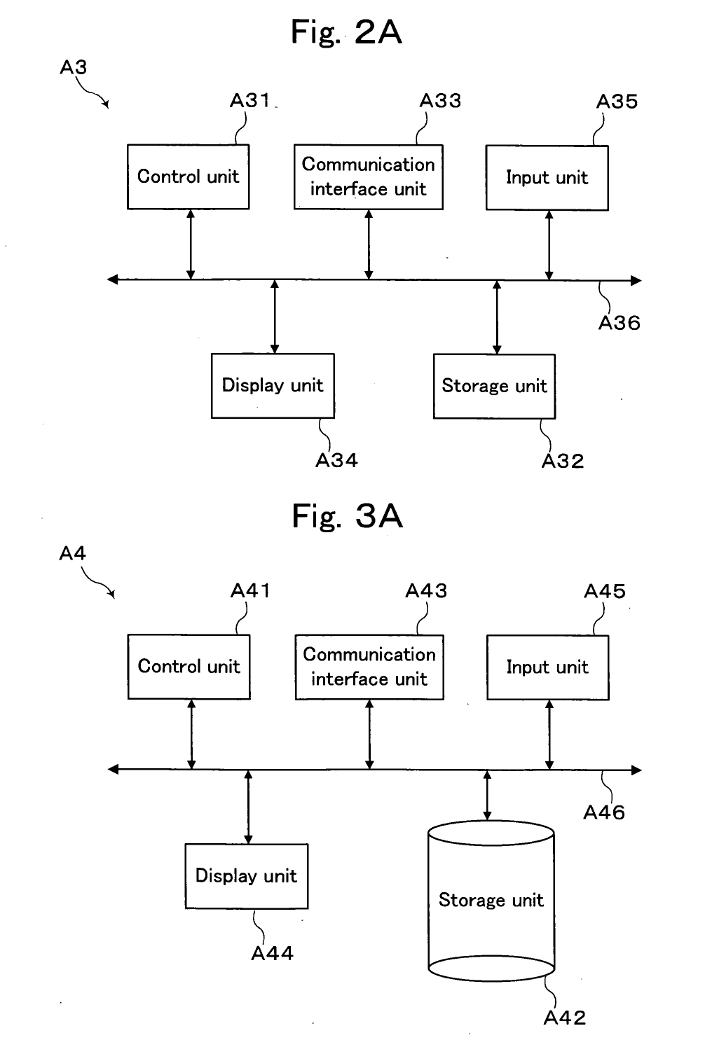

FIG. 2B illustrates an example of a screen to which resource status information is inputted that is displayed by the display unit B14 by the control unit B11 of the computer B1.

FIG. 3B illustrates another example of the screen to which resource status information is inputted that is displayed by the display unit B14 by the control unit B11 of the computer B1.

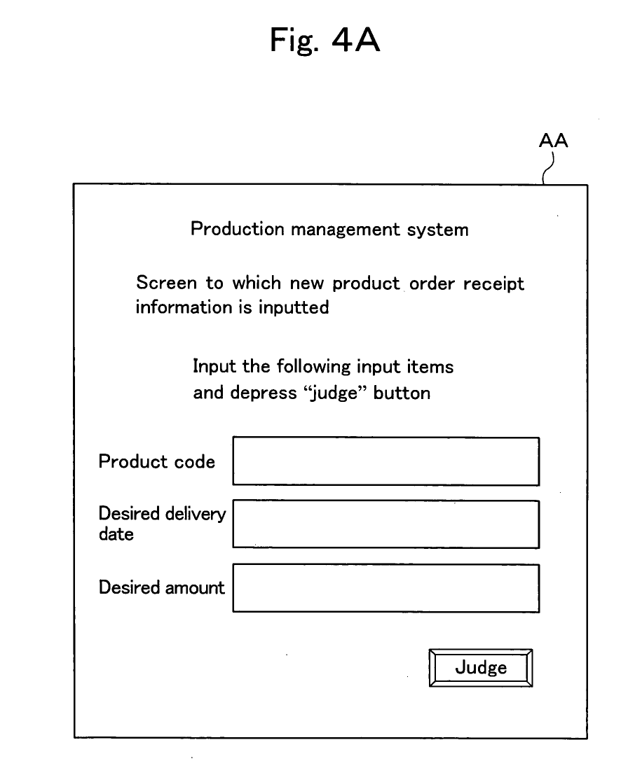

FIG. 4B illustrates still another example of the screen to which resource status information is inputted that is displayed by the display unit B14 by the control unit B11 of the computer B1.

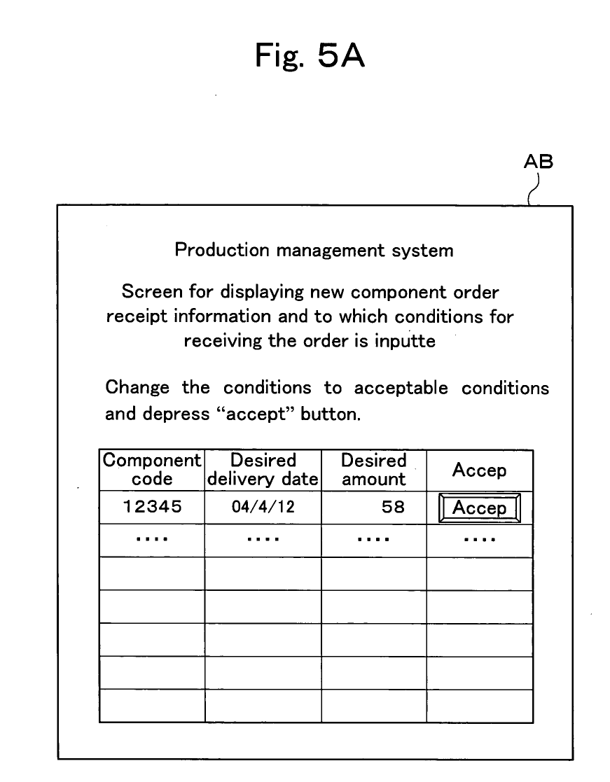

FIG. 5B illustrates an example of a deliverables information input screen displayed by the display unit B14 by the control unit B11 of the computer B1.

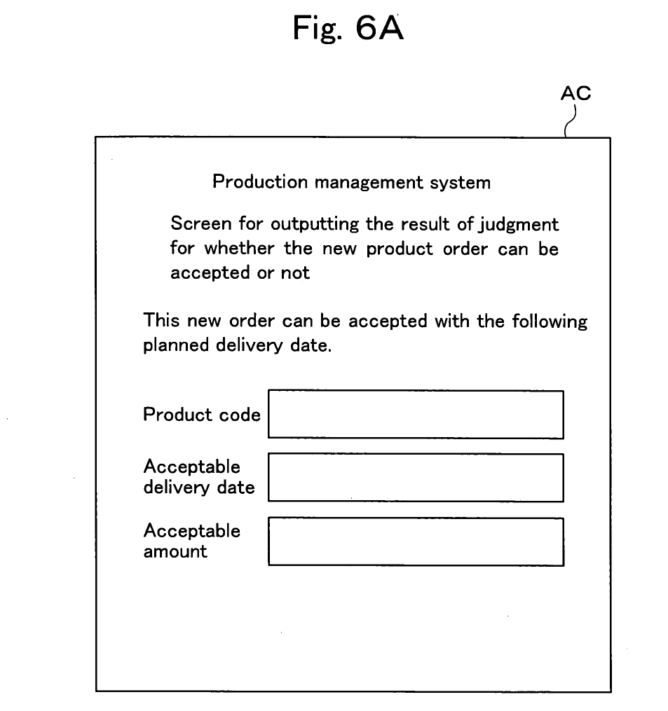

FIG. 6B illustrates an example of a screen to which resource request information is inputted that is displayed by the display unit B14 by the control unit B11 of the computer B1.

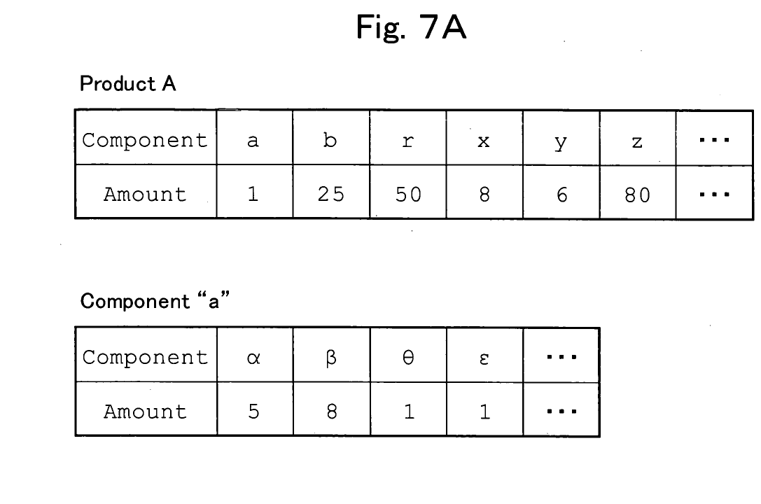

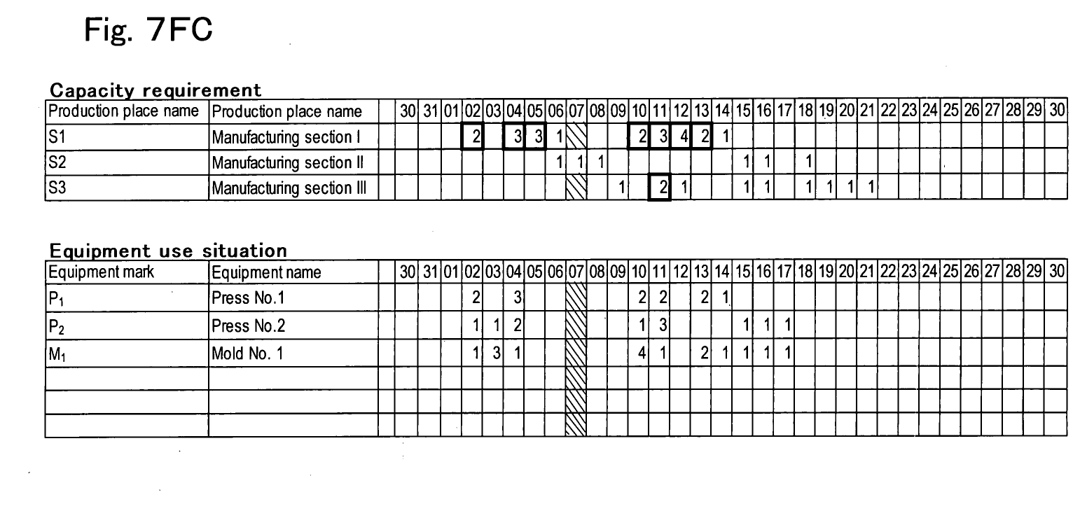

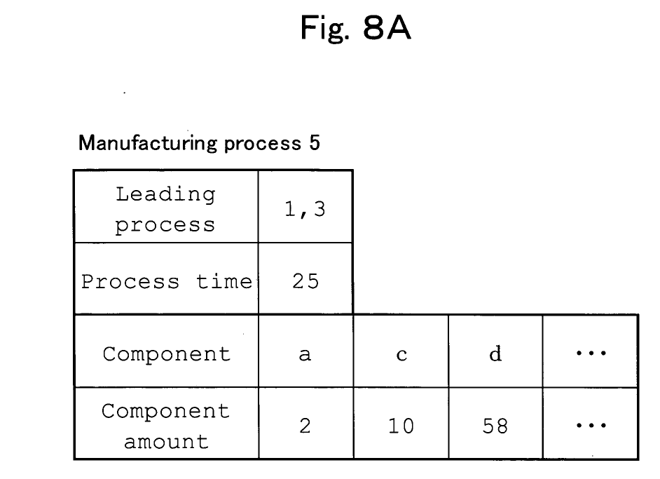

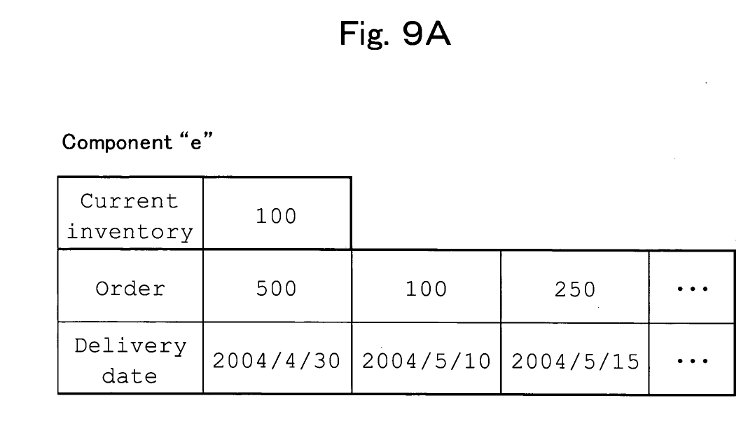

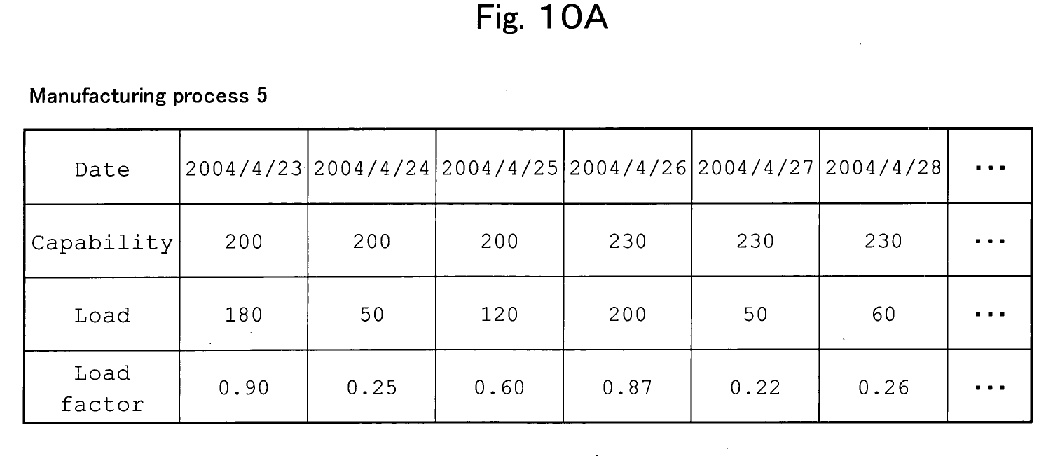

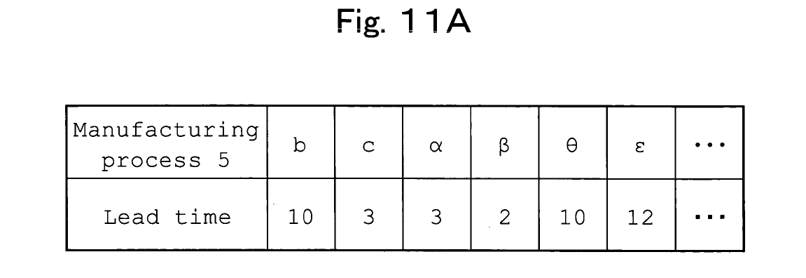

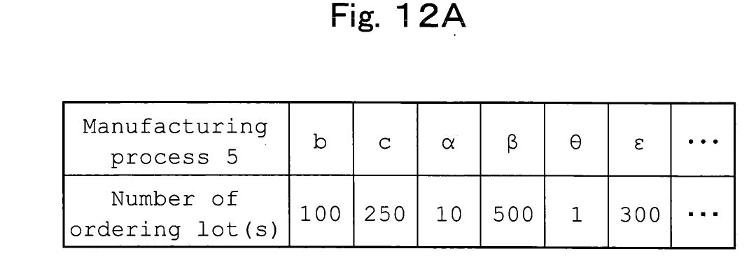

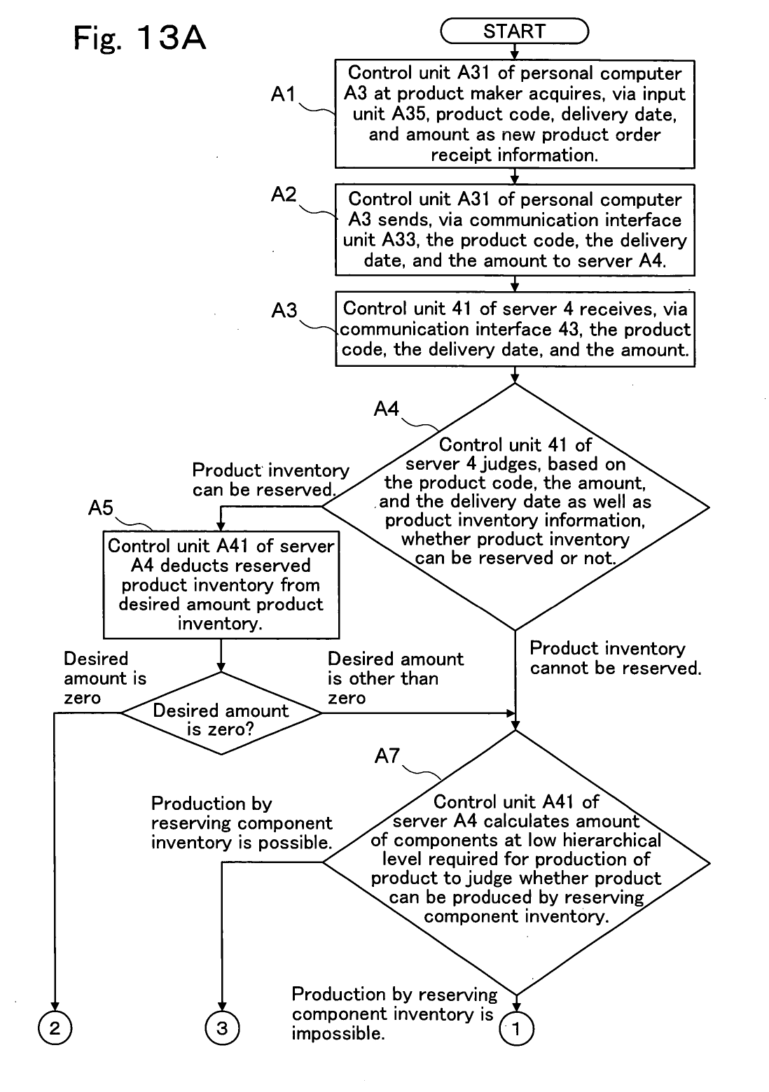

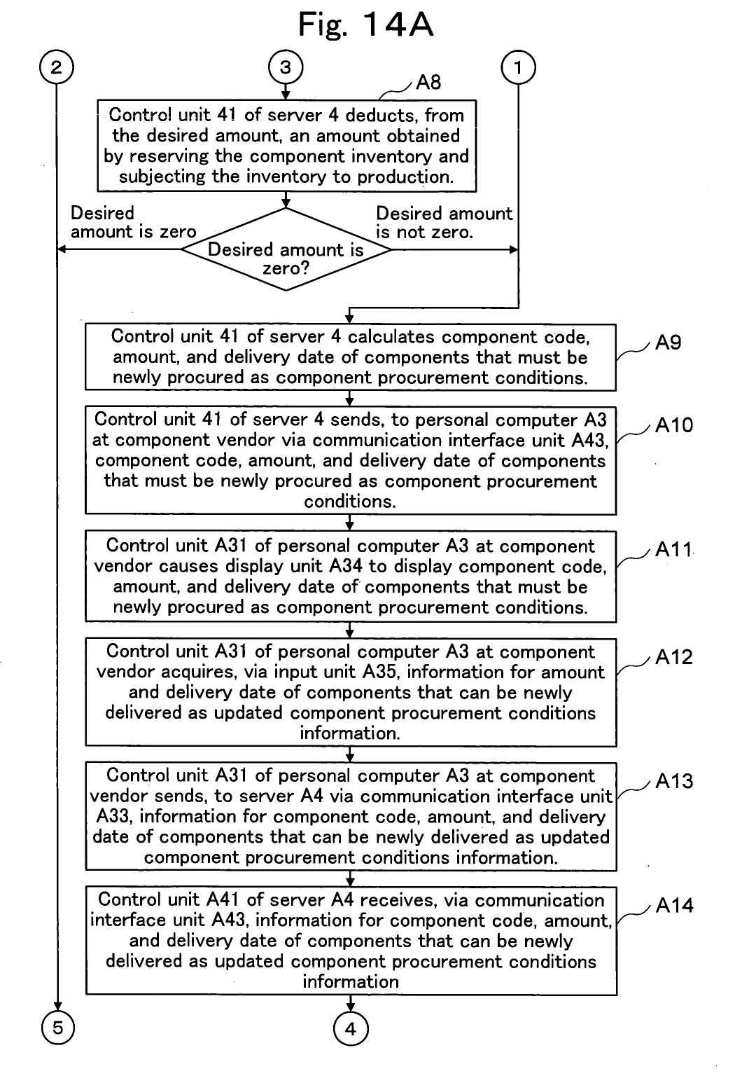

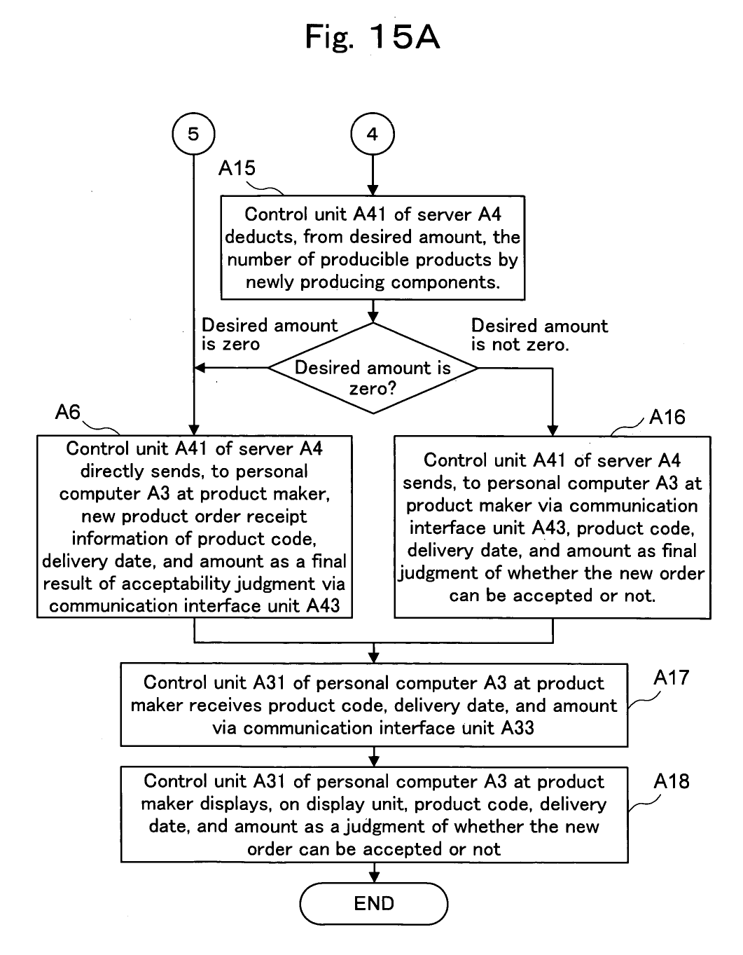

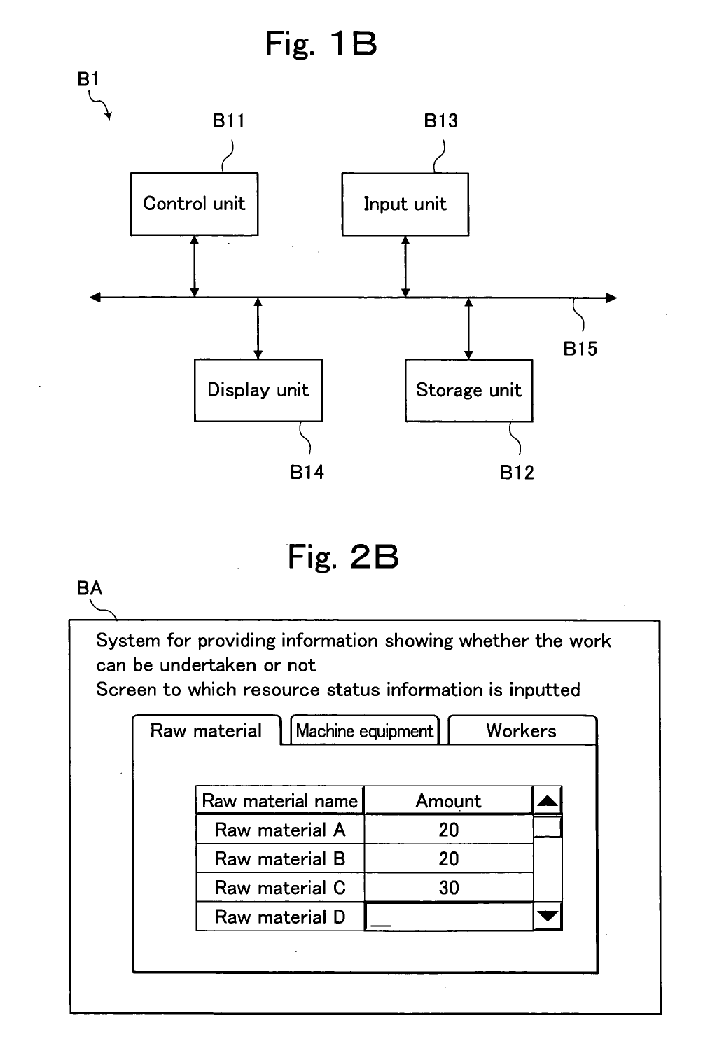

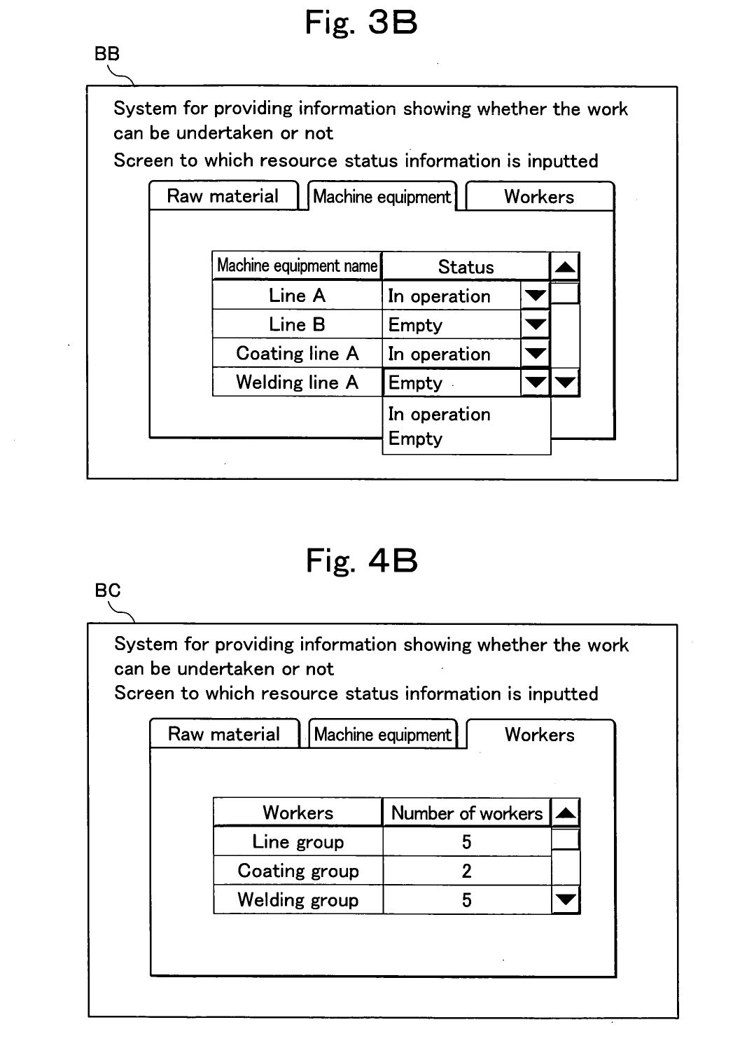

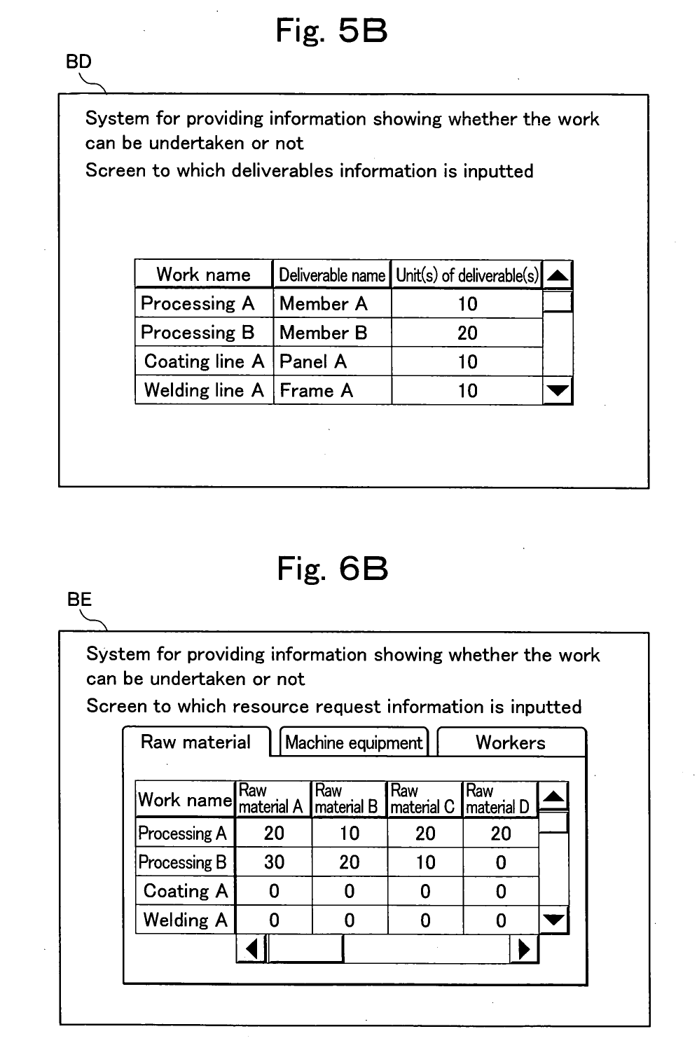

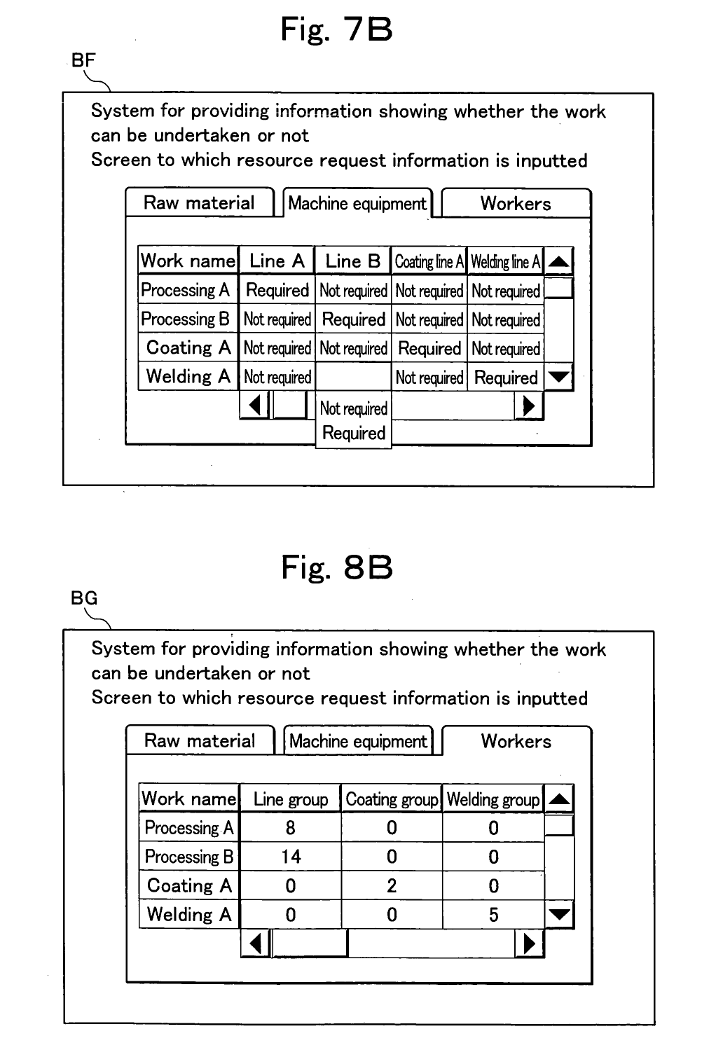

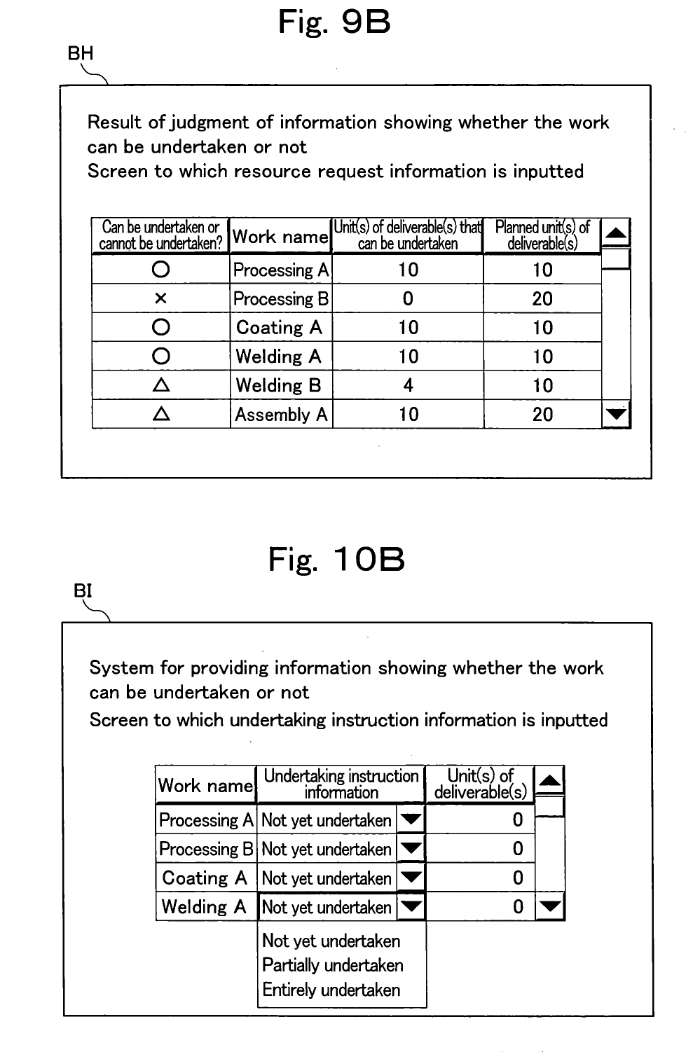

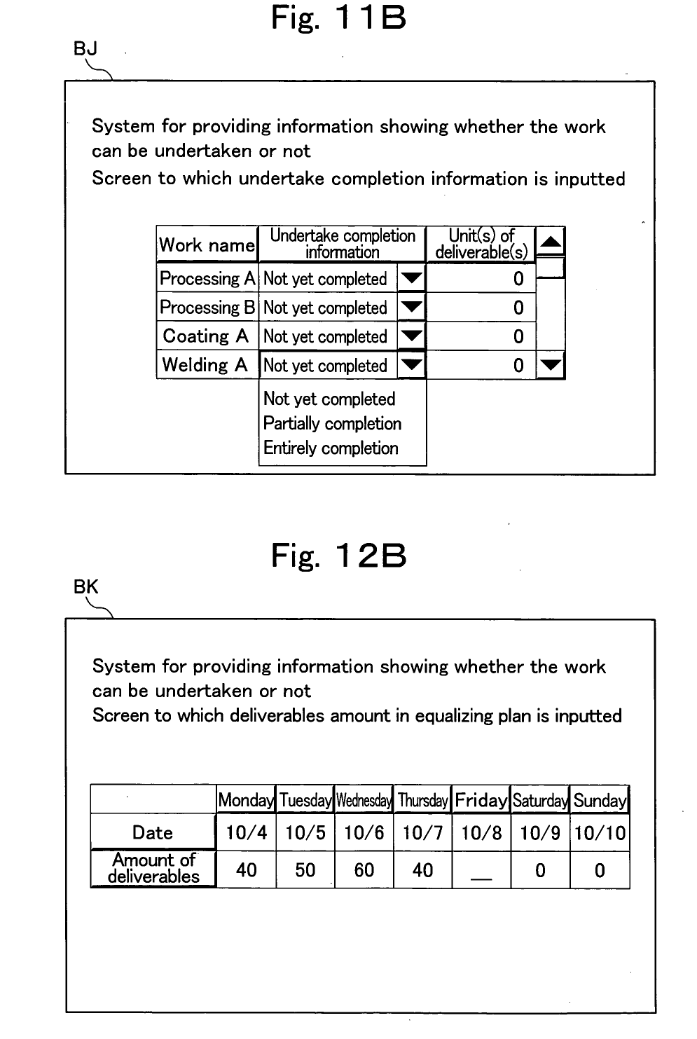

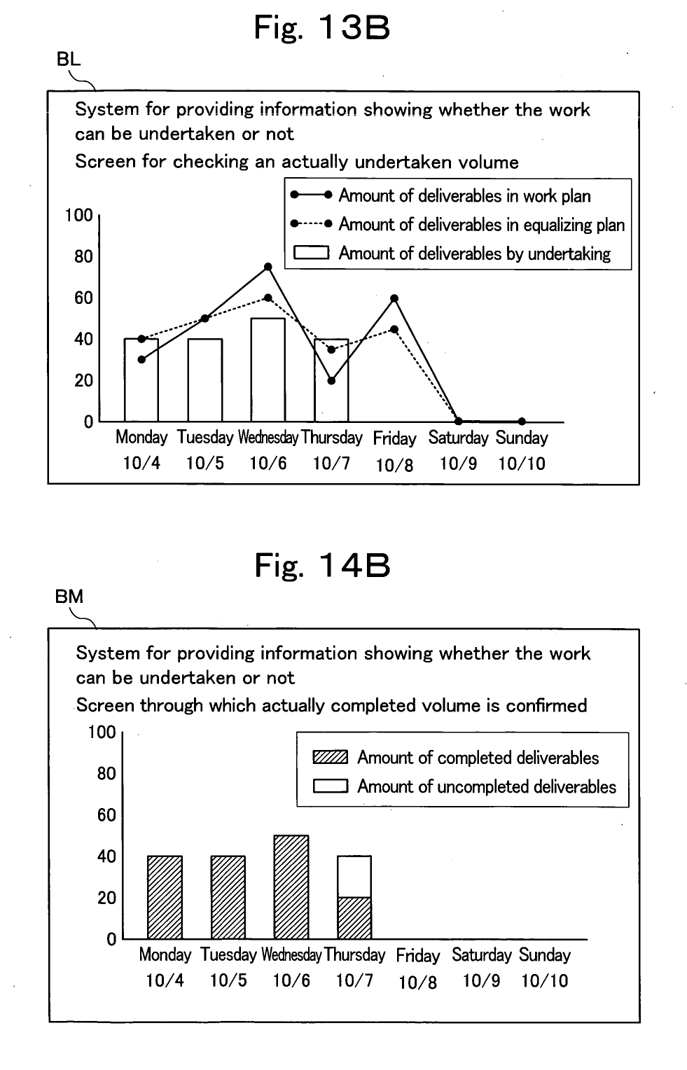

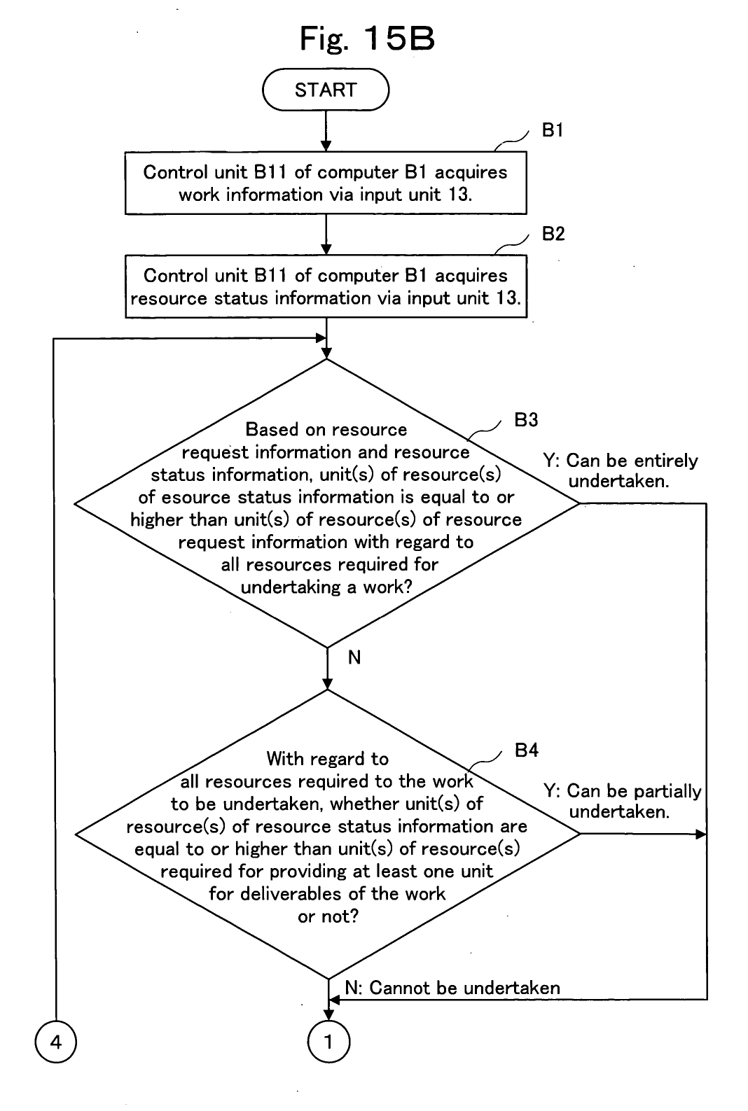

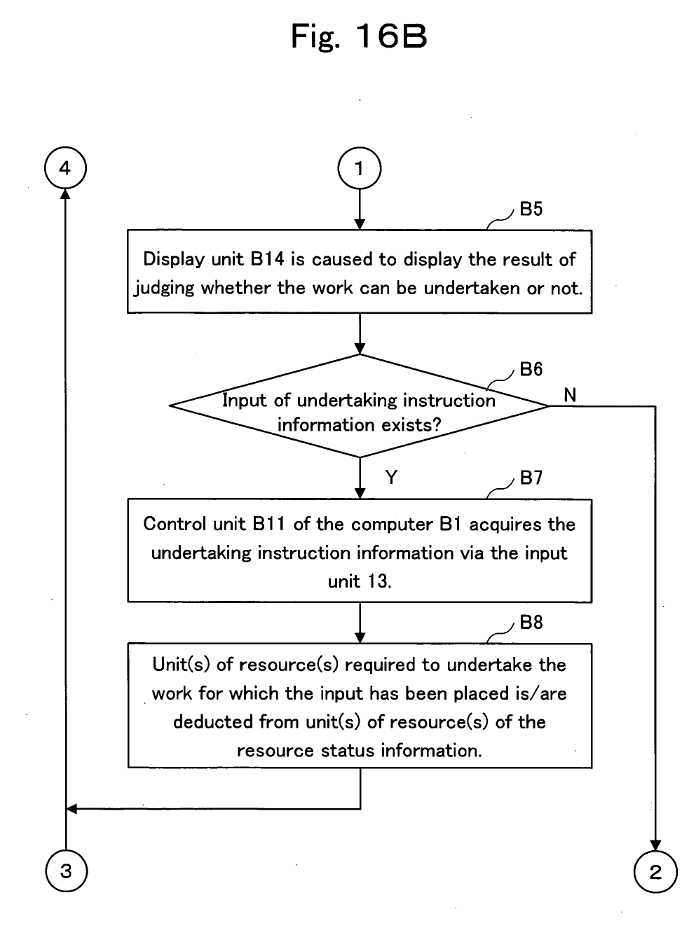

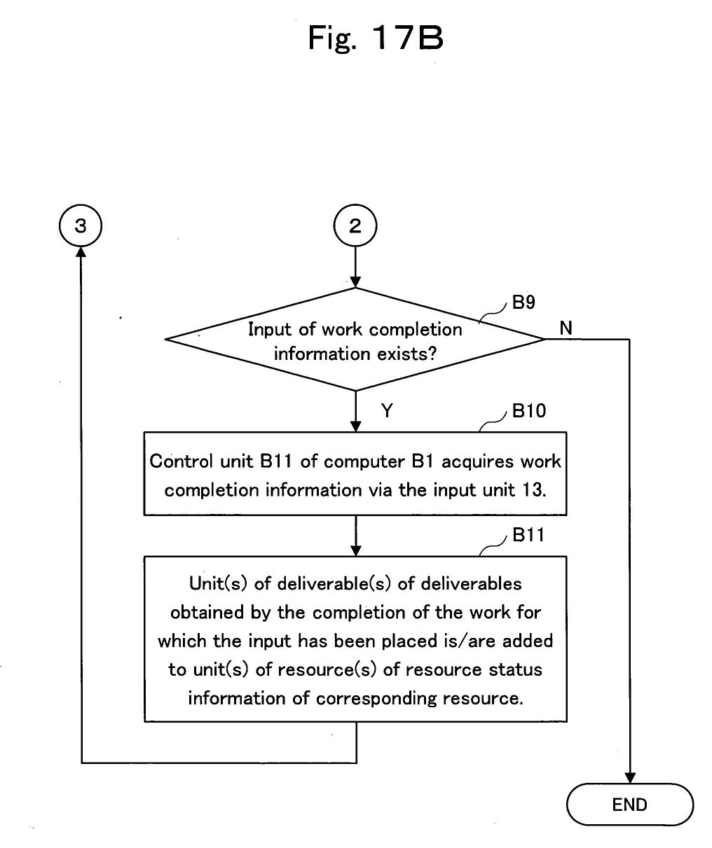

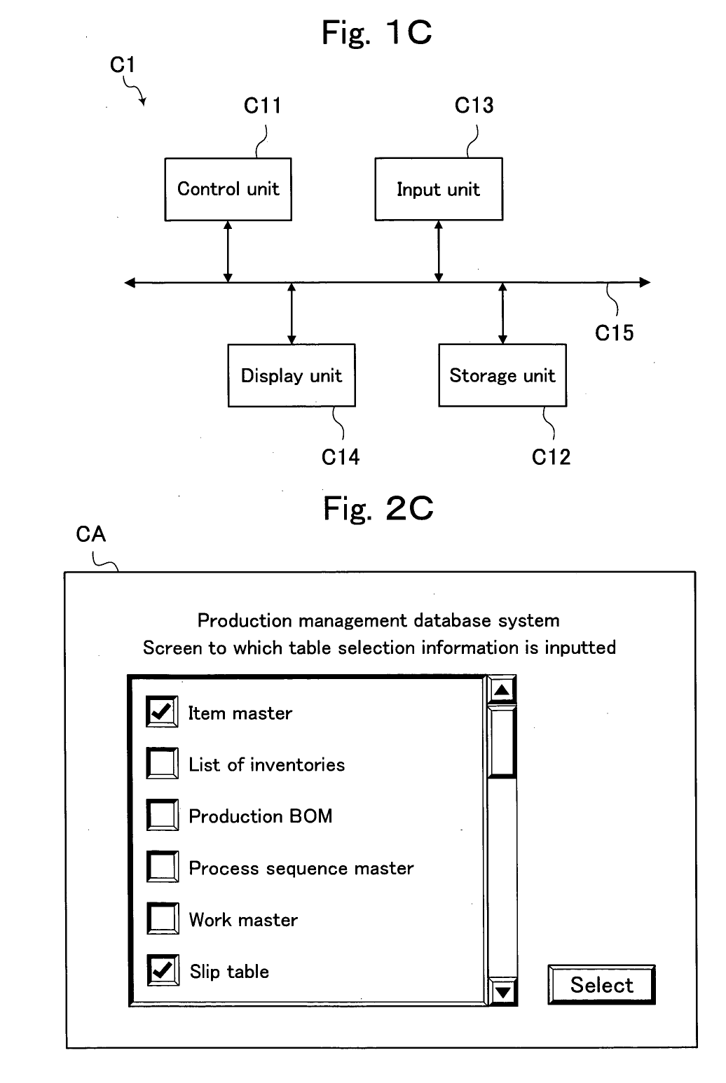

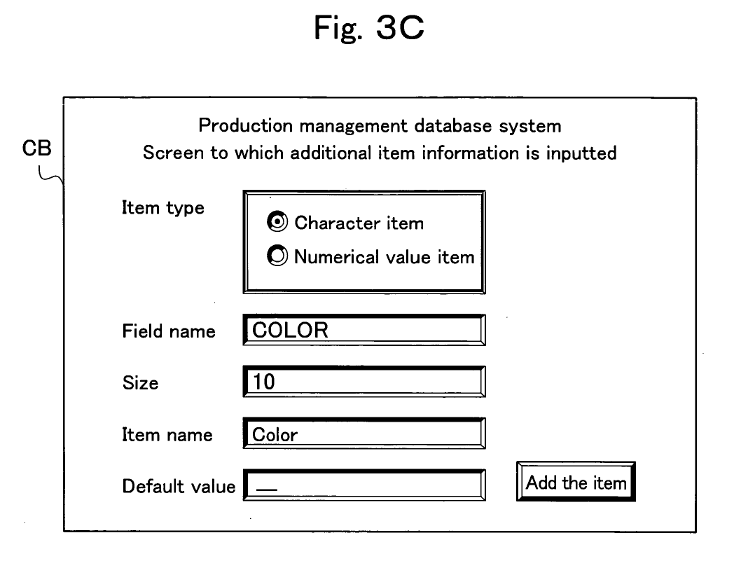

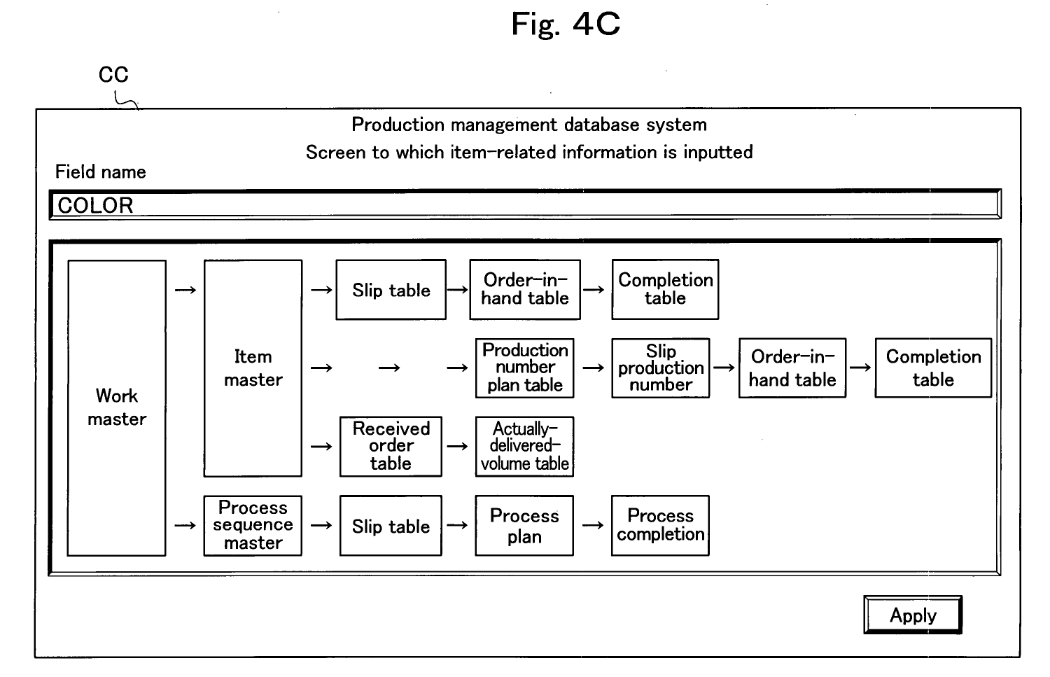

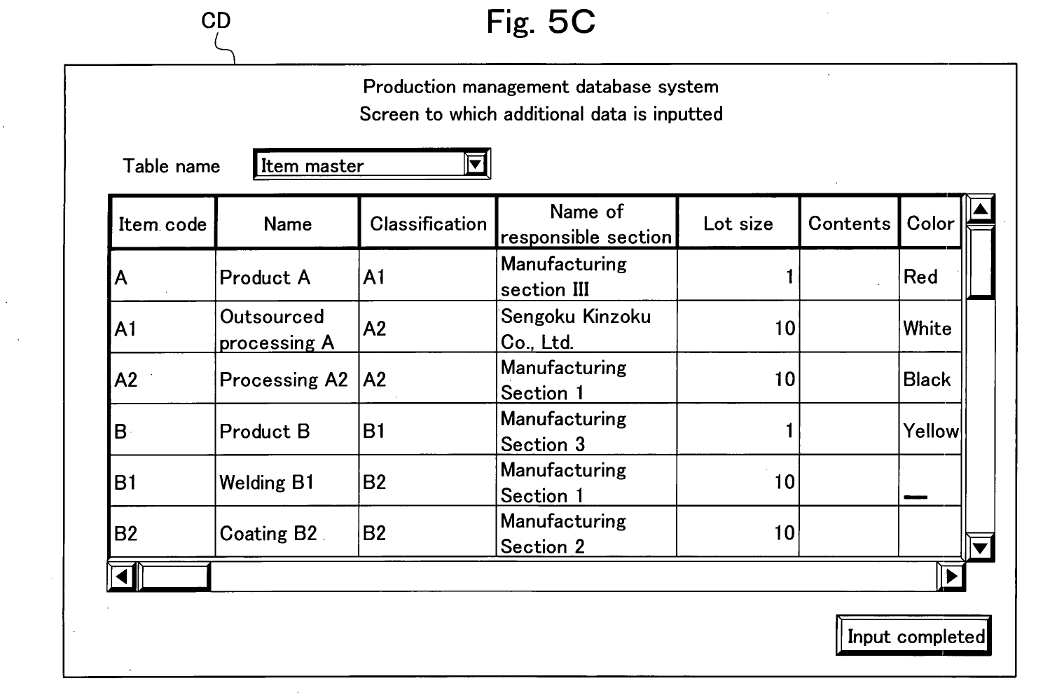

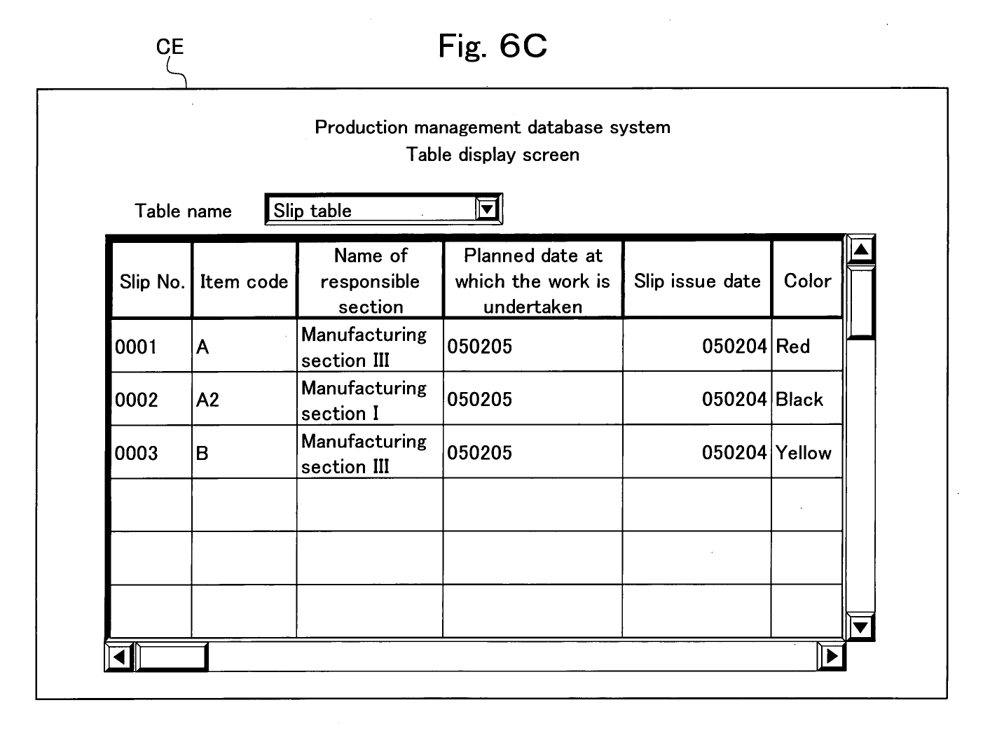

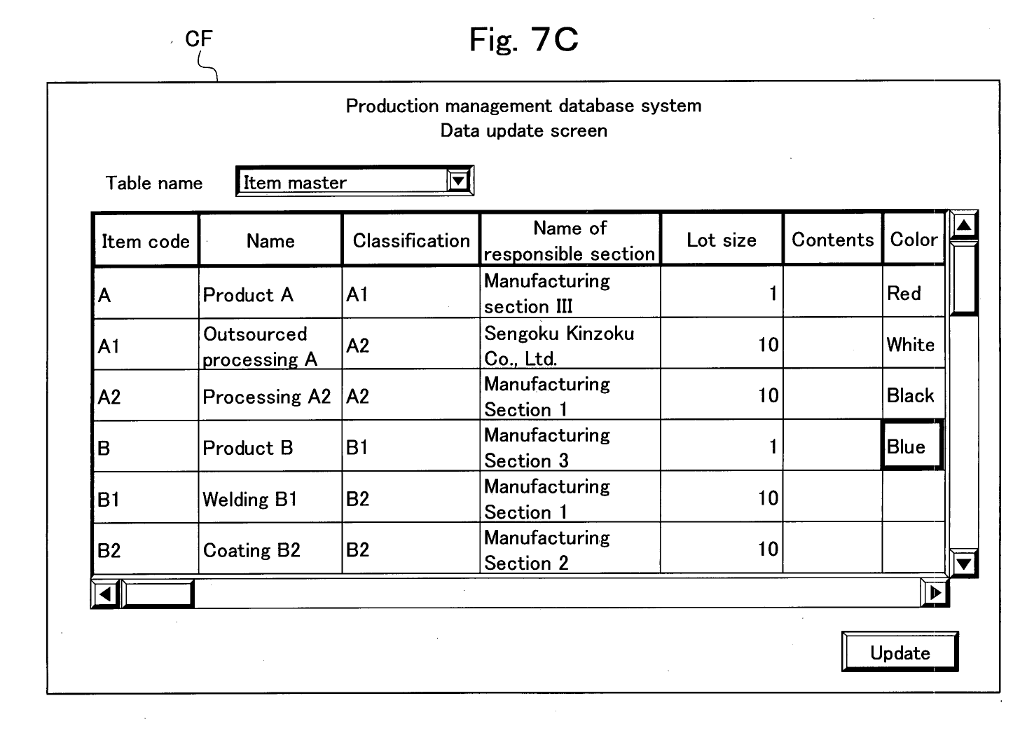

FIG. 7B illustrates another example of the screen to which resource request information is inputted that is displayed by the display unit B14 by the control unit B11 of the computer B1.

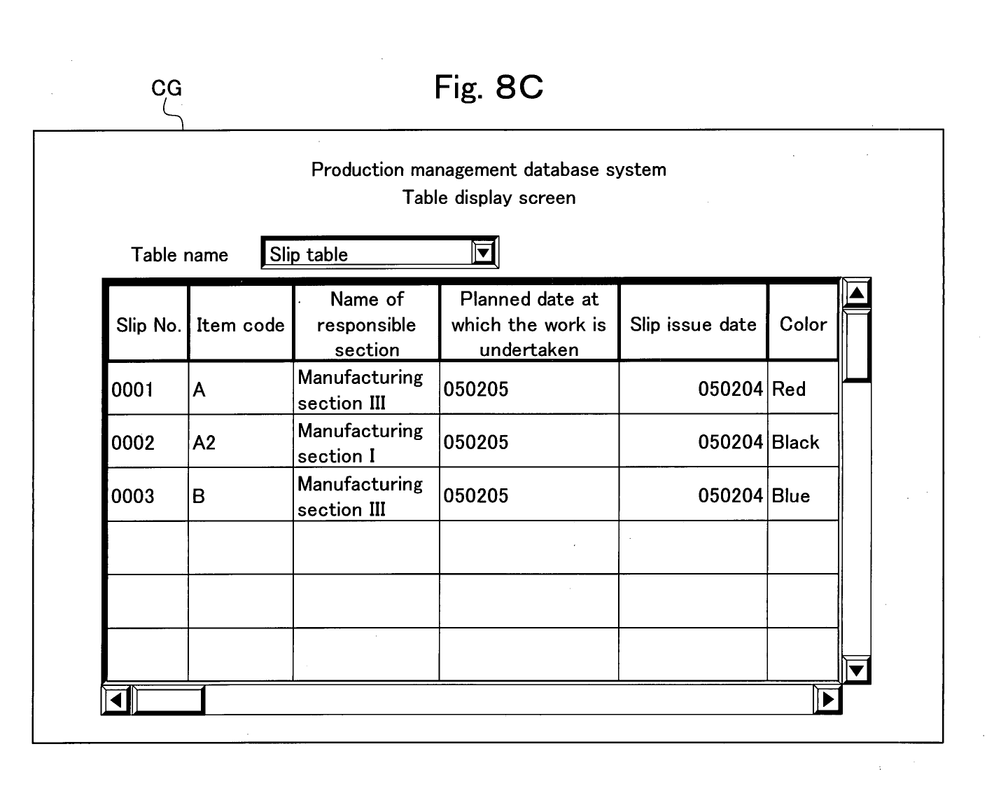

FIG. 8B illustrates still another example of the screen to which resource request information is inputted that is displayed by the display unit B14 by the control unit B11 of the computer B1.

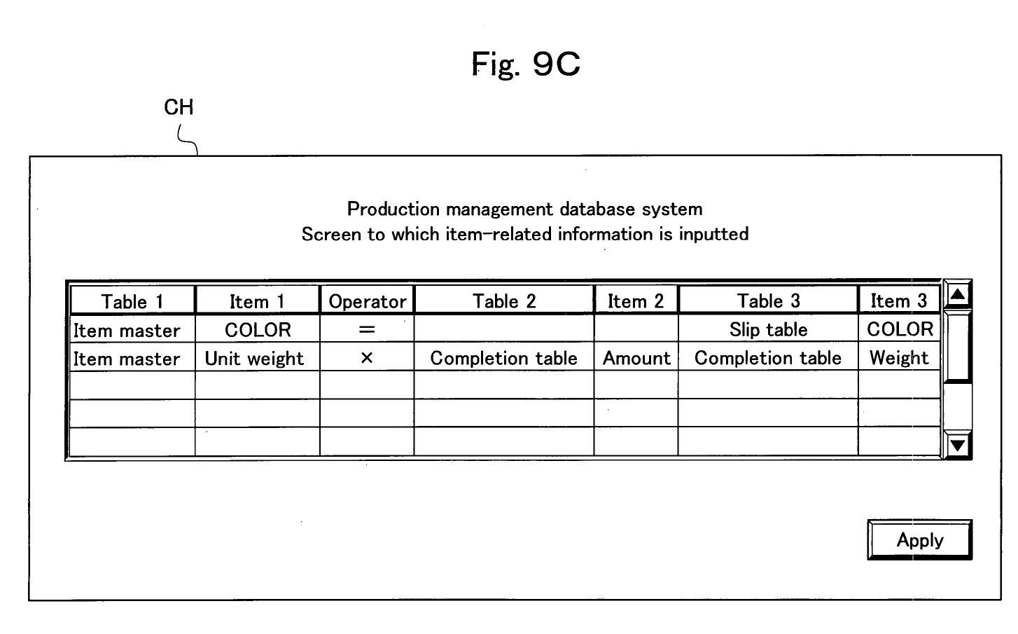

FIG. 9B illustrates an example of a screen for displaying information showing whether the work can be undertaken or not that is displayed by the display unit B14 by the control unit B11 of the computer B1.

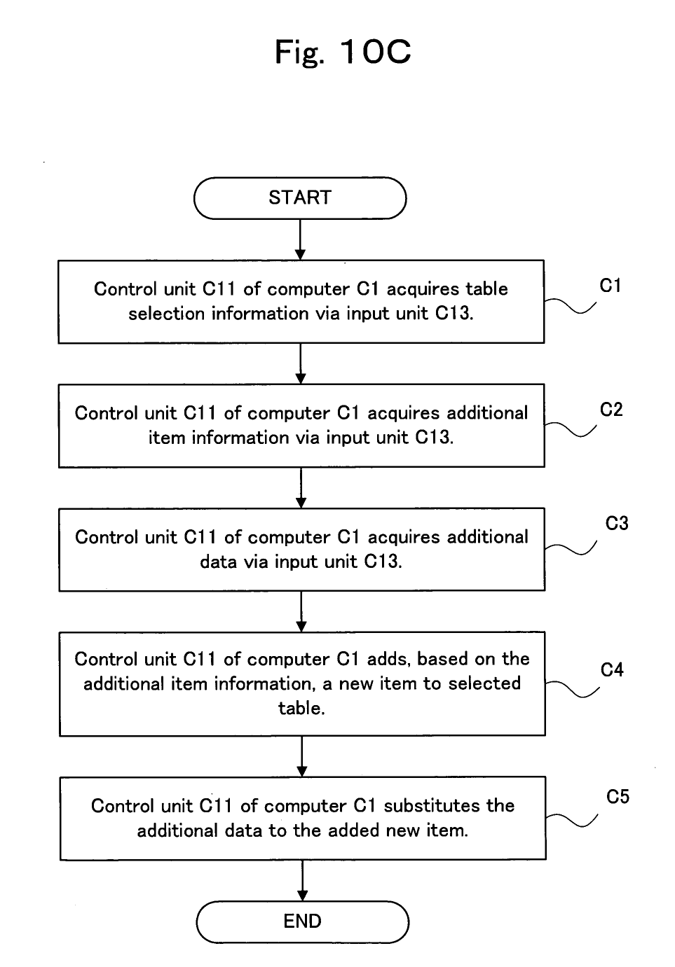

FIG. 10B illustrates an example of a screen to which undertaking instruction information is inputted that is displayed by the display unit B14 by the control unit B11 of the computer B1.

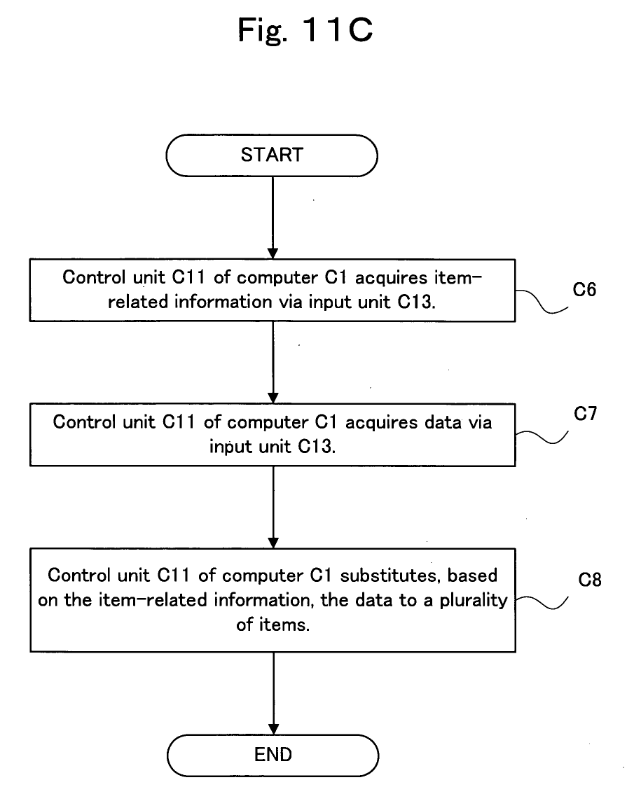

FIG. 11B illustrates an example of a screen to which work completion information is inputted that is displayed by the display unit B14 by the control unit B11 of the computer B1.

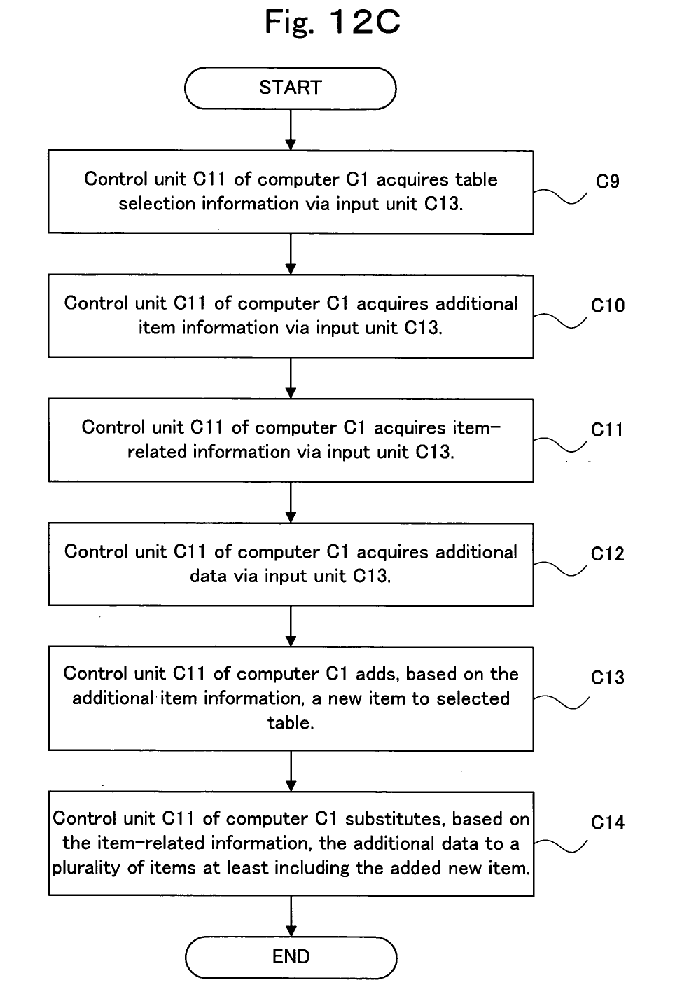

FIG. 12B illustrates an example of a screen to which work equalizing information is inputted that is displayed by the display unit B14 by the control unit B11 of the computer B1.

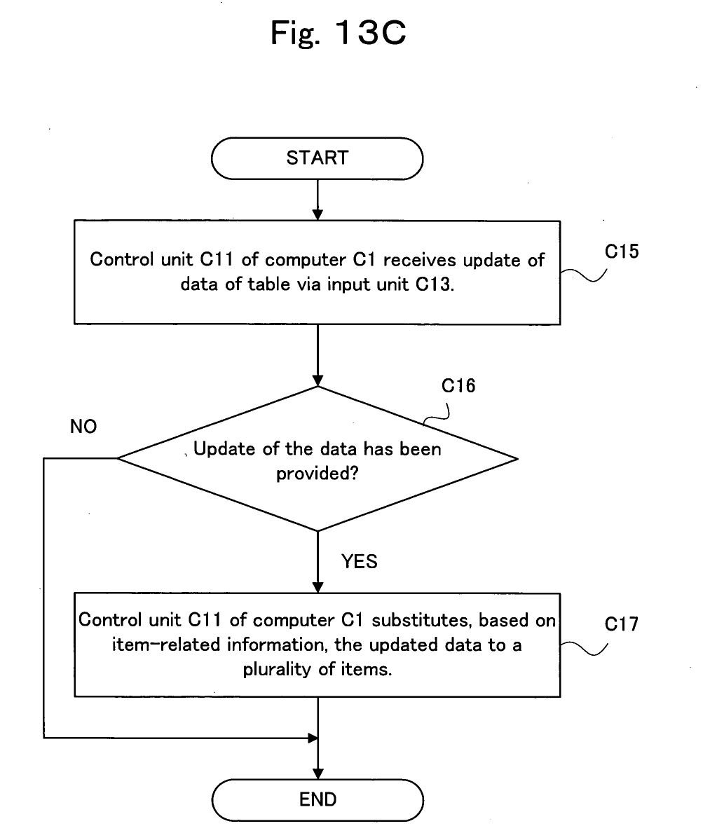

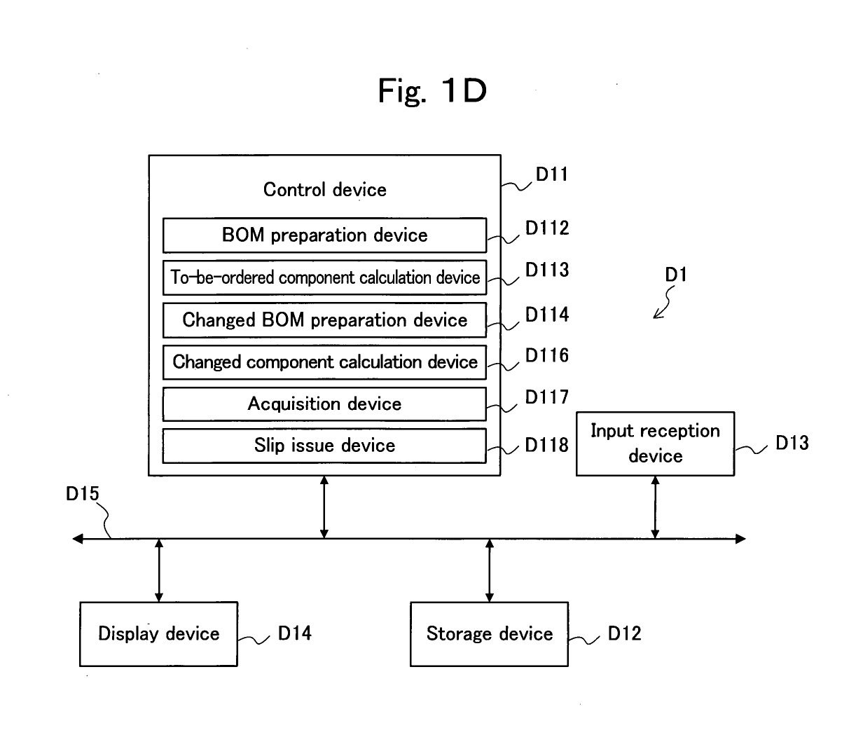

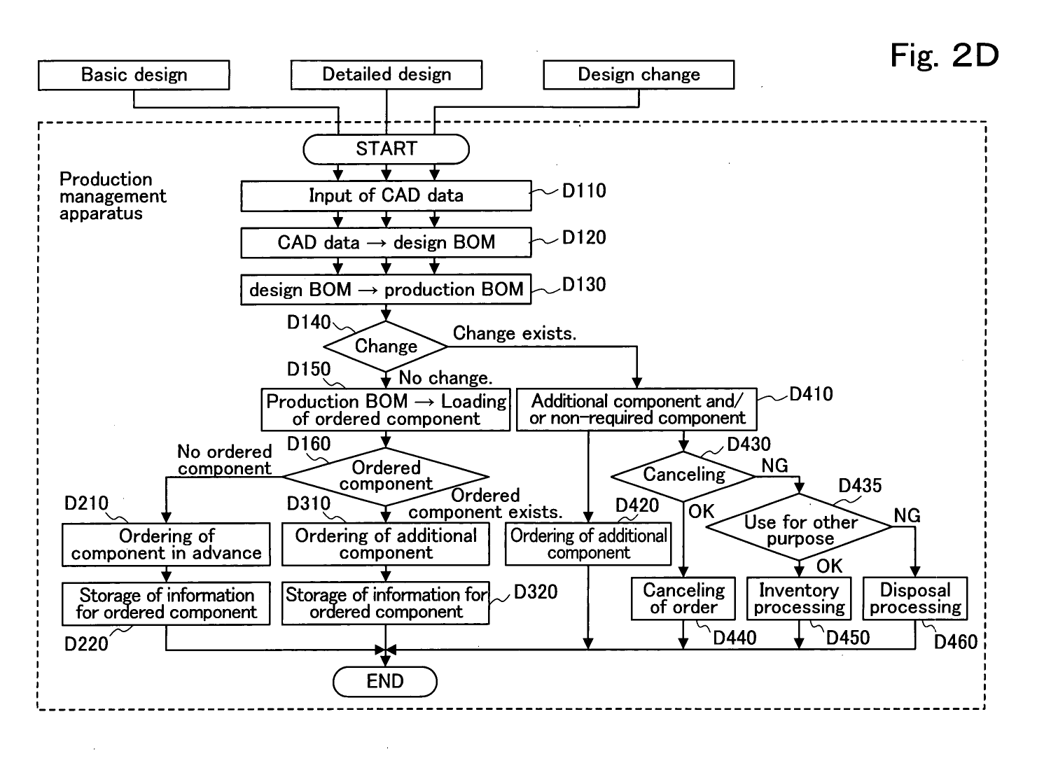

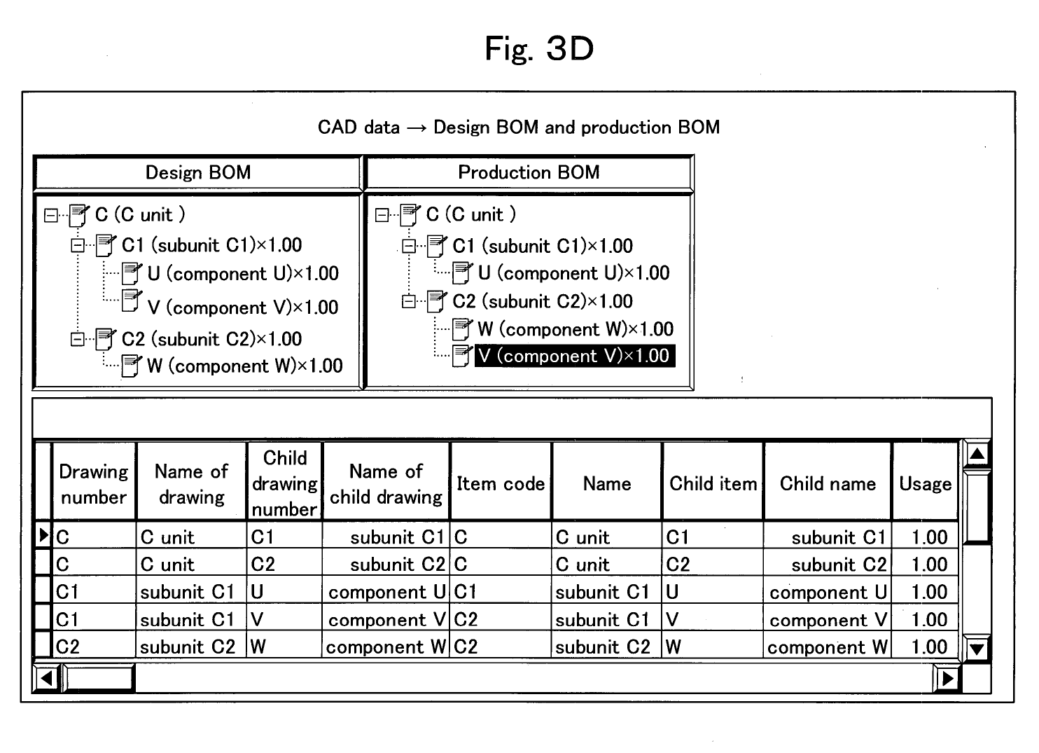

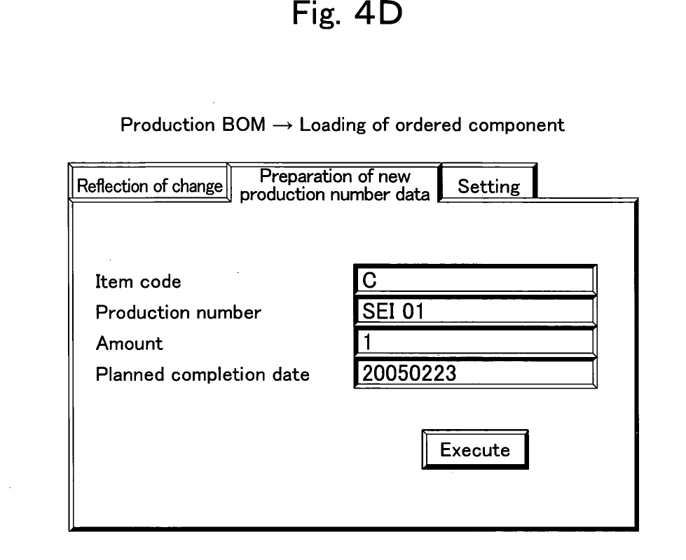

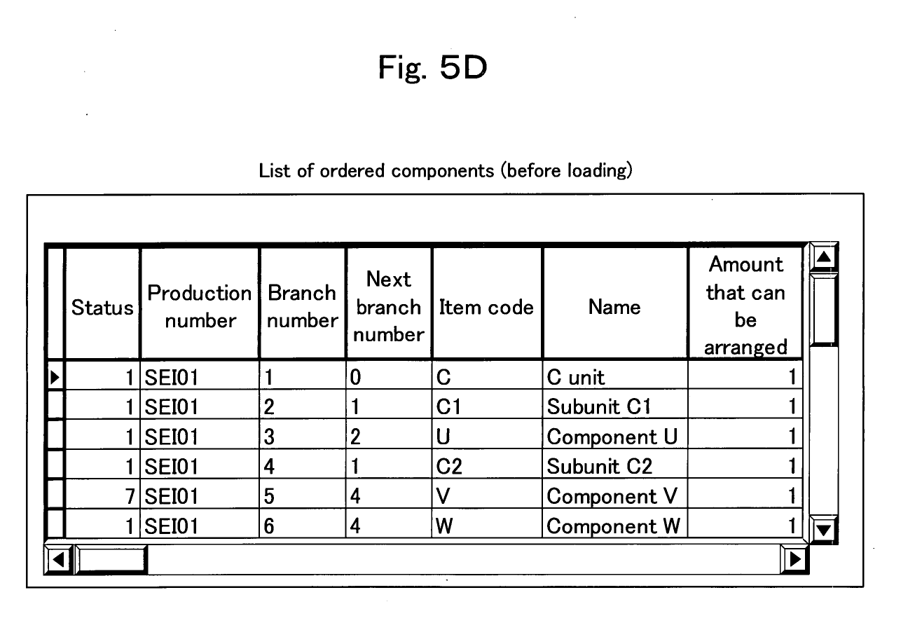

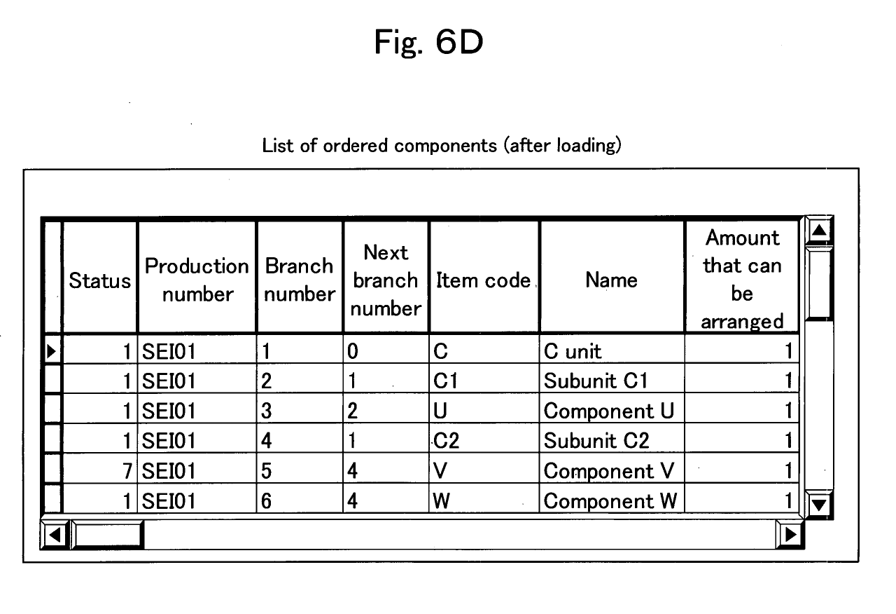

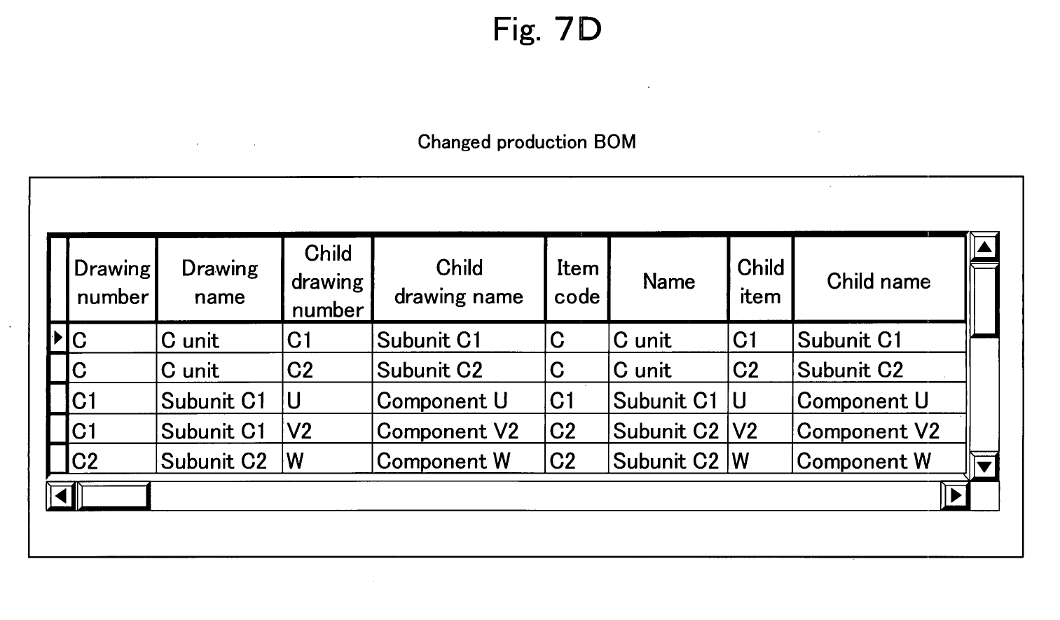

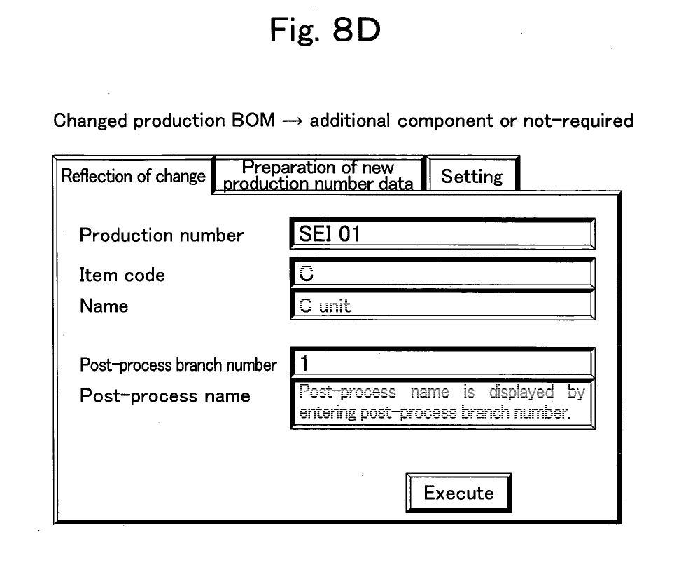

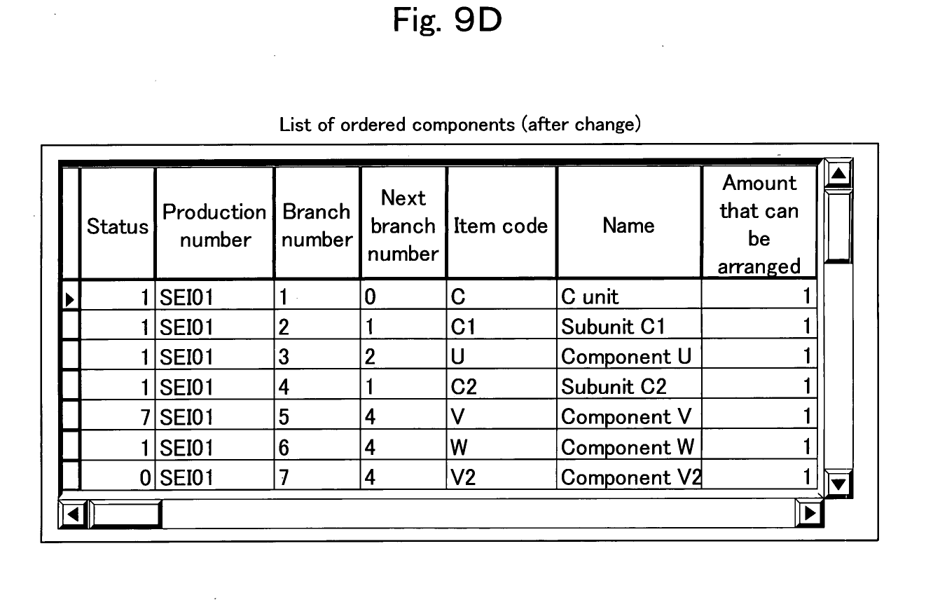

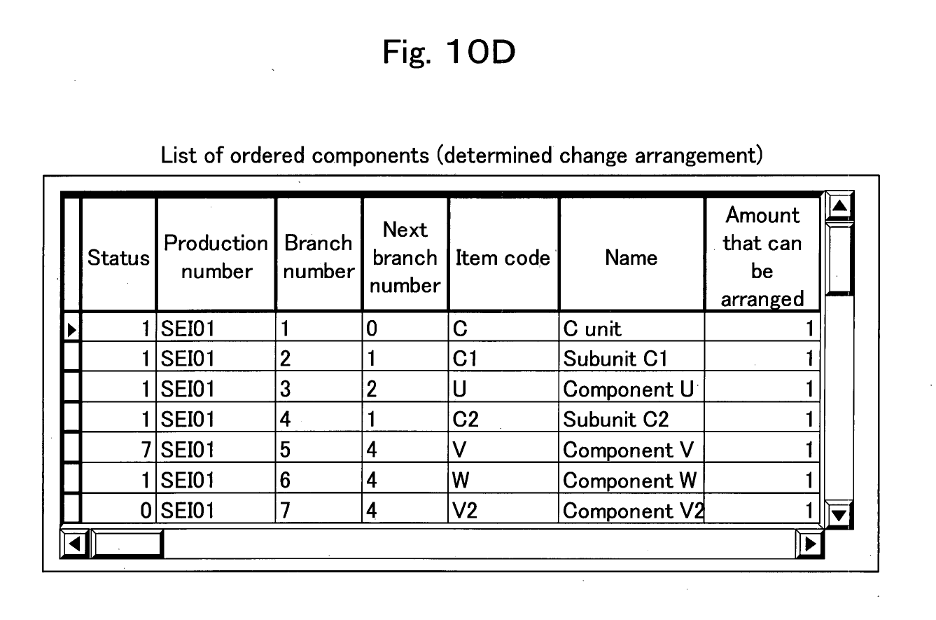

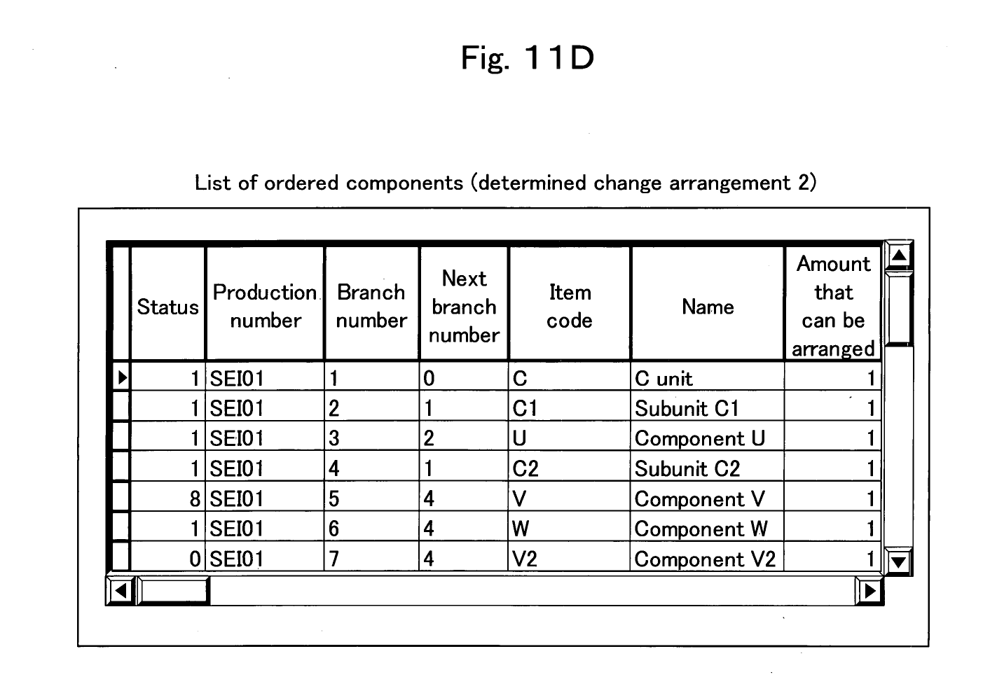

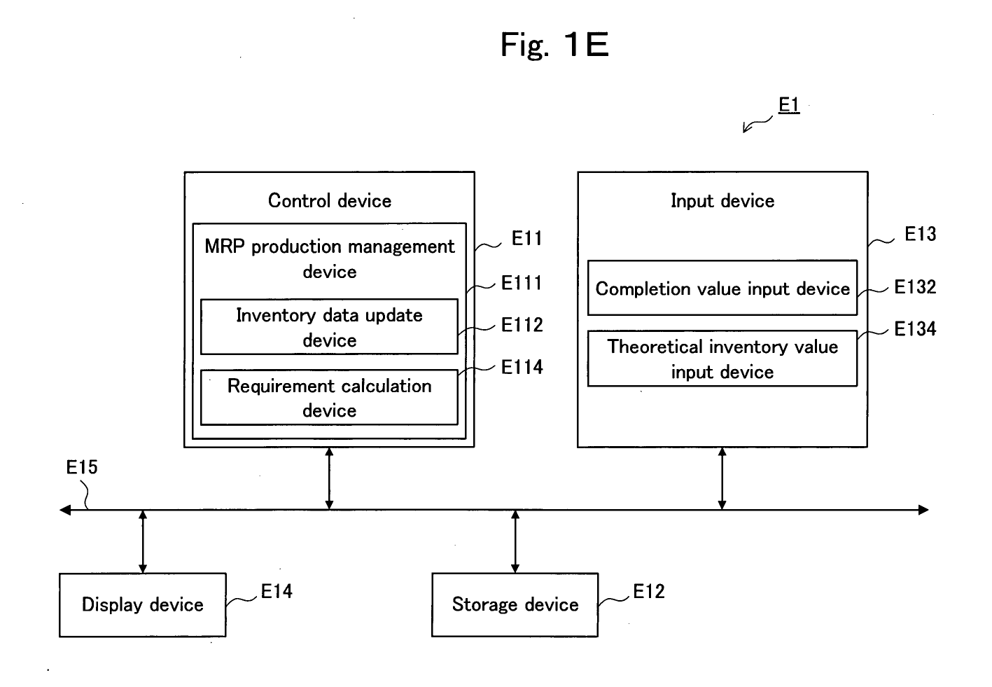

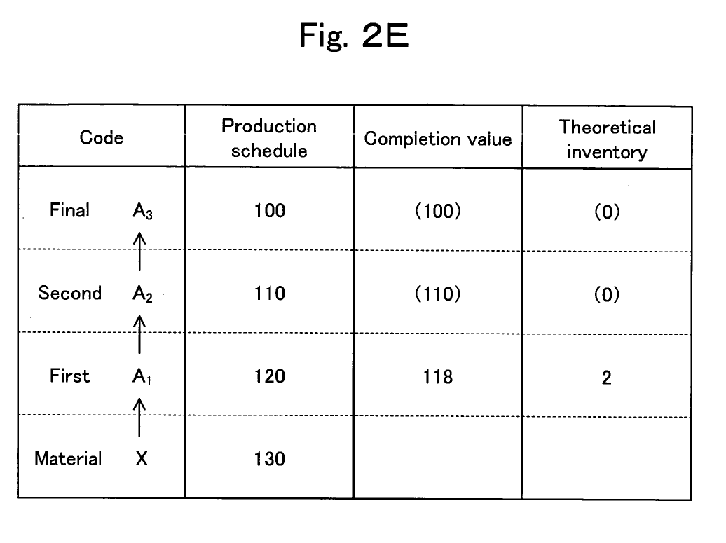

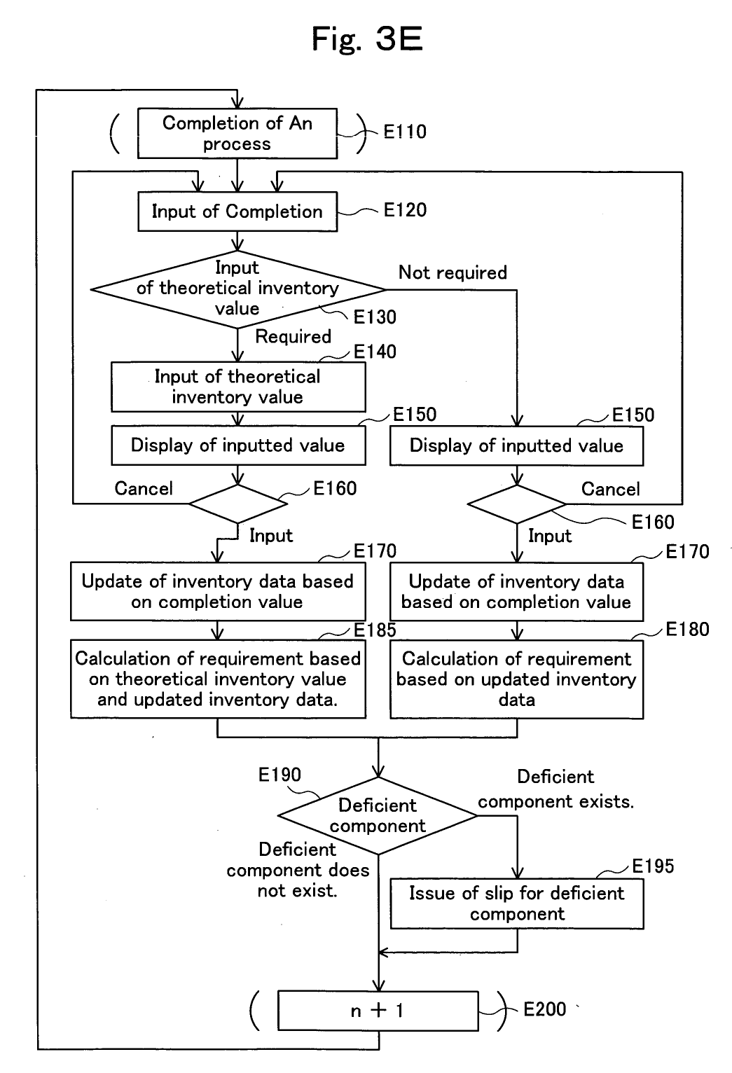

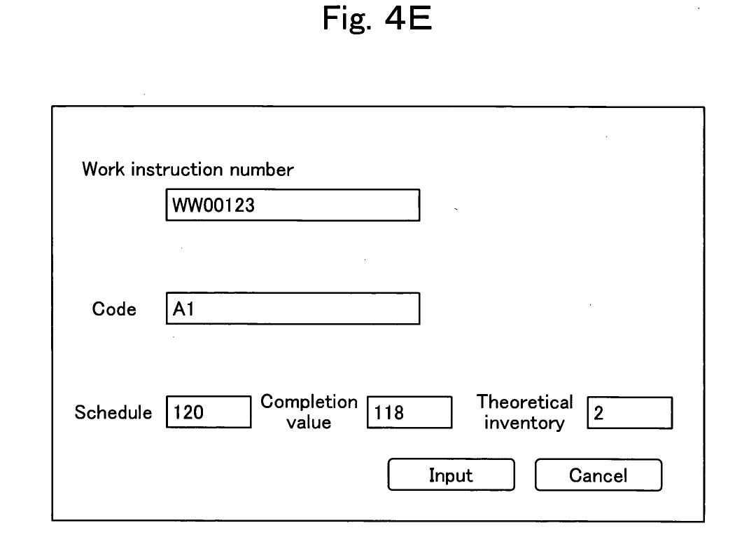

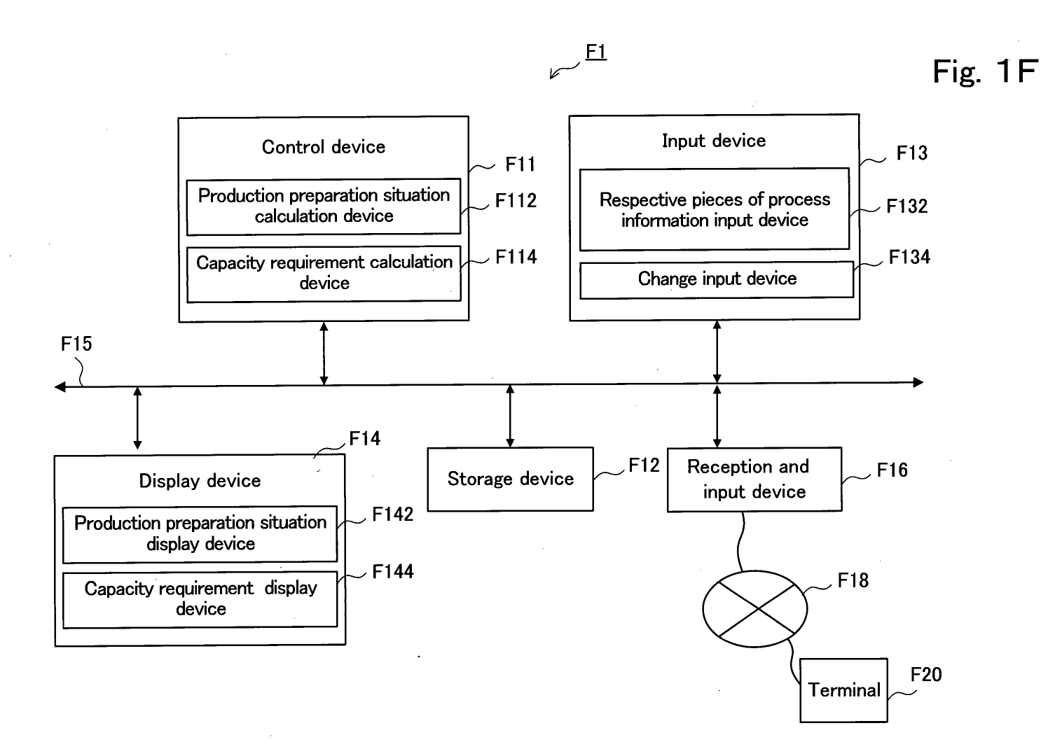

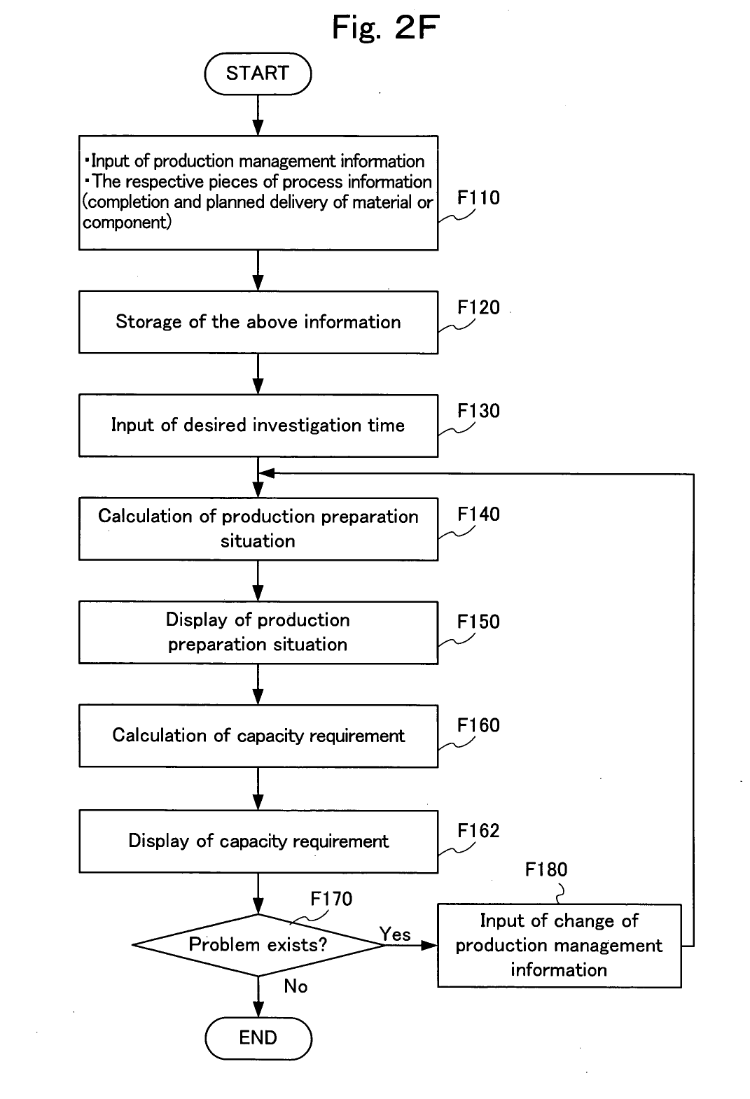

FIG. 13B illustrates an example of a screen for checking an actually undertaken volume that is displayed by the display unit B14 by the control unit B11 of the computer B1.

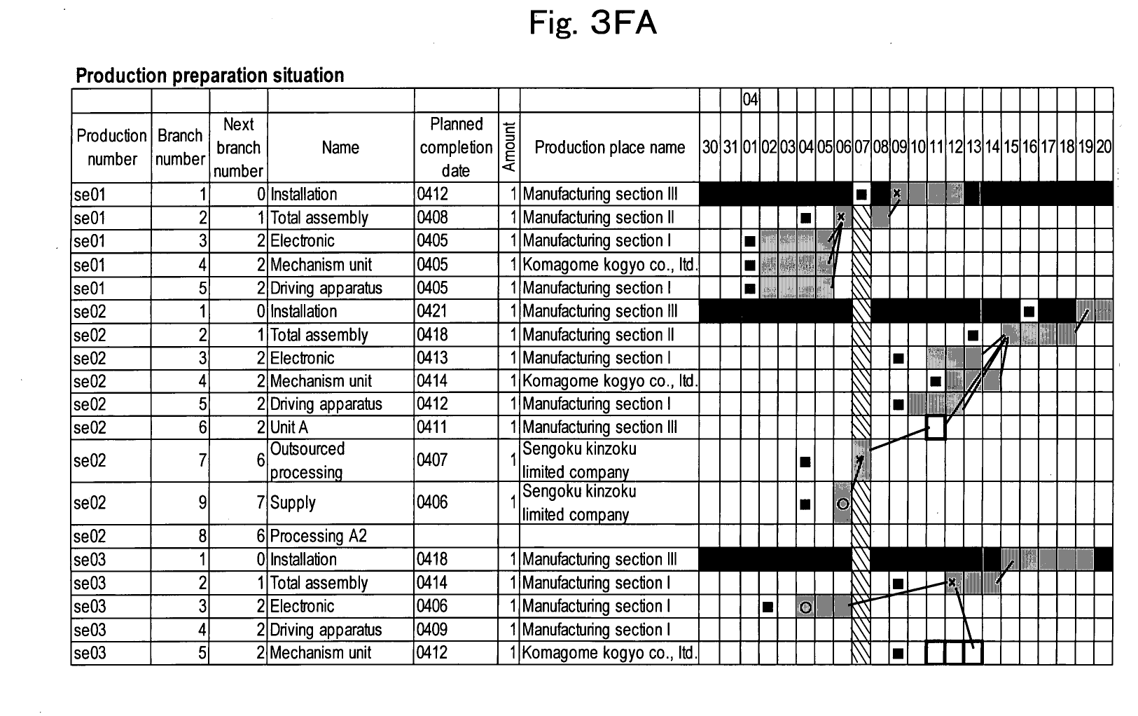

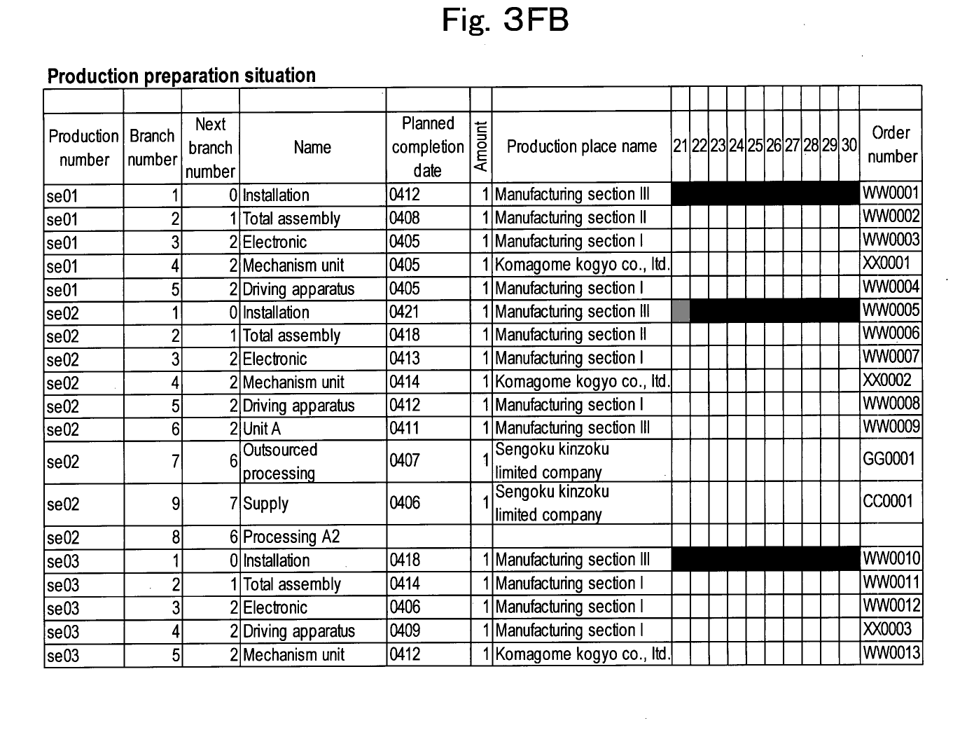

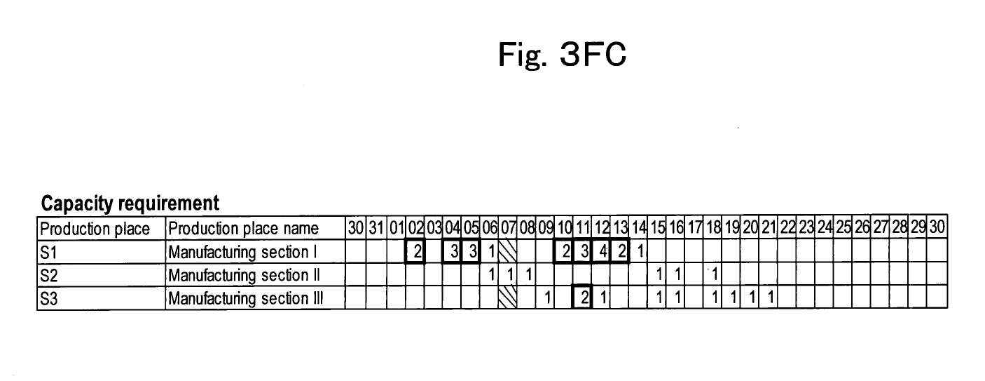

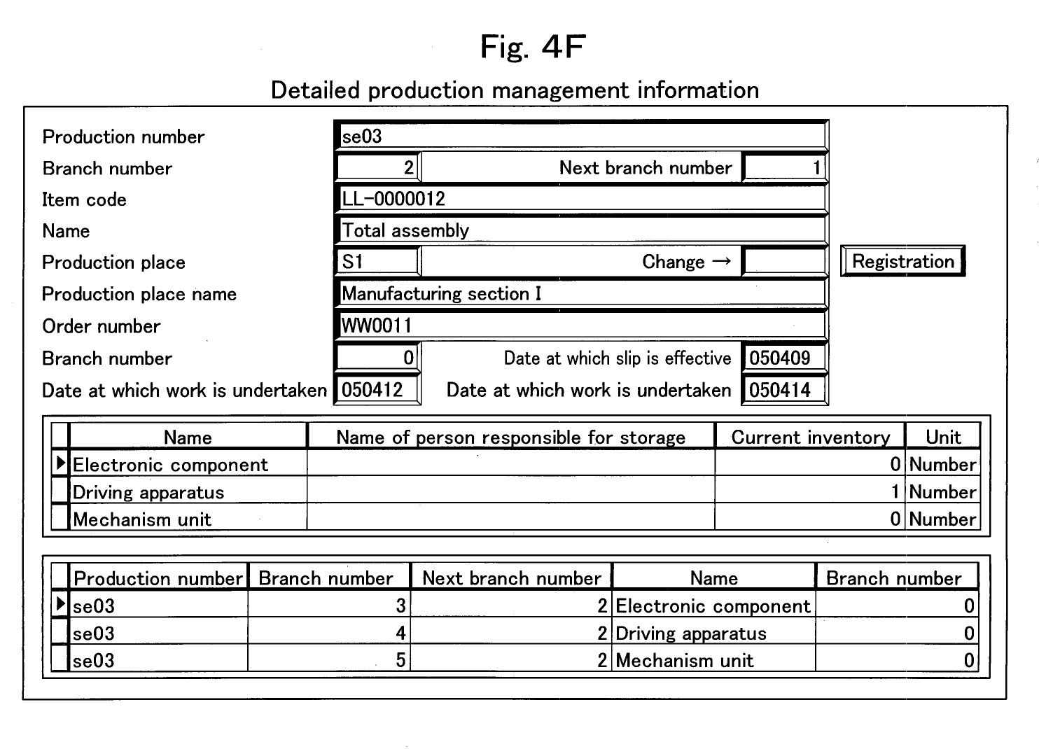

FIG. 14B illustrates an example of a screen through which an actually completed volume is confirmed that is displayed by the display unit B14 by the control unit B11 of the computer B1.

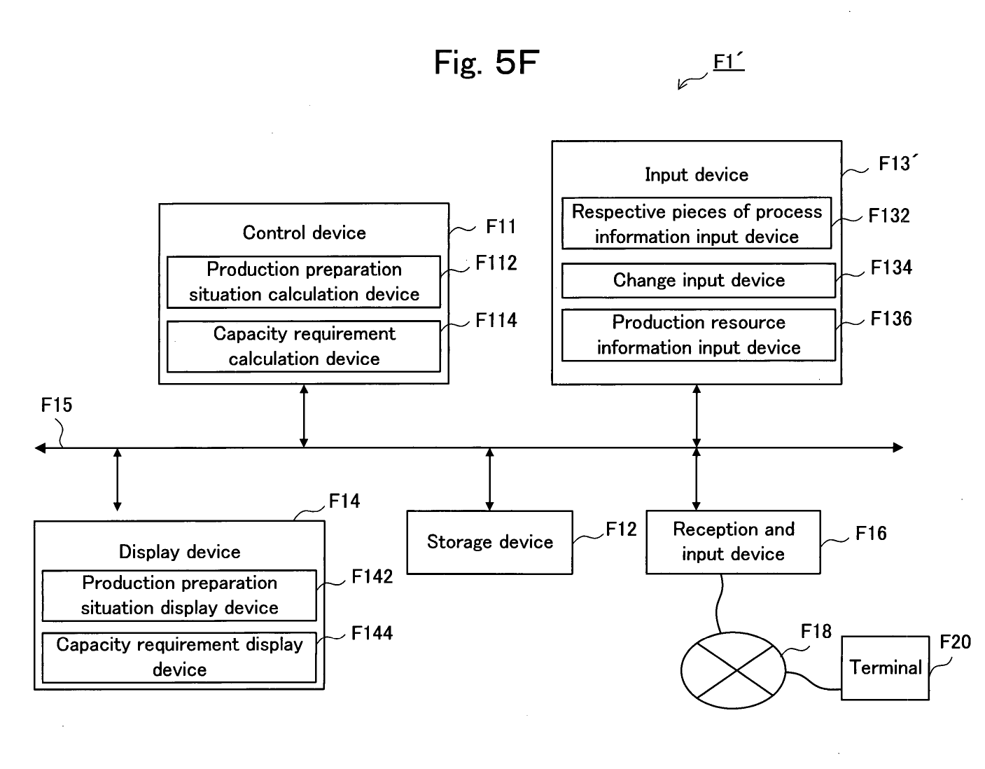

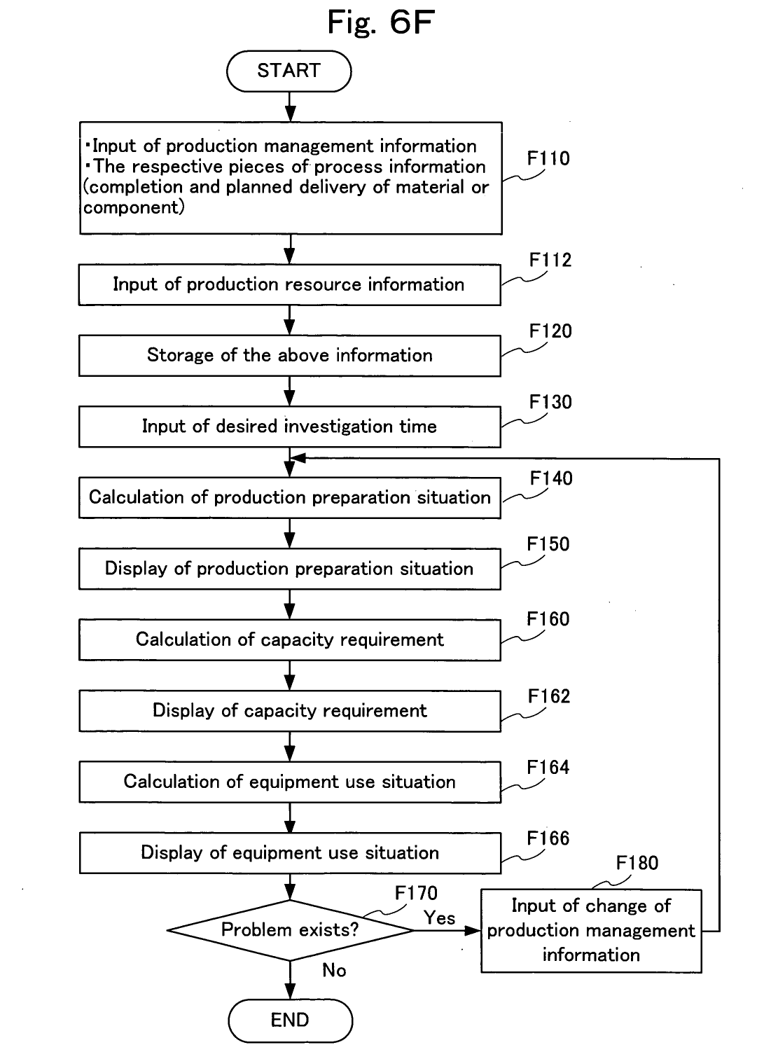

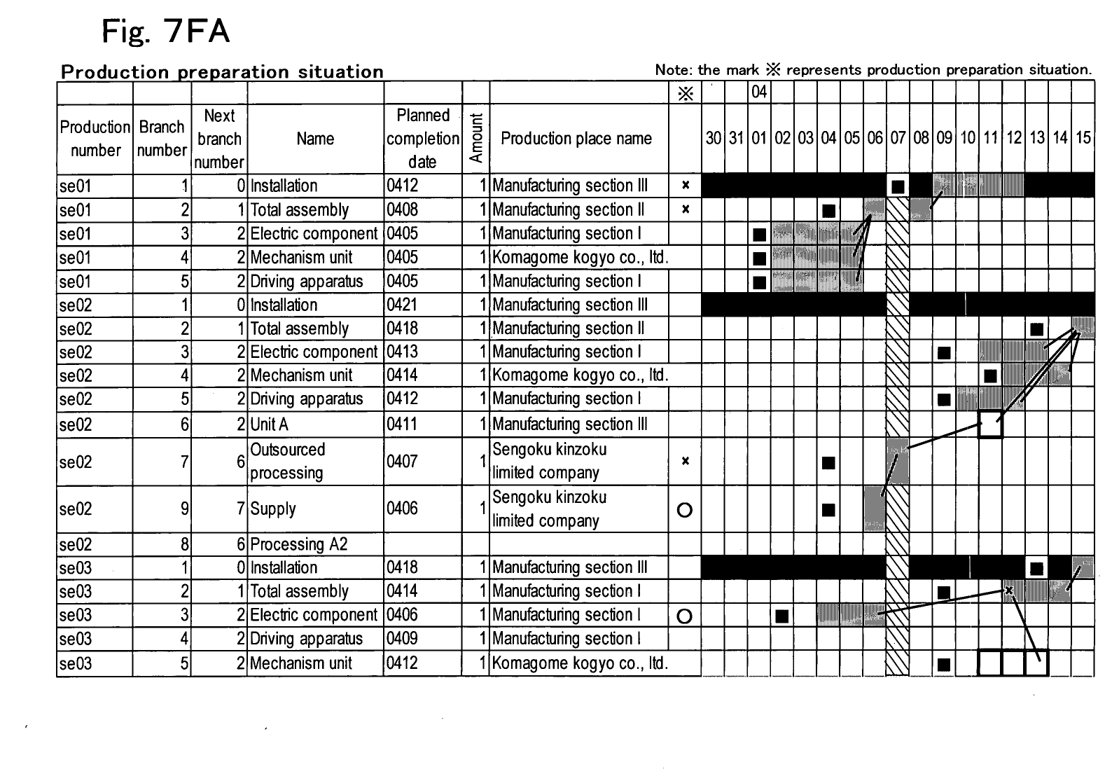

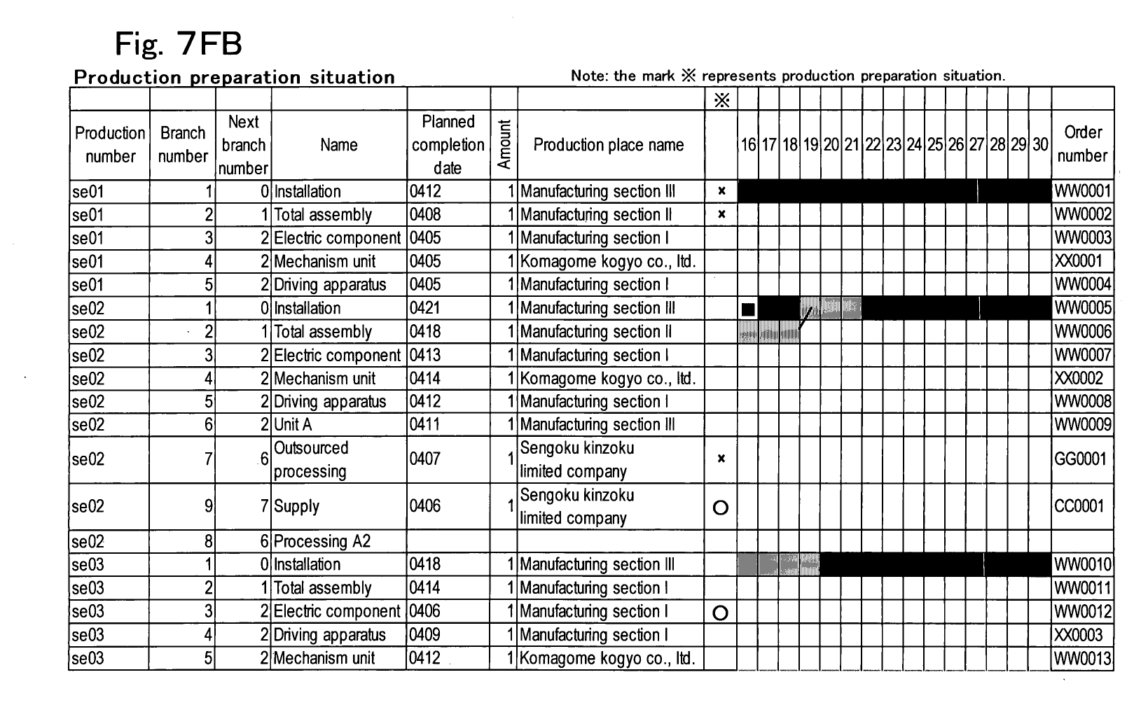

FIG. 15B is a flow diagram illustrating a procedure for calculating information showing whether the work can be undertaken or not.

FIG. 16B is a flow diagram illustrating a procedure for calculating information showing whether the work can be undertaken or not.

FIG. 17B is a flow diagram illustrating a procedure for calculating information showing whether the work can be undertaken or not.

FIG. 1C is a block diagram illustrating the entire structure of a computer according to the present invention.

FIG. 2C illustrates an example of a screen to which table selection information is inputted that is displayed by the display unit C14 by the control unit C11 of the computer C1.

FIG. 3C illustrates an example of a screen to which additional field information is inputted that is displayed by the display unit C14 by the control unit C11 of the computer C1.

FIG. 4C illustrates an example of a screen to which field-related information is inputted that is displayed by the display unit C14 by the control unit C11 of the computer C1.

FIG. 5C illustrates an example of a screen to which additional data is inputted that is displayed by the display unit C14 by the control unit C11 of the computer C1.

FIG. 6C illustrates an example of a table display screen displayed by the display unit C14 by the control unit C11 of the computer C1.

FIG. 7C illustrates an example of a data update screen displayed by the display unit C14 by the control unit C11 of the computer C1.

FIG. 8C illustrates another example of the table display screen displayed by the display unit C14 by the control unit C11 of the computer C1.

FIG. 9C illustrates another example of the screen to which field-related information is inputted that is displayed by the display unit C14 by the control unit C11 of the computer C1.

FIG. 10C is a flow diagram illustrating a procedure for adding, based on the additional field information, a new field to a database of a production management system to substitute additional data.

FIG. 11C is a flow diagram illustrating a procedure for substituting, based on the field-related information, data to the database of the production management system.

FIG. 12C is a flow diagram illustrating a procedure for substituting, based on the field-related information, additional data to the added field and/or existing field in the database of the production management system.

FIG. 13C is a flow diagram illustrating a procedure for a case where data of a field of the database of the production management system is changed.

FIG. 1D is a block diagram illustrating the structure of a production management apparatus D1 according to the present invention.

FIG. 2D is a flowchart illustrating a conceptual operation of the production management apparatus D1 according to the present invention.

FIG. 3D illustrates an example of Engineering Bill of Material and a production BOM prepared based on CAD data.

FIG. 4D illustrates an example of an input screen through which an ordered component is loaded based on the production BOM.

FIG. 5D illustrates an example of a screen for displaying the list of ordered components (before loading).

FIG. 6D illustrates the list of ordered components (after loading).

FIG. 7D illustrates an example of a screen for displaying a changed production BOM.

FIG. 8D illustrates a screen through which an investigation of an additional component and a non-required component is inputted based on the changed production BOM.

FIG. 9D illustrates a screen for displaying the list of ordered components (after change).

FIG. 10D illustrates a screen for displaying the list of ordered components (determined change arrangement 1).

FIG. 11D illustrates a screen for displaying the list of ordered components (determined change arrangement 2).

FIG. 1E is a block diagram illustrating the structure of a production management apparatus E1 according to the present invention.

FIG. 2E illustrates the status of the use of the production management apparatus E1 according to the present invention.

FIG. 3E illustrates an operation of the production management apparatus E1 according to the present invention.

FIG. 4E illustrates a screen displayed by a display device E14 of the production management apparatus E1 according to the present invention.

FIG. 1F is a block diagram illustrating the structure of a production management apparatus according to the present invention.

FIG. 2F is a flowchart illustrating an operation of the production management apparatus according to the present invention.

FIG. 3FA illustrates an example of a table based on a Gantt chart of the production management apparatus according to the present invention displayed by a production preparation situation display device and a capacity requirement display device.

FIG. 3FB illustrates an example of a table based on a Gantt chart of the production management apparatus according to the present invention displayed by a production preparation situation display device and a capacity requirement display device.

FIG. 3FC illustrates an example of a table based on a Gantt chart of the production management apparatus according to the present invention displayed by a production preparation situation display device and a capacity requirement display device.

FIG. 4F illustrates detailed production management information displayed by the production management apparatus according to the present invention.

FIG. 5F is a block diagram illustrating the structure of a production management apparatus of another exemplary embodiment of the present invention.

FIG. 6F is a flowchart illustrating an operation of the production management apparatus shown in FIG. 5F.

FIG. 7FA illustrates another exemplary embodiment of the production preparation situation display.

FIG. 7FB illustrates another exemplary embodiment of the production preparation situation display.

FIG. 7FC illustrates another exemplary embodiment of the production preparation situation display.

### DETAILED DESCRIPTION OF THE INVENTION

Hereinafter, the best mode for carrying out the present invention will be described with reference to the drawings. It is noted that this is a mere example and the technical scope of the present invention is not limited to this.

FIG. 1A is a block diagram illustrating an entire structure of a system according to the present invention. A server A4 is connected to a personal computer A3 as a terminal via a communication network A2. The communication network A2 is a LAN or the Internet network for example but is not limited to this so long as the communication network A2 is a communication network through which information can be sent and received.

The server A4 provides transmission and reception of information between the personal computer A3 and the communication network A2.

FIG. 2A is a block diagram illustrating the structure of the personal computer A3 as a terminal. A control unit A31, a storage unit A32, a communication interface unit A33, a display unit A34, and an input unit A35 are connected via a bus A36. The control unit A31 controls the entirety of the personal computer A3.

The control unit A31 receives an input from a user at the input unit A35 and exchanges information with the server A4 via the communication interface unit A33.

FIG. 3A is a block diagram illustrating the structure of the server A4. The control unit A41, the storage unit A42, the communication interface unit A43, the display unit A44, and the input unit A45 are connected via the bus A46. The control unit A41 controls the entirety of the server A4. The storage unit A42 includes: a product order receiving conditions storage area for storing product order receiving conditions; a component procurement conditions storage area for storing component procurement conditions; a product delivery conditions storage area for storing product delivery conditions; a component information storage area for storing component information; a manufacturing process information storage area for storing manufacturing process information; a product inventory information storage area for storing product inventory information; a component inventory information storage area for storing component inventory information; a ordered component information storage area for storing ordered component information; a manufacturing process load information storage area for storing manufacturing process load information as a part of a production schedule; a component procurement lead time storage area for storing a component procurement lead time; and an area for storing the number of lot(s) for component procurement for storing the number of lot(s) for component procurement.

The control unit A41 exchanges information with the personal computer A3 via the communication interface unit A43.

The storage unit A42 stores a production management program. The server A4 reads and executes this program and performs various processes in cooperation with the above hardware. This allows the server A4 and the personal computer A3 as a terminal to function as a production management system.

FIG. 4A is a block diagram illustrating an example of the structure of information to be displayed on a screen by the display unit A34 by the control unit A31 of the personal computer A3 at a product maker.

The control unit A31 causes the display unit A34 to display an input field for product order receiving conditions composed of a product code, a delivery date, and an amount as order receipt information for a new product. Through this screen, a responsible person of the product maker can input ordering conditions of the product when having an opportunity to receive a new order for the product from a customer.

FIG. 5A is a block diagram illustrating another structure of information to be displayed on a screen displayed by the display unit A34 by the control unit A31 of the personal computer A3 at a component vendor.

The control unit A31 causes the display unit A34 to display component procurement conditions composed of a component code, a delivery date, and an amount as order receipt information for a new component. These component procurement conditions can be updated by the component vendor to component procurement conditions acceptable for the component vendor.

FIG. 6A is a block diagram illustrating another structure of information to be displayed on a screen that is displayed by the display unit A34 by the control unit A31 of the personal computer A3 at the product maker.

The control unit A31 causes the display unit A34 to display product order receiving conditions composed of a product code, a delivery date, and an amount as acceptable new product order receipt information. A responsible person of the product maker can watch this screen to tell the customer acceptable order receipt conditions.

FIG. 7A illustrates an example of component information according to the present invention. This example shows that the production of a product A requires one component “a” and twenty five components “b”. This example also shows that the structure of the component “a” requires five components α and eight components β for example. In this manner, component information includes information having a hierarchical structure.

FIG. 8A illustrates an example of manufacturing process information according to the present invention. This example shows that manufacturing process 5 requires manufacturing processes 1 and 3 as a leading process to be completed and a process time of 25 and also requires the use of two components “a” and ten components “c” for example.

FIG. 9A illustrates an example of component inventory or ordering information according to the present invention. This example shows that the component “e” currently has an inventory of 100, backorders of 500 to be shipped on Apr. 30, 2004, and backorders of 100 to be shipped on May 10, 2004.

FIG. 10A illustrates an example of manufacturing process load information according to the present invention. This example shows that a load situation of a manufacturing process 5 on Apr. 23, 2004 is a capability of 200 and the current load in the production schedule of 180, thus showing a load factor of 0.90.

FIG. 11A illustrates an example of a component procurement lead time according to the present invention. This example shows that a lead time from the order placement of the component “b” to the delivery is ten days.

FIG. 12A illustrates an example of the number of lot(s) in component procurement according to the present invention. This example shows that the number of ordering lot(s) of the component “b” is 100.

Next, the flow of an operation of the present invention will be described with reference to FIG. 13A to FIG. 16A.

FIG. 13A to FIG. 16A are a flow diagram illustrating a procedure for judging, in an opportunity to receive a new order of a product is caused, whether to receive the order or not.

First, the control unit A31 of the personal computer A3 at the product maker acquires, via the input unit A35, a product code, a delivery date, and an amount as new product order receipt information (A1).

Next, the control unit A31 of the personal computer A3 sends, via the communication interface unit A33, the product code, the delivery date, and the amount to the server A4 (A2).

Next, the control unit A41 of the server A4 receives, via the communication interface unit A43, the product code, the delivery date, and the amount (A3).

Next, the control unit A41 of the server A4 judges, based on the product code, the amount, and the delivery date as well as product inventory information, whether the product inventory can be reserved or not (A4).

When the product inventory can be reserved, the control unit A41 of the server A4 deducts the reserved amount of the product inventory from a desired amount (A5).

When the above calculation shows the desired amount of zero, the control unit A41 of the server A4 directly sends, to the personal computer A3 at the product maker, new product order receipt information of the product code, the delivery date, and the amount as a final result of the acceptability judgment via the communication interface unit A43 (A6).

When the above calculation shows the desired amount other than zero, the control unit A41 of the server A4 calculates an amount of components at a low hierarchical level required for the production of the product to judge whether the product can be produced by reserving the inventory of the components (A7). It is noted that this judgment is repeatedly performed for all components required for the production of the product until the bottom hierarchical level is reached.

When the production of the product by reserving the component inventory is possible, the control unit A41 of the server A4 deducts the reserved amount of the component inventory from the desired amount (A8).

When the desired amount is zero, the processing proceeds to A6.

When the desired amount is not zero, the control unit A41 of the server A4 calculates, as component procurement conditions, a component code, an amount, and a delivery date of components that must be newly procured (A9). It is noted that this calculation is repeatedly performed for all components required for the production of the product until the bottom hierarchical level is reached. Although this calculation is performed based on the number of lot(s) in component procurement and component procurement lead time information for the components, when the component procurement lead time must be shortened, the calculation is performed so that the procurement is performed with the shortened component procurement lead time.

Next, the control unit A41 of the server 4 sends, to the personal computer A3 at the component vendor, the component code, the amount, and the delivery date of the components that must be newly procured as component procurement conditions via the communication interface unit A43 (A10).

Next, the control unit A31 of the personal computer A3 at the component vendor causes the display unit A34 to display the component code, the amount, and the delivery date of the components that must be newly procured as component procurement conditions (A11).

Next, the control unit A31 of the personal computer A3 at the component vendor acquires, via the input unit A35, the amount and the delivery date of the components that can be newly delivered as updated component procurement conditions information (A12). Then, the component vendor can input, regardless of a specified number of lot(s) in component procurement, a to-be-delivered amount based on an amount of deliverable components at the time. The delivery date also can be changed to a possible delivery date. This step is performed in the personal computers A3 of all component vendors that supply components that must be newly procured.

Next, the control unit A31 of the personal computer A3 at the component vendor sends to the server A4, via the communication interface unit A33, information regarding the component code, the amount, and the delivery date of the components that can be newly delivered as updated component procurement conditions information (A13). This step is performed in the personal computers A3 of all component vendors that supply components that must be newly procured.

Next, the control unit A41 of the server A4 receives, via the communication interface unit A43, the information regarding the component code, the amount, and the delivery date of the components that can be newly delivered as updated component procurement conditions information (A14). This step is performed for information sent from the personal computers A3 of all component vendors that supply components that must be newly delivered.

Next, when the product can be produced based on the received information regarding the component code, the amount, and the delivery date of the components that can be newly procured, the control unit A41 of the server A4 deducts the number of the newly-procurable and producible products from the desired amount (A15).

Next, the control unit A41 of the server A4 sends to the personal computer A3 at the product maker via the communication interface unit A43 the product code, the delivery date, and the amount as a final judgment of whether the new order can be accepted or not (A16).

Next, the control unit A31 of the personal computer A3 at the product maker receives the product code, the delivery date, and the amount via the communication interface unit A33 (A17).

Next, the control unit A31 of the personal computer A3 at the product maker displays, on the display unit, the product code, the delivery date, and the amount as a judgment of whether the new order can be accepted or not (A18).

Hereinafter, the best mode for carrying out the present invention will be described with reference to the drawings. It is noted that this is a mere example and the technical scope of the present invention is not limited to this.

FIG. 1B is a block diagram illustrating the structure of a computer as a system for providing information showing whether the work can be undertaken or not according to the present invention. The control unit B11, a storage unit B12, the display unit B14, and an input unit B13 are connected via a bus B15. The control unit B11 controls the entirety of the computer B1. The control unit B11 receives an input from a user at the input unit B13 to transmit, as required, information to the display unit. The storage unit B12 includes a storage area for storing work information, resource status information, and other pieces of information. Furthermore, the storage unit B12 stores a program for calculating information showing whether the work can be undertaken or not. The computer B1 reads and executes this program to perform various processing while cooperating with the above hardware. By this structure, the computer B1 functions as a system for providing information showing whether the work can be undertaken or not.

FIG. 2B to FIG. 14B illustrate examples of the structure of information to be displayed on a screen displayed by the display unit B14 by the control unit B11 of the computer B1.

FIG. 2B to FIG. 4B show examples of a screen to which resource status information is inputted. The control unit B11 causes the display unit B14 to display an input field for resource status information composed of resources such as raw material, machine equipment, worker or the like. Through this screen, a responsible person of a manufacturing department can input these pieces of resource status information. It is noted that the resource status information also may be set by another system (e.g., production schedule system) instead of being inputted.

FIG. 2B illustrates an example of an input screen of raw material among resources included in the resource status information. In FIG. 2B, an amount field provided at the right side of each raw material name is inputted with the current value of each raw material on the basis of a unit of resource. As a result, an input of each raw material of resource status information on the basis of a unit of resource is received.

FIG. 3B illustrates an example of an input screen for machine equipment among resources included in resource status information. In FIG. 3B, a status field provided at the right side of each machine equipment name is inputted with the current status of each machine equipment.

FIG. 4B illustrates an example of an input screen for workers among resources included in resource status information. In FIG. 4B, a number-of-workers field provided at the right side of each worker name is inputted with the current number of the respective workers.

FIG. 5B illustrates an example of deliverables information. The control unit B11 causes the display unit B14 to display an input field for deliverables information composed of a deliverable name obtained by the completion of a work and units of deliverables. In FIG. 5B, a deliverable name field, which is sandwiched by a work name field and units of deliverables field, is inputted with a deliverable name obtained by each work. The unit of deliverables field at the right side of the deliverable name field is inputted with deliverables amount obtained by each work.

FIG. 6B to FIG. 8B illustrate an example of a screen to which resource request information is inputted. The control unit B11 causes the display unit B14 to display an input field for resource request information composed of a work name of a work and raw material, machine equipment, workers or the like. Through this screen, a responsible person of a manufacturing department can input resource request information that is required to undertake this work. It is noted that the resource request information also may be set by another system (e.g., production schedule system) instead of being inputted.

FIG. 6B illustrates an example of an input screen of raw material among resources included in the resource request information. In FIG. 6B, tables having the respective work names and raw material names are inputted with the respective values on the basis of units of resources. As a result, an input of the respective raw materials of resource request information of the respective work is accepted.

FIG. 7B illustrates an example of an input screen of machine equipment among resources included in the resource request information. In FIG. 7B, a table consisting of the respective work names and the respective machine equipment names is inputted with machine equipment required by each work.

FIG. 8B illustrates an example of an input screen of workers among resources included in the resource request information. In FIG. 8B, a table consisting of the respective work names and the respective worker names is inputted with the number of workers required by the respective works.

FIG. 9B illustrates an example of a screen for displaying information showing whether the work can be undertaken or not. The control unit B11 causes the display unit B14 to display the information showing whether the work can be undertaken or not that shows whether the work can be entirely undertaken, can be partially undertaken, or cannot be undertaken. Through this screen, a responsible person of a manufacturing department can recognize, with regard to a work, information showing whether the work can be undertaken or not.

FIG. 10B illustrates an example of a screen to which undertaking instruction information is inputted. The control unit B11 causes the display unit B14 to display an input field of undertaking instruction information that shows whether a work is not yet undertaken, partially undertaken, or entirely undertaken and that shows units of deliverables to be obtained by the completion of the undertaken work. Through this screen, a responsible person of a manufacturing department can input the undertaking instruction information for the work.

FIG. 11B illustrates an example of a screen to which work completion information is inputted. The control unit B11 causes the display unit B14 to display an input field of the work completion information that shows whether a work is not yet completed, partially completed, or entirely completed and units of deliverables actually obtained by the completion. Through this screen, a responsible person of a manufacturing department can input the work completion information of the work as completion information.

FIG. 12B illustrates an example of a screen to which work equalizing information is inputted. In FIG. 12B, the term “equalizing plan deliverables amount” represents units of deliverables of deliverables in an equalizing plan prepared by a responsible person of a manufacturing department and constitutes work equalizing information. A row of “deliverables amount” shows units of deliverables for the respective corresponding dates in the above row.

FIG. 13B illustrates an example of a screen for checking an actually undertaken volume. In FIG. 13B, the term “work plan deliverables amount” represents the total sum of an amount on the basis of units of deliverables obtained by all works to be executed within a period calculated based on the work plan. The term “amount of deliverables by undertaking” represents the total sum of an amount of deliverables obtained by all works for which an undertaking instruction is issued on a certain day. This screen simultaneously displays the amount of deliverables by undertaking and the work equalizing information. A responsible person of a manufacturing department can make comparison between these pieces of information to determine an amount of works to be executed within the day.

FIG. 14B illustrates an example of a screen through which an actually completed volume is confirmed. In FIG. 14B, the term “amount of completed deliverables” represents an amount of deliverables obtained from all works completed within a certain period. The term “amount of uncompleted deliverables” represents a total sum of amounts of deliverables corresponding to uncompleted works among those for which undertaking instructions have been issued. This screen simultaneously displays the amount of completed deliverables and the number of uncompleted deliverables. As a result, a responsible person of a manufacturing department can visually check actually-completed works and works being undertaken.

Next, an operation flow of the present invention will be described with reference to FIG. 15B to FIG. 17B.

FIG. 15B to FIG. 17B illustrate flows for calculating information showing whether the work can be undertaken or not. First, the control unit B11 of the computer B1 acquires work information via an input unit B13 (B1). Next, the control unit B11 of the computer B1 acquires resource status information via the input unit B13 (B2). Next, the control unit B11 of the computer B1 judges, based on the resource request information and the resource status information, whether the work can be entirely undertaken or not by judging whether unit(s) of resource(s) of resource status information is (are) equal to or higher than unit(s) of resource(s) of resource request information with regard to all resources required for undertaking a work (B3). When the work can be entirely undertaken, the processing proceeds to B5. When the work cannot be entirely undertaken, whether the work can be partially undertaken or not is judged by judging, with regard to all resources required for undertaking the work, whether unit(s) of resource(s) of the resource status information is (are) equal to or higher than unit(s) of resource(s) required for undertaking at least one unit of resources with regard to deliverables of the work (B4). Next, these judgment results are displayed by the display unit B14 as a result of judging whether the work can be undertaken or not (B5). Furthermore, the control unit B11 of the computer B1 judges whether undertaking instruction information is inputted or not (B6). When undertaking instruction information is inputted, the control unit B11 of the computer B1 acquires the undertaking instruction information via the input unit B13 (B7). Next, unit(s) of resource(s) required for undertaking the work for which the undertaking instruction information is inputted is (are) deducted form the unit(s) of resource(s) of the resource status information (B8). Thereafter, the processing returns to B3. When there is no input of undertaking instruction information, whether work completion information is inputted or not is judged (B9). When work completion information is inputted, the control unit B11 of the computer 1 acquires the work completion information via the input unit B13 (B10). Next, unit(s) of deliverable(s) of deliverables obtained by the completion of the work for which the work completion information is inputted is (are) added to units of resources of resource status information of a corresponding resource (B11). Thereafter, the processing returns to B3. When there is no input of work completion information, the processing is completed.

Hereinafter, the best mode for carrying out the present invention will be described with reference to the drawings. It is noted that this is a mere example and the technical scope of the present invention is not limited to this.

A computer according to the present invention includes, as main components thereof, a database and a storage unit. This database has a plurality of tables. The storage unit includes a storage area. The storage area at least stores therein a plurality of tables, table selection information, additional field information, field-related information, and additional data.

The table selection information represents the selection status of a table selected by a user from among the plurality of tables. By this, a table selected by the user is specified. The additional field information represents a field newly added to the table selected by the user. The field-related information represents a dependency among a plurality of fields. The additional data is data inputted by the user with regard to the new field.

The computer also includes: a table selection information input reception device; an additional field information input reception device; a field-related information input reception device; an additional data input reception device and/or a data input reception device; and a data substitution device. The table selection information input reception device receives an input of the table selection information by a user. The additional field information input reception device receives an addition of a new field by the user with regard to the selected table. The field-related information input reception device receives an input of the field-related information by the user. The additional data input reception device receives an input of the additional data by the user. The data substitution device substitutes an additional data to the new field based on the field-related information and the additional data.

Hereinafter, an exemplary embodiment in which the present invention is applied to a production management system will be described. However, this is a mere exemplary embodiment in order to explain an embodiment of the present invention. Embodiments of the present invention are not limited to this and includes an embodiment other than the production management system as described above.

FIG. 1C is a block diagram illustrating the structure of a computer as a production management system according to the present invention. A control unit C11, a storage unit C12, a display unit C14, and an input unit C13 are connected via a bus C15. The control unit C11 controls the entirety of a computer C1. The control unit C11 receives an input from a user at the input unit C13 to transmit, as required, information to the display unit. The storage unit C12 includes a storage area for a plurality of tables of the database, table selection information, field-related information, and other pieces of information. Furthermore, the storage unit C12 stores a database control program. The computer C1 reads and executes this program to perform various processes while cooperating with the above hardware. By this structure, the computer C1 functions as a production management system.

FIG. 2C to FIG. 9C illustrate examples of the structure of information to be displayed on a screen by the display unit C14 by the control unit C11 of the computer 1.

FIG. 2C shows an example of a screen to which table selection information is inputted. A user-selects, from this screen, a table to which a field is desired to be added and checks a checkbox at the left side of the table name. As a result, an input of the table selection information is received. The table selection information represents the selection status of a table selected by the user from a plurality of tables. In this example, two tables for a field master and a slip table are selected.

FIG. 3C shows an example of a screen to which additional field information is inputted. Through this screen, the user selects a type of a field by selecting a radio button and inputs a field name, a size, a field name, and a default value. As a result, additional field information representing a new field added to the table selected by the user is inputted and the additional new field is received. In this example, a field type of “character field” is selected and a field name of “COLOR”, a size of “10”, and a field name of “color” are inputted.

FIG. 4C shows an example of a screen to which field-related information is inputted. Here, the field-related information represents a dependency among a plurality of fields at least including a new field that is added to the table selected by the user. Through this screen, the user inputs, to the field name field, a field name of a field to have a dependency and then depresses the “apply” button. As a result, the input of field-related information is received. In this example, the direction of the arrow in the screen represents the direction of the dependency. Specifically, additional fields in tables connected by the arrows have a dependency in which a field at the right side of another field is dependent on the another field. For example, fields “color” of the item master and the slip table (field name: “COLOR”) has a dependency in which the field “color” of the slip table is dependent on the field “color” of the item master. It is noted that these arrows connect not only neighboring tables but also provides a dependency between, for example, a field of the item master and a field of the completion table in FIG. 4C. It is noted that a dependency between tables also can be inputted by a method other than that of this embodiment for operating a mouse by dragging and dropping the mouse for example to connect arbitrary tables by an arrow (not shown). In this case, the dependency between the inputted tables is reflected on field-related information between fields belonging to the tables.

FIG. 5C shows an example of a screen to which additional data is inputted. Additional data is inputted by a user with regard to a new field. Through this screen, the user selects a table name field to select a table to which additional data is inputted and inputs data to a field of an added field to subsequently depresses an input completion button. As a result, the input of the additional data is received. In this example, with regard to the field name “color”, a component having the “field code” of “A” is inputted with “red”, a component having the “field code” of “Al” is inputted with “white”, a component having the “field code” of “A2” is inputted with “black”, a component having the “field code” of “B” is inputted with “yellow”, and a component having the “field code” of “B1” waits for an input.

FIG. 6C shows an example of a table display screen. The data inputted to the field added by the user through the additional data input screen of FIG. 5C is also reflected on fields of another table having a dependency. This example shows that the input of “yellow” to the field name “color” of the item master of FIG. 5C is reflected so that the field name “color” of “0003” of “slip number field” in the slip table of FIG. 6C is “yellow”.

FIG. 7C illustrates an example of a data update screen. A user overwrites already-inputted field data for input and depresses an update button to update the data. As a result, the update of the data stored in the database is received. The received update is reflected on added fields in another table having a dependency. In this example, an input is provided by a user according to which the data “yellow” of the field name “color” of a component having the field name “field code” of “B” in the table of FIG. 7C is changed to “blue”. Due to the dependency as described above in which the field “color” of the item master is substituted to the “color” field of the slip table, this change is automatically reflected on fields of another table having the dependency when the update button is depressed thereafter.

FIG. 8C shows another example of the table display screen. The update of the data by the user to the added field through the data update screen of FIG. 7C is also reflected on fields of another table having the dependency. In this example, the field name “color” of the “field code” “B” of the item master of FIG. 7C is updated by causing the field name “color” of the “slip number field” “0003” of the slip table of FIG. 7C to be “blue”.

FIG. 9C illustrates an example of the screen to which field-related information is inputted in a different embodiment. Through this screen, the user inputs a table name including a field used for an operation, and field name used for the operation, an operator, a table name for storing the operation result, and a field name to depress the “apply” button. As a result, the input of the field-related information is received that represents the dependency and that includes a mathematical expression provided to include at least the new field. In this example, the dependency is established in which the field 1 and the field 2 are “independent” from the field 3 in the screen and the field 3 is “dependent” on the field 1 and the field 2. For example, the field “COLOR” of the item master and the field “COLOR” of the slip table have a dependency in which the field “COLOR” of the item master is independent from the field “COLOR” of the slip table. According to this dependency, the field “unit weight” of the item master and the “amount” of the completion table are “independent” from the “weight” of the completion table and the “weight” of the completion table is “dependent” on the field “unit weight” of the item master and the “amount” of the completion table. Although not shown, when the data of the “unit weight” of the item master that is “independent” is updated for example, this update will be reflected on the “weight” of the completion table that is “dependent”. This embodiment assumes that the “unit weight” and the “amount” are existing fields and the “weight” is newly added. However, the technical scope of the present invention is not limited to this and field-related information for an arbitrary field can be inputted regardless of whether the field is an existing field or a new field.

FIG. 10C illustrates an example of the flow for adding, based on the present invention, a new field to the database of the production management system to substitute additional data to the field. First, the control unit C11 of the computer C1 acquires table selection information via the input unit C13 (C1). Next, the control unit C11 of the computer C1 acquires additional field information via the input unit C13 (C2). Next, the control unit C11 of the computer C1 acquires additional data via the input unit C13 (C3). Next, the control unit C11 of the computer C1 adds, based on the additional field information, a new field to the selected table (C4). Next, the control unit C11 of the computer C1 substitutes the additional data to the added new field (C5) . The above steps substitute additional data to the new field based on the additional field information.

FIG. 11C illustrates an example of the flow showing a procedure for substituting, based on the present invention, data to the database of the production management system based on the field-related information. First, the control unit C11 of the computer C1 acquires the field-related information via the input unit C13 (C6). Next, the control unit C11 of the computer 1 acquires data via the input unit C13 (C7). Next, the control unit C11 of the computer C1 substitutes, based on the field-related information, data to a plurality of fields (C8). The above steps add the newly added field to the specified table and substitute data based on the dependency among fields.

FIG. 12C illustrates an example of the flow showing a procedure for substituting, based on the present invention, additional data to the added field and/or existing field in the database of the production management system based on the field-related information. First, the control unit C11 of the computer C1 acquires the table selection information via the input unit C13 (C9). Next, the control unit C11 of the computer C1 acquires the additional field information via the input unit C13 (C10). Next, the control unit C11 of the computer C1 acquires the field-related information via the input unit C13 (C11). Next, the control unit C11 of the computer C1 acquires additional data via the input unit C13 (C12). Next, the control unit C11 of the computer C1 adds, based on the additional field information, a new field to the selected table (C13). Next, the control unit C11 of the computer C1 substitutes, based on the field-related information, the additional data to a plurality of fields at least including the added new field (C14). The above steps add the newly-added field to the selected table and substitute the data based on the dependency among fields.

FIG. 13C illustrates the flow showing a procedure when the data of a field of the database of the production management system is changed. In this case, the control unit C11 of the computer C1 receives the update of the data of the table via the input unit C13 (C15). Then, the control unit C11 of the computer C1 judges whether the data has been updated or not (C16). When data of an arbitrary field among added fields is updated, the control unit C11 of the computer C1 substitutes, based on the field-related information, the updated data to a plurality of fields (C17). Thereafter, the processing is completed. When there is no update of data, the processing is completed.

As described above, when the data of the field is changed, data of fields of all related tables will be updated.

Hereinafter, the best mode for carrying out the present invention will be described with reference to the drawings. It is noted that this is a mere example and the technical scope of the present invention is not limited to this.

FIG. 1D is a block diagram illustrating the structure of a production management apparatus D1 according to the present invention. The production management apparatus of the present invention is desirably realized by a computer. A control device D11, a storage device D12, a display device D14, and an input reception device D13 are connected via a bus D15. The control device D11 controls the entirety of the production management apparatus. The control device D11 reads and executes a program stored in the storage device D12 for example, thereby realizing various device (which will be described later) while cooperating with the above hardware.

The control device D11 includes: a BOM preparation device D112 for preparing, based on inputted CAD data, a design BOM and a production BOM; a to-be-ordered component calculation device D113 for calculating, based on the prepared production BOM, the to-be-ordered component in association with a production number; a changed BOM preparation device D114 for preparing a changed BOM based on CAD data of a changed drawing; a changed component calculation device D116 for comparing a component included in the prepared changed design BOM with the to-be-ordered component stored in the storage device D12 to calculate a to-be-canceled component and a to-be-additionally-ordered component including the amounts thereof; an acquisition device D117 for acquiring information showing whether the displayed to-be-canceled component can be cancelled or not; and a slip issue device D118 for issuing a canceling slip for a cancelable component and a slip for the to-be-additionally-ordered component.

The storage device D12 can be realized by a hard disk or a semiconductor memory and stores information for an ordered component and other pieces of information required for the production management apparatus. The input reception device D13 can be realized by an input reception device (e.g., LAN) using a keyboard, a scanner, or a communication line for example. The display device can be realized by a liquid display or a cathode-ray tube (CRT) for example.

FIG. 2D is a flowchart illustrating the conceptual operation of the production management apparatus D1 according to the present invention. FIG. 3D to FIG. 11D illustrate contents displayed by the display device D14 in the production management apparatus D1.

A product obtained by one item portion is also generally subjected to a process for determining the basic design. The basic design is provided to the basic device and structure of a machine or equipment to be produced. In the basic design, so-called long delivery component and long delivery material requiring a long delivery from an order placement to the delivery are also selected. When the basic design is completed, the CAD data thereof is inputted by the input reception device D13 to the production management apparatus D1 (D110). Based on the inputted CAD data, a design BOM is prepared (D120). Based on the design BOM, a production BOM incorporating production conditions is prepared (D130).

FIG. 3D illustrates an example of Engineering Bill of Material, a production component structure, and a production BOM converted from the CAD data. As shown in FIG. 3D, the Engineering Bill of Material and the production component structure graphically show a relationship between components and a unit by the display device D14 to clarify the relationship. As shown in FIG. 3D, the Engineering Bill of Material and the production component structure may be different from each other due to a convenience of production. For example, there may be cases where the Engineering Bill of Material specifies that a component V belongs to a C1 unit while the production component structure specifies that the component V belongs to a C2 unit. The lower part of FIG. 3D illustrates an example of the production BOM.

The next processing is the first processing and thus performs a processing for showing “no change” (D140). When the processing for showing “no change” is performed, a process for issuing an ordering slip based on the production BOM is performed, which will be described (D150). FIG. 4D illustrates an input screen in a case where a new production number is firstly inputted. As shown in FIG. 4D, the item code “C”, the production number “SEI01”, the amount “1”, and the planned completion date “20050223” in the production BOM for example are inputted. After the screen is confirmed, an execution button is clicked. Then, a list of ordered components (before loading) as shown in FIG. 5D is displayed. When the result of the confirmation of this screen shows no problem, a user clicks another button (not shown). Then, a screen as shown in FIG. 6D is displayed by the display device D14. FIG. 6D shows that the status is changed from “0” to “1”, showing that the above input is loaded to the production number “SEI01”.

When the above input is loaded to the production number “SEI01”, then an existence or non-existence of an ordered component is investigated (D160) . Since the first processing does not include an ordered component, a component is ordered in advance by the production management apparatus D1 (D210). Then, the storage device D12 stores therein the information for the ordered component in association with the production number “SEI01” (D220).

Next, when a detailed design is completed, the CAD data is inputted as in the case of the basic design (D110). The inputted CAD data is processed as in the case of the basic design (D120, D130). Thereafter, no change is performed (D140). Thus, the ordered component is loaded from the production BOM (D150). Thereafter, an existence or non-existence of an ordered component for the same production number is checked (D160) . Since “an ordered component exists”, then an additional component is ordered (D310). Then, the information for the ordered component is stored in the storage device D12 while being associated with the production number (D320). When there is no change or the like, then the production management of the production number by this processing is completed.

However, a specification or a design is changed due to various reasons as described above. When a situation where a specification or a design is changed is caused, then a design change is performed. When the design change is completed, then the input reception device D13 inputs the CAD data (D110). As described above, a design BOM is prepared based on the CAD data (D120). A production BOM is prepared based on the design BOM (D130). Then, a changed production BOM as shown in FIG. 7D is prepared. The subunit C1 of the drawing number C1 before change (FIG. 3D) has the child drawing number “V” and the subunit C1 of the drawing number C1 in the example of FIG. 7D has the child drawing number “V2”.

Next, the result is “change exists” (D140). Thus, a processing for an additional component and a non-required component is performed (D410). Then, the display device D14 displays a screen as shown in FIG. 8D that reflects the change. When an execution button is clicked, the list of ordered components (after change) as shown in FIG. 9D is displayed by the display device D14. In the example of FIG. 9D, the status “9” represents that the component V having the branch number 5 is not required and the status “0” represents that the component V2 having the branch number 7 is a component that must be additionally ordered. Specifically, the production management apparatus D1 automatically searches data based on the information stored in the storage device D12. Then, a non-required component and an additional component are displayed by the display device D14.

With regard to the non-required component having the branch number 5, information showing whether the changed non-required component can be cancelled or not is acquired by the acquisition device D117 (D430). When the investigation result shows that the cancel is impossible, then whether the component can be used for other purposes or not is investigated (D435) . When the investigation result shows that the cancel is possible, then the status of the branch number 5 is changed to “7” as shown in FIG. 10D. When the cancel is impossible and the component can be used for other purposes, then the production number is cancelled and the status of the branch number 5 is changed to “8” as shown in FIG. 11D. When the cancel is impossible and the component cannot be used for other purposes, then the status of the branch number 5 is changed to “6” (not shown).

After the processing, by the status information for the non-required component V having the branch number 5, slips required for order canceling (D440), inventory processing (D450), and disposal processing (D460) are issued by the slip issue device D118 and the information is stored in the storage device D12.

With regard to the additional component having the branch number 7, the component V2 having the branch number 7 of the status “0” is subjected to an additional component ordering processing (D420). Specifically, the slip issue device D118 issues the ordering slip and the information is stored in the storage device D12 while being associated with the production number.

As described above, the production management apparatus 1 allows, even when a change or the like is requested from a customer to a user, the user to take a measure suitable for the changed contents in a secure manner. As a result, an inconvenience including, for example, an increase of the cost or a delayed completion due to the change can be minimized.

In particular, even in the case of a product obtained by one item portion, processes such as the cancellation of a changed component, an additional ordering, or a processing of inventory can be executed securely. As a result, an estimation considering the changed cost also can be provided accurately.

As a result, morale of employees is improved. Furthermore, the number of disposed components can be reduced when compared to a case where rough estimation is performed. Thus, an environmental destruction due to disposed scraps.

Although the above example has described the production management apparatus, the present invention also can be realized by installing a production management program having the device described with regard to the production management apparatus into a computer so that the computer can function as the device.

Alternatively, the present invention also can be realized by causing the computer to read the computer-readable recording medium for recording the production management program as described above to install the production management program so that the computer can function as the device.

Alternatively, the present invention also can be realized by installing a computer program having an equivalent device to a computer having an equivalent performance as that of the above production management apparatus to use the computer by the method as described above.

As described above, embodiments of the present invention have been described. However, the technical scope of the present invention is not limited to the scopes described in the above embodiments. The above embodiments can be subjected to various changes or modifications. Embodiments including such computer program also may be included in the technical scope of the present invention, as can be seen from the description of the claims. For example, although the above section has described a case where the production management apparatus is a computer, a system using a digital signal processor instead of CPU also may be used. Furthermore, although the above section has mainly described the control of custom-made production, the present invention also can be applied to not only custom-made production but also small or medium scale production control.

Hereinafter, the best mode for carrying out the present invention will be described with reference to the drawings. It is noted that this is a mere example and the technical scope of the present invention is not limited to this.

FIG. 1E is a block diagram illustrating the structure of a production management apparatus E1 according to the present invention. The production management apparatus of the present invention is desirably realized by a computer. A control device E11, a storage device E12, a display device E14, and an input device E13 are connected via a bus E15. The control device E11 controls the entirety of the production management apparatus. For example, the control device E11 reads and executes a program stored in the storage device E12, thereby realizing, while cooperating with the hardware, various device (which will be described later).

The control device E11 includes an MRP production management device E111. The MRP production management device E111 includes an inventory data update device E112 and a requirement calculation device E114. The MRP production management device E111 can be realized by introducing the f-MRP function of f-MRP function made by TPiCS Laboratory, Inc. for example.

The storage device E12 can be realized by a hard disk or a semiconductor memory and stores information for an ordered component and other pieces of information required for the production management apparatus. The input device E13 can be realized by an input reception device (e.g., LAN) using a keyboard, a scanner, or a communication line for example. The display device can be realized by a liquid display or a cathode-ray tube (CRT) for example.

FIG. 2E illustrates the status of the use of the production management apparatus E1 according to the present invention. FIG. 3E is a flowchart illustrating the operation of the production management apparatus E1 according to the present invention. FIG. 4E illustrates a screen displayed by the display device E14 of the production management apparatus E1. Through this screen, an operator inputs a completion value by a completion value input device E132 and inputs a theoretical inventory by a theoretical inventory value input device E134 to confirm the result through the screen.

The production management apparatus E1 using the MRP production management device E111 is structured so that a completion value and a theoretical inventory value are inputted, with regard to a predetermined production schedule for the respective processes, to the production management apparatus E1, as shown in the examples of FIG. 2E to FIG. 4E. As shown in FIG. 2E, one product is manufactured by subjecting material X to the first process A1, the second process A2, and the final process A3 in this order. This production schedule shows 130 materials at the material status. However, the production schedule considers the existence of a defect rate to estimate that the first process A1 provides 120 works-in-process, the second process A2 provides 110 works-in-process, and the final process A3 provides 100 works-in-process.

For example, a case will be considered as shown in FIG. 4E where the first process A1 according to a work instruction number WW00123 is completed (E110) and the first process A1 provides a completion value of 118. Conventionally, an input of the completion value of 118 causes the subsequent requirement calculation to calculate, based on the inputted completion value, an amount of material to be ordered and the timing of the order based on a BOM and inventory information. This has caused an inconvenience where, even when a responsible person at a shop floor judges that the difference between the planned value and the completion value can be compensated by the second process A2 or the final process A3 based on the past completion or the like, the amount of material to be ordered and the timing of the order are calculated based on the planned value and the completion value, thus causing a situation where a slip for compensating the shortage is issued.

The production management apparatus of the present invention includes, as shown in FIG. 4E, not only a field to which a completion value is inputted but also a field to which a theoretical inventory value is inputted. After the completion of the first process A1, a completion value 118 is inputted (E120). When a responsible person at a shop floor judges that the difference between the planned value and the completion vale can be compensated in consideration of the past completion or the like (E130), then a theoretical inventory value 2 is inputted (E140). When the responsible person at the shop floor judges that the difference between the planned value and the completion vale cannot be compensated, a theoretical inventory value is not inputted. Alternatively, a theoretical inventory value of 1 (one) also may be inputted based on the judgment that the difference can be partially compensated. When the theoretical inventory value is inputted, then the theoretical inventory value is inputted from the completion value input device E132 to the production management apparatus E1. Then, the theoretical inventory value is displayed by the display device E14 together with the completion value 118, as shown in FIG. 4E (E150). The theoretical inventory value is also inputted from the theoretical inventory value input device E134 to the production management apparatus E1 and is displayed by the display device E14 as a theoretical inventory of 2 as shown in FIG. 3E (E150). It is noted that, when a theoretical inventory value is not inputted, the theoretical inventory field of FIG. 4E is displayed as an empty field. When the user sees the displayed input value and judges that the value is correct, then the user clicks an input button of FIG. 4E. As a result, the data is loaded to the inventory data update device E112. When the user clicks a cancel button, then the completion value field and the theoretical inventory field become empty and the processing returns to an input of a completion value (E120). The processing also may be configured so that the display of this screen is completed.

Based on the inputted completion value, the inventory data update device E112 updates inventory data for an MRP production management (E170). Furthermore, the requirement calculation device E114 calculates, based on the updated inventory data and the theoretical inventory value 2, a requirement for an MRP production management (E185). Thereafter, an existence or non-existence of a deficient component is examined (E190). The result is that the total sum of the updated inventory data and the theoretical inventory value 2 is equal to the planned amount of 120. Thus, the deficient component is 0(zero) and an additional slip is not issued.

When an input of a theoretical inventory value is not required (e.g., when a responsible person of a shop floor judges that the difference between the planned value and the completion vale cannot be compensated) on the other hand, then the inventory data update device E112 updates, based on the inputted completion value, inventory data for an MRP production management (E170). Furthermore, the requirement calculation device E114 calculates, based on the updated inventory data, a requirement for an MRP production management (E180). The result in the case of FIG. 4E is that the updated inventory data is 118 to the planned amount of 120. Thus, a deficient amount is 2 and an additional slip for two components is issued.

After the completion of the above processing, then an input of data for the next process is prepared (E200). If the difference between the planned value and the completion vale can be compensated as expected by the responsible person of the shop floor as in the example of FIG. 2E, then the second process A2 inputs a completion value of 110. If the final process A3 proceeds as planned by the production schedule, then a completion value of 100 will be inputted.

As a result, the production management apparatus can be used as an MRP production management apparatus adapted to an actual situation. Thus, production management can be performed in a preferred manner.

Although the above example has described the example of the production management apparatus, the present invention also can be realized by installing, to a computer, a production management program having the device described for the production management apparatus so that the computer can function as the device.

The present invention also can be realized by causing a computer to read a computer-readable recording medium in which the production management program as described above is recorded to install the production management program so that the computer can function as the device.

Alternatively, the present invention also can be realized by installing a computer program having an equivalent device to a computer having an equivalent performance as that of the above production management apparatus to use the computer by the method as described above.

As described above, embodiments of the present invention have been described. However, the technical scope of the present invention is not limited to the scopes described in the above embodiments. The above embodiments can be subjected to various changes or modifications. Embodiments including such changes or modifications also may be included in the technical scope of the present invention, as can be seen from the description of the claims. For example, although the above section has described a case where the production management apparatus is a computer, a system using a digital signal processor instead of CPU also may be used.

Hereinafter, the best mode for carrying out the present invention will be described with reference to the drawings. It is noted that this is a mere example and the technical scope of the present invention is not limited to this.

FIG. 1F is a block diagram illustrating the structure of a production management apparatus F1 according to the present invention. The production management apparatus of the present invention is desirably realized by a computer. A control device F11, a storage device F12, a display device F14, an input device F13, and a reception and input device F16 are connected via a bus F15. The control device F11 controls the entirety of the production management apparatus. The control device F11 reads and executes a program stored in the storage device F12 for example, thereby realizing various device (which will be described later) while cooperating with the above hardware. The reception and input device F16 is connected to a terminal F20 via a communication line F18.

The control device F11 includes a production preparation situation calculation device F112 and a capacity requirement calculation device F114. The input device F13 includes respective pieces of process information input device F132 and a change input device F134. The display device F14 includes a production preparation situation display device F142 and a capacity requirement display device F144.

The storage device F12 can be realized by a hard disk or a semiconductor memory and stores information for an ordered component and other pieces of information required for the production management apparatus. The input device F13 can be realized by an input reception device (e.g., LAN) using a keyboard, a scanner, or a communication line for example. The display device F14 can be realized by a liquid display or a cathode-ray tube (CRT) for example. The reception and input device F16 can be realized by a communication hardware and related software (e.g., communication modem, TA, router). The communication line F18 can be realized by a general public line or the Internet. The terminal F20 can be realized by a personal computer or the like.

FIG. 2F is a flowchart illustrating the operation of the production management apparatus F1 according to the present invention. FIG. 3FA-3FC shows an example of a Gantt chart-based production preparation situation displayed by the production preparation situation display device F142 and the capacity requirement display device F144 of the production management apparatus F1 according to the present invention. FIG. 4F illustrates detailed production management information displayed by the display apparatus F14 of the production management apparatus F1 according to the present invention.

Here, production management information specifically device, for example, a production number and a production BOM as well as inventory, a production place, a supplier, and a planned completion date of to-be-used child components. The production preparation situation is information showing whether production preparation in the respective processes is provided or not. More specifically, the production preparation situation is information that can be represented as “◯”, “Δ”, and “X”. The capacity requirement specifically represents, for example, the sum of amount obtained through works planned on the day. Alternatively, the capacity requirement also may represent, for an easy understanding, a numerical number of processes that must be performed within the day.

Hereinafter, the production management apparatus F1 of the present invention will be described with reference to the operation and the use method. First, with regard to a production schedule, production management information is inputted in advance by the input device F13. The production management information is different depending on a product to be produced. The production management information is, for example, a plurality of production numbers, a component structure, a component name, and an amount related to the production number, a name of a production place of the component, and a planned completion date of each component or each process. Next, the process information input device F132 is used to input each piece of process information regarding the arrival or the completion of material or a component under production management that includes the schedule or a track record (F110). Such process information also may be directly inputted from the terminal F20 of a vendor by the reception and input device F16 via the communication line F18. Then, these pieces of information are stored by the storage device F12 (F120). The respective pieces of process information are collected whenever a piece of information is obtained or whenever a predetermined period has passed and are inputted by the respective pieces of process information input device F132 and are stored in the storage device F12 while being associated with the production schedule.

A desired investigation time is inputted by the input device F13 (F130). Alternatively, the input of a desired investigation time also may be substituted by providing a clock function to the production management apparatus 1 so that the current time is automatically inputted and the processing can proceed to the subsequent processing. Alternatively, depending on the type of a product to be subjected to production control, a desired investigation date also may be used instead of a desired investigation time.

When the desired investigation time is inputted, the production preparation situation calculation device F112 calculates, based on the respective pieces of process information and production management information stored in the storage device F12, a production preparation situation at the desired investigation time (F140). Next, the production preparation situation display device F142 displays the calculated production preparation situation and production management information (F150). Then, it is desirable that the capacity requirement calculation device F114 calculates, based on the production management information of the production schedule, a capacity requirement (F160) and the capacity requirement display device F144 displays the capacity requirement in association with the production preparation situation and the production management information together with the time axes thereof (e.g., date) (F162).

FIG. 3FA-3FC illustrates an example in which the production preparation situation and the pileup information are displayed based on a Gantt chart method. FIG. 3FA-3FC displays production management information (e.g., a production number, a branch number, a title of a component or a process, a planned completion date, an amount, a production place, a order number), dates at which slips for the respective components or processes are issued, and a work time schedule are displayed. An applicable date at which a slip is issued is shown by a square colored by gray and the work time schedule is shown by a block colored by pale gray. The desired investigation time is April 7 and is shown by diagonal lines. In FIG. 3FA-3FC, the thick solid line represents a relationship showing that a component is required for the next process. As shown in FIG. 3FA-3FC, the Gantt chart-based display provides an understanding of the entire work schedule. In the display as described above, the production preparation situation according to the present invention is calculated by the production preparation situation calculation device F112 and the result regarding a component or a process for which the preparation is provided is displayed by production preparation situation display device F142 as “◯” so that the component or the process can be intuitively judged at a glance. In FIG. 3FA-3FC, the component or the process for which the preparation is provided applies to the combination of the production number “se03”, the branch number “3”, the “electric component”, and April 4 and the combination of the production number “se02”, the branch number “9”, the “supply”, “Sengoku Kinzoku Limited Company”, and April 6. On the other hand, a component or a process for which the preparation is not yet provided is displayed by “X” so that the component or the process can be intuitively judged at a glance. The component or the process for which the preparation is not provided applies to the combination of the production number “se01”, the branch number “2”, the “total assembly”, and April 6 and the combination of the production number “se02”, the branch number “7”, the “outsourced processing ”, the “Sengoku Kinzoku Limited Company”, and April 7, and the combination of the production number “se03”, the branch number “2”, the “total assembly”, and April 12. Although not shown, a component or a process for which the preparation is partially provided is displayed by “Δ” so that the component or the process can be intuitively judged at a glance.

As described above, the production preparation situation is displayed so that the production preparation situation can be judged intuitively at a glance. As a result, a manager of a production shop floor can know which process can be undertaken now.

The lower section of FIG. 3FA-3FC illustrates capacity requirement that are a desirable embodiment of the present invention and that are displayed by the capacity requirement display device F144 as numerical values. This capacity requirement also may be displayed by a graph or a different color. In this embodiment, each the numerical values represents the number of processes that must be performed within the day. Those numerical values that have a great number of works and that are problematic are shown with the frame with a thick line. As can be seen from FIG. 3FA-3FC, Manufacturing Section 1 has significantly many works on April 12. In this manner, not only the production preparation situation but also the capacity requirement can be known. Thus, the manager of the production shop floor can determine the situation more accurately. For example, based on the capacity requirement of FIG. 3FA-3FC, it is found that Manufacturing Section 1 has a great number of works and that the schedule is problematic. When such a problem is found (F170), the production place is changed from F1 to F2 (i.e., from Manufacturing Section 1 having the great number of works to Manufacturing Section 2 having no planned works) for example (F180) . When the change is inputted and a registration button is clicked, then the production preparation situation is calculated again in accordance with the changed contents and the capacity requirement is calculated again and is displayed. When a user sees the display and finds no problem, then the user can carry out the operation based on the changed schedule. Alternatively, dates at which processes by Manufacturing Section 1 are undertaken also may be partially changed. In such a case, the change also may be realized by moving, although not shown, a schedule bar on a Gantt chart by dragging and dropping a mouse. In this case, the production preparation situation and the capacity requirement are also calculated again as in the above case and are displayed.

In FIG. 3FA-3FC, when a schedule bar shown with “X” representing that the work cannot be undertaken is clicked, then detailed production management information is displayed. FIG. 4F shows an example of a display that is displayed when the schedule bar of the production number “se03”, the branch number “2”, the “total assembly”, and April 12 in FIG. 3FA-3FC is clicked. In FIG. 4F, the upper section displays the respective production management items of the problematic process. The middle section shows whether components that are required for performing the total assembly and that correspond to reserved inventory can be used or not. The example of FIG. 4F shows that there is inventory of one available driving apparatus. The lower section shows the manufacturing situation of the respective components.

Next, the example of FIG. 3FA-3FC shows that the schedule bar of the production number “se03”, the branch number “5”, and April 12 is displayed with the frame of a thick line. This display is due to a reason that the schedule conflicts with the delivery date because a delivery date of the mechanism unit having the production number “se03” and the branch number “5” (April 13) is later than a date at which the work for the combination of the production number “se03” and the branch number “2” is undertaken. Such a situation is caused because Komagome Kogyo Co., Ltd. as a vendor has directly inputted the respective pieces of process information by the reception and input device 16. Although the schedule bars in this example are displayed with the frame by a thick line, the schedule bars also may be displayed with a different color (e.g., red). The reason why the plan for the combination of the production number “se03” and the branch number “2” is represented by “>X” is that the electric component having the branch number “3” and the mechanism unit having the branch number “5” are not yet completed and thus the total assembly for the combination of the production number “se03” and the branch number “2” cannot be undertaken now. In this case, the plans for the total assembly and installation work must be postponed two days. If the final installation work cannot be postponed due to a relationship with a customer, it is required to request Komagome Kogyo to expedite the delivery date or to shorten the period for the total assembly for example. When Komagome Kogyo is to be requested to expedite the delivery date, then a desirable schedule date can be sent again to Komagome Kogyo Co., Ltd. as a vendor by dragging and dropping the plan to left on this Gantt chart or by using a communication device.

In a more desirable embodiment, by calculating the production preparation situation for a predetermined period before and after a desired investigation time and by calculating the capacity requirement for the predetermined period in advance and displaying the situations, a manager of a production site is allowed to judge the situations in an integrated manner. An appropriate length of the predetermined period is different depending on a type of a product to be produced. Thus, the predetermined period is desirably determined by the production shop floor in advance. In the example of FIG. 3FA-3FC, the time earlier than April 7 as the desired investigation date is displayed with a process for which a work is not yet completed. The time later than April 7 as the desired investigation date is displayed with fourteen days as a predetermined period.

As described above, by automatically calculating whether a production preparation is provided or not in individual working places where production management is performed based on completion data of processes and by displaying the data in a manner in which a user can easily take an appropriate measure, the production management apparatus for providing an efficient production management can be provided.

Next, another exemplary embodiment of the present invention will be described. For some types of products, a resource used for the production may be important for the judgment in the production control. It is an object of this embodiment to further improve the present invention so as to be easily used in the case as described above. FIG. 5F is a block diagram illustrating the structure of a production management apparatus F1′ of another exemplary embodiment of the present invention. The production management apparatus F1′ shown in FIG. 5F has the same structure as that of FIG. 1F except for that a production resource information input device F136 is added to an input device F13. FIG. 6F is a flowchart illustrating the operation of the production management apparatus F1′ shown in FIG. 5F. FIG. 6F have contents that are different from those described in FIG. 2 in that FIG. 6F additionally includes a step for inputting production resource information (F112), a step for calculating an equipment use situation (F164), and a step for displaying an equipment use situation (F166).

As shown in FIG. 5F and FIG. 6F, production preparation situation is calculated together with the contents as described above and production resource information. Then, the production preparation situation is displayed. Thus, when a production resource is important in the judgment in the production control, a manager of a shop floor can judge the situation and take a measure more appropriately.

FIG. 7FA-7FC illustrates another exemplary embodiment for the production preparation situation display device F142. As shown in FIG. 7FA-7FC, this embodiment is comprising a column is additionally provided at the top part of the Gantt chart. This column displays a production preparation situation. The additionally-provided column leads to an advantage that a part in the displayed screen that should always attract attention from a manager is fixed. The additional display of the equipment use situation also allows a manager to understand the production management situation more comprehensively to take an appropriate measure.

Although the above example has described the production management apparatus, the present invention also can be realized by installing a production management program having the device described with regard to the production management apparatus into a computer so that the computer can function as the device. Alternatively, the present invention also can be realized by causing a computer to read the computer-readable recording medium for recording the production management program as described above to install the production management program so that the computer can function as the device.

Alternatively, the present invention also can be realized by installing a computer program having an equivalent device to a computer having an equivalent performance as that of the above production management apparatus to use the computer by the method as described above.

As described above, embodiments of the present invention have been described. However, the technical scope of the present invention is not limited to the scopes described in the above embodiments. The above embodiments can be subjected to various changes or modifications. Embodiments including such changes or modifications also may be included in the technical scope of the present invention, as can be seen from the description of the claims. For example, although the above section has described a case where the production management apparatus is a computer, a system using a digital signal processor instead of CPU also may be used. Furthermore, although the above section has described the example of the display of a production preparation situation based on Gantt chart, the present invention also can be carried out by the part time method.

Effect of the Invention

As described above, the present invention may provide effects as shown below.
(a) To improve the accuracy and speed of production management and to reduce the cost for the production control.
(b) To improve, base on the above (a), a capability of a shop floor to cope with a change caused in a production activity.

As described above, the present invention may provide effects as shown below.
(a) By promoting the equalizing of manufacturing works, to make the manufacturing works to be more efficient and to stabilize the manufacturing processes.
(b) By presenting an amount of works to be done within the day as a goal so that the amount can be compared with an amount of works that have been actually undertaken so that how far the current situation is from the goal can be visually confirmed, thereby promoting willingness for the work to improve the production efficiency.
(c) By providing information showing whether the work can be undertaken or not to a sudden change of a situation caused in a production site to support the decision making for the manufacturing work schedule (i.e., decision making as to whether to maintain, change, or stop the schedule), thereby improving the capability of the production site to cope with an accident.

The present invention as described above may provide the effects as described below. Specifically, an arbitrary item can be securely added to a plurality of tables of a database while eliminating the labor for receiving an input from a user of table selection information and item-related information to directly edit a database schema. Furthermore, it is not required to rewrite an application in order to handle an added item. This allows, without help from a programmer, the user himself to add the item to use the system.

According to the present invention, even when a product obtained by one item portion for example faces a situation where a component is ordered in advance in order to shorten a schedule period from a date at which the work is undertaken to a date at which the product is completed and then the component is subsequently changed due to the change of an intention of a customer, the changed component and a non-required component can be appropriately detected and can be reflected on the production control. This can prevent the change from delaying the schedule period from a date at which the work is undertaken to a date at which the product is completed. This also can suppress, in a reasonable manner, an increase of the cost due to the change. Furthermore, this also can minimize an amount of disposed unnecessary components, which is environmentally preferable.

The present invention can eliminate even an inconvenience where, when a responsible person at a shop floor judges that a difference between an actual inventory and a planned value can be compensated by the next process when the responsible person calculates, at an arbitrary timing, a requirement by an MRP production management system for the production management based on Material Requirements Planning for calculating, based on a production BOM and inventory information, an amount of material to be ordered and an ordering timing, the calculation is performed based on the planned value to cause a situation where a slip for compensating the difference is issued. The present invention also solves a problem where real execution data for inputting an completion can be only inputted and thus an actual production not satisfying a schedule leads to a situation where an instruction for additional production is issued or a situation where a procurement slip is additionally issued in spite of the fact that the additional production is not needed. Furthermore, a theoretical inventory value, a virtual completion value, and a completion value can be inputted in a manner adapted to an actual situation of an actual shop floor for the production. Thus, a production management apparatus, a production management program, a computer-readable recording medium for recording the production management program, and a production management method can be provided that provide production management more adapted to reality.

According to the present invention, a production preparation situation at a desired investigation time is automatically calculated based on the respective pieces of process completion information. A capacity requirement is also displayed while being associated with the production preparation situation and production management information. As a result, a manager at a shop floor can judge the production preparation situation together with the capacity requirement in a comprehensive manner. When the manager sees the production preparation situation and the capacity requirement and then judges that a measure can be provided by changing a production place or the like, then the manager can an input for the change. When the change is inputted, a production preparation situation and a capacity requirement at a desired investigation time are displayed. As a result, a manager of an individual working place can judge whether the change is appropriate or not. Thus, an efficient production management can be provided.

Furthermore, some types of products to be produced find the production resource as a key for the production process. In such a case, the present invention advantageously allows a manager at a shop floor to judge a date at which the production resource is completed and information for the component or the like in a comprehensive manner. Furthermore, a production preparation situation and a capacity requirement within a predetermined period before and after a desired investigation time are displayed. In this manner, whether production preparation is provided or not is automatically calculated based on the respective pieces of process completion information and is displayed so that a user can easily take an appropriate measure. As a result, a production management apparatus, a production management program, a computer-readable recording medium for recording the production management program, and a production management method can be provided through which the manager of the shop floor can perform production management that is more adapted to reality.

What is claimed is:

1. A server that is connected to a terminal via a communication network and that calculates acceptable ordering conditions in accordance with a change of ordering conditions sent from the terminal to transmit the calculated conditions to the terminal, comprising:
a storage unit at least including a product order receiving conditions storage area for storing product order receiving conditions and a component procurement conditions storage area for storing component procurement conditions;
a product order receiving conditions reception device for receiving product order receiving conditions from the terminal;
a component procurement conditions transmission device for transmitting, to the terminal, component procurement conditions calculated based on the product order receiving conditions;
a component procurement conditions reception device for receiving, from the terminal, an update regarding the component procurement conditions; and
a product order receiving conditions transmission device for transmitting, to the terminal, product order receiving conditions calculated based on the received component procurement conditions.

2. A server that is connected to a terminal via a communication network and that calculates an effect on product delivery conditions in accordance with a change of component procurement conditions sent from the terminal to transmit the calculated effect to the terminal, comprising:
a storage unit at least including a component procurement conditions storage area for storing component procurement conditions, a production schedule storage area for storing a production schedule, and a product delivery conditions storage area for storing product delivery conditions;
a component procurement conditions reception device for receiving component procurement conditions from the terminal;
a production schedule transmission device for transmitting, to the terminal, a production schedule calculated based on the component procurement conditions;
a production schedule reception device for receiving, from the terminal, an update of the production schedule; and
a product delivery conditions transmission device for transmitting, to the terminal, product delivery conditions calculated based on the received production schedule.

3. The server according to claim 1, comprising:
the storage unit further including:
a product inventory information storage area for storing product inventory information;
a component inventory information storage area for storing component inventory information;
a component procurement lead time storage area for storing a component procurement lead time; and
a production schedule storage area for storing production schedule,
a production schedule determination device for determining the production schedule including a buffer based on the product inventory information, the component inventory information, and the component procurement lead time.

4. The server according to claim 2, further comprising:
the storage unit further including:
a product inventory information storage area for storing product inventory information;
a component inventory information storage area for storing component inventory information; and
a component procurement lead time storage area for storing a component procurement lead time,
a production schedule determination device for determining the production schedule by including a buffer on the product inventory information, the component inventory information, and the component procurement lead time.

5. A production management program that causes a server connected to a terminal via a communication network to calculate acceptable ordering conditions in accordance with a change of ordering conditions sent from the terminal to transmit the calculated conditions to the terminal, wherein:
the server includes a control unit and a storage unit;
the storage unit at least includes a product order receiving conditions storage area for storing product order receiving conditions and a component procurement conditions storage area for storing component procurement conditions;
the production management program further causes the control unit to execute:
a product order receiving conditions reception processing for receiving product order receiving conditions from the terminal;
a component procurement conditions transmission processing for transmitting, to the terminal, component procurement conditions calculated based on the product order receiving conditions;
a component procurement conditions reception processing for receiving, from the terminal, an update of the component procurement conditions; and
a product order receiving conditions transmission processing for transmitting, to the terminal, product order receiving conditions calculated based on the received component procurement conditions.

6. A production management program that causes a server connected to a terminal via a communication network to calculate acceptable ordering conditions in accordance with a change of ordering conditions sent from the terminal to transmit the calculated conditions to the terminal, wherein:
the server includes a control unit and a storage unit;
the storage unit at least includes a product order receiving conditions storage area for storing product order receiving conditions and a component procurement conditions storage area for storing component procurement conditions;
the production management program further causes the control unit to execute:
a product order receiving conditions reception processing for receiving product order receiving conditions from the terminal;
a component procurement conditions transmission processing for transmitting, to the terminal, component procurement conditions calculated based on the product order receiving conditions;
a component procurement conditions reception processing for receiving, from the terminal, an update of the component procurement conditions; and
a product order receiving conditions transmission processing for transmitting, to the terminal, product order receiving conditions calculated based on the received component procurement conditions.

7. The production management program according to claim 5, wherein:
the storage unit further includes a product inventory information storage area for storing product inventory information, a component inventory information storage area for storing component inventory information, a component procurement lead time storage area for storing a component procurement lead time, and a production schedule storage area for storing a production schedule,
the production management program further causes the control unit to execute:
a production schedule determination processing for determining the production schedule including a buffer based on the product inventory information, the component inventory information, and the component procurement lead time.

8. The production management program according to claim 6, comprising:
the storage unit further includes a product inventory information storage area for storing product inventory information, a component inventory information storage area for storing component inventory information, and a component procurement lead time storage area for storing a component procurement lead time,
the production management program further causes the control unit to execute:
a production schedule determination processing for determining the production schedule including a buffer based on the product inventory information, the component inventory information, and the component procurement lead time.

9. A computer for judging whether a work can be undertaken or not, wherein:
the computer includes a storage unit that includes a storage area, the storage area at least stores therein work information, the work information being composed of: resource status information that represents the current status of a resource required for undertaking a work and that is composed of a resource name and unit of resource; deliverables information that represents a work name specifying the work and deliverables obtained by the completion of the work; and resource request information that represents required conditions of the resource required for undertaking the work,
the deliverables information is composed of a deliverable name and unit of deliverable and the resource request information is composed of a resource name and unit of resource, and
the computer further includes:
a resource status information input reception device for receiving an input of resource status information;
a work information input reception device for receiving work information;
a device for judging whether a work can be undertaken or not, the device judges that the work can be undertaken when unit of resource of the resource status information of all resources required for undertaking the work is equal to or higher than unit of resource of resource request information and judges that the work cannot be undertaken in a case other than the above case; and
a device for displaying a result of the judgment regarding whether a work can be undertaken or not, the device displays the judgment result of the device for judging whether a work can be undertaken or not.

10. The computer according to claim 9, wherein:
the device for judging whether a work can be undertaken or not judges that the work can be entirely undertaken when unit of resource of the resource status information of all resources required for undertaking the work is equal to or higher than unit of resource of resource request information, judges that the work can be partially undertaken in a case other than the above case in which unit of resource of the resource status information is, with regard to deliverables of the work, equal to or higher than unit of resource required for providing at least one unit of deliverable, and judges that the work cannot be undertaken in a case other than these cases, and the device for displaying a result of the judgment regarding whether a work can be undertaken or not displays unit of deliverable of deliverables information of work information of the work judged by the device for judging whether a work can be undertaken or not.

11. The computer according to claim 9, wherein:
the storage unit includes a storage area that at least stores undertaking instruction information, the undertaking instruction information notifies that the work has been undertaken and is composed of a work name, a deliverable name, and unit of deliverable planned to be obtained when the work is undertaken, and
the computer includes:
an undertaking instruction information input reception device for receiving an input of the undertaking instruction information; and
an undertaken resource status information update device for deducting, when the undertaking instruction information regarding the work is inputted, from unit of resource of the resource status information, unit of resource of resource request information of the work corresponding to unit of deliverable of undertaking instruction information of the work with regard to all resources corresponding to deliverable names of the work for update.

12. The computer according to claim 9, wherein:
the storage unit includes a storage area that at least stores work completion information, the work completion information notifies that the work is completed and composed of a work name, a deliverable name, and unit of deliverable obtained by the completion of the work, and
the computer includes:
a work completion information input reception device for receiving an input of the work completion information; and
a completed resource status information update device for adding, when the work completion information regarding the work is inputted and when deliverables of the work are a resource required for undertaking another work, unit of deliverable of work completion information of the work to unit of resource of the resource of resource status information for update.

13. The computer according to claim 9, wherein:
the work information further includes planned undertaking timing information representing a planned timing at which a work is undertaken,
the computer further includes a device for receiving an input of a final timing at which a work is displayed for receiving an input of work final display timing information showing a final timing at which a work is displayed, and
the device for displaying a result of the judgment regarding whether a work can be undertaken or not displays, when a work has work information having planned undertaking timing information that is simultaneous with or earlier than the final display timing information and when the work has unit of deliverable larger than unit of deliverable of work completion information, the judgment result by the device for judging whether a work can be undertaken or not.

14. The computer according to claim 11, wherein:
the storage unit includes a storage area that at least stores work equalizing information for displaying, in order to equalize works of a manufacturing department, an amount of works to be done by the manufacturing department on a date and actually undertaken volume information showing the total of unit of deliverable of deliverables planned to be obtained when the work for which an undertaking instruction has been issued on the date is undertaken, and
the computer further includes:
a work equalizing information input reception device for receiving an input of the work equalizing information; and
a work equalizing information display device for simultaneously displaying the work equalizing information and the actually undertaken volume information.

15. A program for allowing a computer to realize a function for judging whether a work can be undertaken or not, wherein:
the computer includes a storage unit that includes a storage area, the storage area at least stores therein work information, the work information is composed of: resource status information that represents the current status of a resource required for undertaking a work-and that is composed of a resource name and unit of resource; deliverables information that represents a work name specifying the work and deliverables obtained by the completion of the work; and resource request information that represents required conditions of the resource required for undertaking the work,
the deliverables information is composed of a deliverable name and unit of deliverable and the resource request information is composed of a resource name and unit of resource, and
the program further allows the computer to realize:
a resource status information input reception function for receiving an input of resource status information;
a work information input reception function for receiving work information;
a function for judging whether a work can be undertaken or not, the function judges that the work can be undertaken when unit of resource of the resource status information of all resources required for undertaking the work is equal to or higher than unit of resource of resource request information and judges that the work cannot be undertaken in a case other than the above case; and
a function for displaying a result of the judgment regarding whether a work can be undertaken or not for displaying the judgment result of the function for judging whether a work can be undertaken or not.

16. The program according to claim 15, wherein:
the function for judging whether a work can be undertaken or not causes the computer to judge that the work can be entirely undertaken when unit of resource of the resource status information of all resources required for undertaking the work is equal to or higher than unit of resource of resource request information, to judge that the work can be partially undertaken in a case where unit of resource of the resource status information is, with regard to deliverables of the work, equal to or higher than unit of resource required for providing at least one unit of deliverable, and to judge that the work cannot be undertaken in a case other than these cases, and the function for displaying a result of the judgment regarding whether a work can be undertaken or not causes the computer to display unit of deliverable of deliverables information of work information of the work judged by the function for judging whether a work can be undertaken or not.

17. The program according to claim 15, wherein:
the storage unit of the computer further includes a storage area that at least stores undertaking instruction information, the undertaking instruction information notifies that the work has been undertaken and is composed of a work name, a deliverable name, and unit of deliverable planned to be obtained when the work is undertaken,
the program allows the computer to realize:
an undertaking instruction information input reception function for receiving an input of the undertaking instruction information; and
an undertaken resource status information update function for deducting, when the undertaking instruction information regarding the work is inputted, from unit of resource of the resource status information, unit of resource of resource request information of the work corresponding to unit of deliverable of undertaking instruction information of the work with regard to all resources corresponding to deliverable names of the work for update.

18. The program according to claim 15, wherein:
the storage unit of the computer further includes a storage area that at least stores work completion information, the work completion information notifies that the work is completed and is composed of a work name, a deliverable name, and unit of deliverable obtained by the completion of the work,
the program allows the computer to realize:
a work completion information input reception function for receiving an input of the work completion information; and
a completed resource status information update function for adding, when the work completion information regarding the work is inputted and when deliverables of the work are a resource required for undertaking another work, unit of deliverable of work completion information of the work to unit of resource of the resource of resource status information for update.

19. The program according to claim 15, wherein:
the work information further includes planned undertaking timing information representing a planned timing at which a work is undertaken,
the function for displaying a result regarding whether a work can be undertaken or not further allows the computer to realize:
a function for receiving an input of a final timing at which a work is displayed for receiving an input of work final display timing information showing a final timing at which a work is displayed,; and
a function for determining the display of a judgment result for displaying, when a work has work information having planned undertaking timing information that is simultaneous with or earlier than the final display timing information and when the work has unit of deliverable larger than unit of deliverable of work completion information, the judgment result by the function for judging whether a work can be undertaken or not.

20. The program according to claim 17, wherein:
the storage unit of the computer includes a storage area that at least stores work equalizing information for displaying, in order to equalize works of a manufacturing department, an amount of works to be done by the manufacturing department on a date and actually undertaken volume information showing the total of unit of deliverable of deliverables planned to be obtained when the work for which an undertaking instruction has been issued on the date is undertaken,
the program further allows the computer to realize:
a work equalizing information input reception function for receiving an input of the work equalizing information; and
a work equalizing information display function for simultaneously displaying the work equalizing information and the actually undertaken volume information.

21. A computer including a database having a plurality of tables, wherein:
the computer includes a storage unit including a storage area, the storage area at least stores: the plurality of tables; table selection information showing the status of a table selected by a user from among the plurality of tables; additional item information showing a new item added to the table selected by the user; and the additional data inputted by the user regarding the new item,
the computer includes:
a table selection information input reception device for receiving an input of the table selection information by the user;
an additional item information input reception device for receiving an input of the additional item information by the user regarding the selected table;
an additional data input reception device for receiving an input of the additional data by the user;
an item addition device for adding, based on the additional item information, the new item to the selected table; and
a data substitution device for substituting the additional data to the new item.

22. A computer including a database having a plurality of tables, wherein:
the computer includes a storage unit including a storage area, the storage area at least stores: the plurality of tables; item-related information representing a dependency among a plurality of items included in the plurality of tables; and data inputted by a user regarding the plurality of items included in the plurality of tables,
the computer includes:
an item-related information input reception device for receiving an input of the item-related information by the user;
a data input reception device for receiving an input of the data by the user; and
a data substitution device for substituting, based on the item-related information, the data to the plurality of items.

23. A computer including a database having a plurality of tables, wherein:
the computer includes a storage unit including a storage area, the storage area at least stores: the plurality of tables; table selection information representing the selection status of a table selected by a user from among the plurality of tables; additional item information representing a new item added to the table selected by a user; item-related information representing a dependency among a plurality of items included in the plurality of tables; and additional data regarding the new item inputted by a user,
the computer includes:
a table selection information input reception device for receiving an input of the table selection information by the user;
an additional item information input reception device for receiving an input of the additional item information regarding the selected table by the user;
an item-related information input reception device for receiving an input of the item-related information by the user;
an additional data input reception device for receiving an input of the additional data by the user;
an item addition device for adding, based on the additional item information, the new item to the selected table; and
a data substitution device for substituting, based on the item-related information, the additional data to the plurality of items at least including the new item.

24. The computer according to claim 21, wherein:
the item-related information is represented by a mathematical expression.

25. The computer according to claim 24, wherein:
the computer includes a mathematical expression input reception device for receiving an input of the mathematical expression by the user.

26. The computer according to claim 21, wherein:
the storage unit further includes an area for storing table relation information representing a dependency among the tables and the item-related information input reception device further includes a table relation information input reception device for receiving an input of the table relation information by the user.

27. A program for allowing a computer to control a database having a plurality of tables, wherein:
the computer includes a storage unit including a storage area, the storage area at least stores: the plurality of tables; table selection information representing the selection status of a table selected by a user from among the plurality of tables; additional item information representing a new item added to the table selected by a user; item-related information representing a dependency among a plurality of items included in the plurality of tables; and additional data regarding the new item inputted by a user,
the program allows the computer to realize:
a table selection information input reception function for receiving an input of the table selection information by the user;
an additional item information input reception function for receiving an input of the additional item information regarding the selected table by the user;
an item-related information input reception function for receiving an input of the item-related information by the user;
an additional data input reception function for receiving an input of the additional data by the user;
an item addition function for adding, based on the additional item information, the new item to the selected table; and
a data substitution function for substituting, based on the item-related information, the additional data the plurality of items at least including the new item.

28. A method for adding a table item using a computer for controlling a database having a plurality of tables, wherein:
the computer includes a storage unit including a storage area, the storage area at least storing: the plurality of tables; table selection information representing the selection status of a table selected by a user from among the plurality of tables; additional item information representing a new item added to the table selected by a user; item-related information representing a dependency among a plurality of items included in the plurality of tables; and additional data regarding the new item inputted by a user,
the method includes:
a table selection information input reception step for receiving an input of the table selection information by the user;
an additional item information input reception step for receiving an input of the additional item information regarding the selected table by the user;
an item-related information input reception step for receiving an input of the item-related information by the user;
an additional data input reception step for receiving an input of the additional data by the user;
an item addition step for adding, based on the additional item information, the new item to the selected table; and
a data substitution step for substituting, based on the item-related information, the additional data the plurality of items at least including the new item.

29. The computer according to claim 21, wherein:
the computer is used for table control.

30. The computer according to claim 21, wherein:
the computer is used for production control.

31. A production management apparatus, comprising:
a storage device for storing at least a component ordered while being associated with a production number;
a changed BOM preparation device for preparing a changed BOM based on changed CAD data;
a changed component calculation device for comparing a component included in the prepared changed BOM with the component stored in the storage device to calculate a to-be-canceled component of the production number and a to-be-additionally-ordered component; and
a display device for displaying the calculated to-be-canceled component and to-be-additionally-ordered component.

32. The production management apparatus according to claim 31, further comprising:
an input reception device for receiving an input of CAD data;
a production BOM preparation device for preparing a production BOM based on the received input of CAD data; and
a to-be-ordered component calculation device for calculating a to-be-ordered component based on the prepared production BOM so that the to-be-ordered component is associated with a production number.

33. The production management apparatus according to claim 31, further comprising:
an acquisition device for acquiring information regarding whether the displayed to-be-canceled component can be cancelled or not; and
a slip issue device for issuing a slip for canceling the cancelable component and a slip for a to-be-additionally-ordered component.

34. A production management program, wherein the program causes a computer as a production management apparatus to function as:
a storage device for storing at least a component ordered while being associated with a production number;
a changed BOM preparation device for preparing a changed BOM based on changed CAD data;
a changed component calculation device for comparing a component included in the prepared changed BOM with the component stored in the storage device to calculate a to-be-canceled component of the production number and a to-be-additionally-ordered component; and
a display device for displaying the calculated to-be-canceled component and to-be-additionally-ordered component.

35. The production management program according to claim 34, wherein the program allows the computer to additionally function as:
an input reception device for receiving an input of CAD data;
a production BOM preparation device for preparing a production BOM based on the received input of CAD data; and
a to-be-ordered component calculation device for calculating a to-be-ordered component based on the prepared production BOM so that the to-be-ordered component is associated with a production number.

36. The production management program according to claim 34, comprising the program allows the computer to additionally function as:
an acquisition device for acquiring information regarding whether the displayed to-be-canceled component can be cancelled or not; and
a slip issue device for issuing a slip for canceling the cancelable component and a slip for a to-be-additionally-ordered component.

37. The computer-readable recording medium for recording a production management program according to claim 34.

38. A computer-based production management method, comprising:
a step for storing at least a component ordered while being associated with a production number;
a step for preparing a changed BOM based on changed CAD data;
a step for comparing a component included in the prepared hanged BOM with the component stored in the storage step to calculate a to-be-canceled component of the production number and a to-be-additionally-ordered component; and
a step for displaying the calculated to-be-canceled component and to-be-additionally-ordered component.

39. The computer-based production management method according to claim 38, comprising:
the method performs, prior to the storing step, a step for receiving an input of CAD data;
a step for preparing a production BOM based on the received input of CAD data; and
a step for calculating a to-be-ordered component based on the prepared production BOM so that the to-be-ordered component is associated with a production number.

40. The computer-based production management method according to claim 38, comprising:
the method further including:
a step for acquiring information regarding whether the displayed to-be-canceled component can be cancelled or not; and
a step for issuing a slip for canceling the cancelable component and a slip for a to-be-additionally-ordered component.

41. A production management apparatus based on Material Requirements Planning for calculating, based on a production BOM and inventory information, an amount of material to be ordered and an ordering timing, comprising:
a completion value input device for inputting, with regard to an already-executed work item among work items to be executed in a production schedule, the real completion value thereof;
a theoretical inventory value input device for inputting a theoretical inventory value for the material requirement calculation;
an inventory data update device for using the completion value inputted to the completion value input device to update inventory data of the already-executed work item; and
a requirement calculation device for using the theoretical inventory value inputted to the theoretical inventory value input device and the inventory data updated by the inventory data update device to calculate the next requirement.

42. A production management program for allowing a computer to function as a production management apparatus based on Material Requirements Planning for calculating, based on a production BOM and inventory information, an amount of material to be ordered and an ordering timing, comprising the program allows the computer to function as:
a completion value input device for inputting, with regard to an already-executed work item among work items to be executed in a production schedule, the real completion value thereof;
a theoretical inventory value input device for inputting a theoretical inventory value for the material requirement calculation;
an inventory data update device for using the completion value inputted to the completion value input device to update inventory data of the already-executed work item; and
a requirement calculation device for using the theoretical inventory value inputted to the theoretical inventory value input device and the inventory data updated by the inventory data update device to calculate the next requirement.

43. The computer-readable recording medium for recording a production management program according to claim 42.

44. A production management method based on Material Requirements Planning using a computer for calculating, based on a production BOM and inventory information, an amount of material to be ordered and an ordering timing, comprising:
an item for inputting, with regard to an already-executed work item among work items to be executed in a production schedule, the real completion value thereof; and
an item for inputting a theoretical inventory value for the material requirement calculation, and
the method comprising:
a step for using the inputted completion value to update inventory data of the already-executed work item; and
a step for using the inputted theoretical inventory value and the inventory data updated in the step for updating the inventory data to calculate the next requirement.

45. A production management apparatus, comprising:
a respective pieces of process information input device for inputting, with regard to a production schedule, the respective pieces of process information including a schedule or a result of delivery or completion of material or a component;
a storage device for storing the inputted respective pieces of process information and production management information of the production schedule;
a production preparation situation calculation device for calculating, based on the respective pieces of process information and production management information stored in the storage device, a production preparation situation at a desired investigation time; and
a production situation display device for displaying the calculated production preparation situation and the production management information.

46. The production management apparatus according to claim 45, further comprising:
a capacity requirement calculation device for calculating, based on the production management information of the production schedule, a capacity requirement; and
a capacity requirement display device for displaying the capacity requirement so as to be associated with the production preparation situation and the production management information.

47. The production management apparatus according to claim 46, wherein:
the production management apparatus further includes a reception and input device for receiving the respective pieces of process information from at least one terminal via a communication line, and
based on the received respective pieces of process information and the production management information stored in the storage device, the production preparation situation calculation device calculates a production preparation situation at a desired investigation time and the capacity requirement calculation device calculates a capacity requirement at a desired investigation time.

48. The production management apparatus according to claim 46, wherein:
the production management apparatus further includes a change input device for inputting a change of the displayed production management information regarding predetermined material or component, and
based on the inputted change of the production management information, the production preparation situation calculation device calculates a production preparation situation at a desired investigation time and the capacity requirement calculation device calculates a capacity requirement at a desired investigation time.

49. The production management apparatus according to any claim 45, wherein:
the production management apparatus further includes a production resource information input device,
the storage device further stores the production resource information, and
the production preparation situation calculation device calculates the production preparation situation at the desired investigation time in consideration of the production resource information stored in the storage device.

50. The production management apparatus according to claim 45, wherein:
the production preparation situation calculation device calculates a production preparation situation in a predetermined period before and after the desired investigation time, and
the capacity requirement calculation device calculates a capacity requirement in a predetermined period before and after the desired investigation time.

51. A production management program characterized in allowing a computer as a production management apparatus to function as:
a respective pieces of process information input device for inputting, with regard to a production schedule, the respective pieces of process information including a schedule or a result of delivery or completion of material or a component;
a storage device for storing the inputted respective pieces of process information and production management information of the production schedule;
a production preparation situation calculation device for calculating a production preparation situation at a desired investigation time based on the respective pieces of process information and production management information stored in the storage device; and
a production situation display device for displaying the calculated production preparation situation and the production management information.

52. The production management program according to claim 51, wherein:
the production management program further allows the computer to function as:
a capacity requirement calculation device for calculating, based on the production management information of the production schedule, a capacity requirement, and
a capacity requirement display device for displaying the capacity requirement so as to be associated with the production preparation situation and the production management information.

53. The production management program according to claim 52, wherein:
the production management program further allows the computer to function as:
a reception and input device for receiving the respective pieces of process information from at least one terminal via a communication line, and
based on the received respective pieces of process information and the production management information stored in the storage device, the production preparation situation calculation device is caused to calculate a production preparation situation at a desired investigation time and the capacity requirement calculation device is caused to a capacity requirement at a desired investigation time.

54. The production management program according to claim 52, wherein:
the production management program further allows the computer to function as:
a change input device for inputting a change of the displayed production management information regarding predetermined material or component, and
based on the inputted change of the production management information, the production preparation situation calculation device is further caused to calculate a production preparation situation at a desired investigation time and the capacity requirement calculation device is further caused to calculate a capacity requirement.

55. The production management program according to claim 51, wherein:
the production management program further allows the computer to function as a production resource information input device,
a storage device is caused to further store the inputted production resource information, and
the production preparation situation calculation device is caused to calculate the production preparation situation at the desired investigation time in further consideration of the production resource information stored in the storage device.

56. The production management program according to claim 51, wherein:
the production preparation situation calculation device is caused to calculate a production preparation situation in a predetermined period before and after the desired investigation time, and
the capacity requirement calculation device is caused to calculate a capacity requirement in a predetermined period before and after the desired investigation time.

57. The computer-readable recording medium for recording a production management program according to claim 51.

58. A computer-based production management method, comprising:
a respective nieces of process information input step for inputting, with regard to a production schedule, the respective pieces of process information including a schedule or a result of delivery or completion of material or a component:
a storage step for storing the inputted respective pieces of process information and production management information of the production schedule;
a production preparation situation calculation step for calculating, based on the respective pieces of process information and production management information stored in the storage step, a production preparation situation at a desired investigation time; and
a production situation display step for displaying the calculated production preparation situation and the production management information.

59. The computer-based production management method according to claim 58, further comprising:
a capacity requirement calculation step for calculating, based on the production management information of the production schedule, a capacity requirement; and
a capacity requirement display step for displaying the capacity requirement so as to be associated with the production preparation situation and the production management information.

60. The computer-based production management method according to claim 59, wherein:
the method further includes a reception and input step for receiving the respective pieces of process information from at least one terminal via a communication line,
based on the received respective pieces of process information and the production management information stored in the storage step, the production preparation situation calculation step calculates a production preparation situation at a desired investigation time and the capacity requirement calculation step calculates a capacity requirement at a desired investigation time.

61. The computer-based production management method according to claim 59, wherein:
the method further includes a change input step for inputting a change of the displayed production management information regarding predetermined material or component, and
based on the inputted change of the production management information, the production preparation situation calculation step calculates a production preparation situation at a desired investigation time and the capacity requirement calculation step calculates a capacity requirement at a desired investigation time.

62. The computer-based production management method according to claim 58, wherein:
the method further includes a production resource information input step,
the storage step further stores the production resource information, and
the production preparation situation calculation step calculates the production preparation situation at the desired investigation time in consideration of the production resource information stored in the storage step.

63. The computer-based production management method according to claim 58, wherein:
the production preparation situation calculation step calculates a production preparation situation in a predetermined period before and after the desired investigation time, and
the capacity requirement calculation step calculates a capacity requirement in a predetermined period before and after the desired investigation time.
